(19) United States
(12) Patent Application Publication
(10) Pub. No.: US 2007/0230297 A1
(43) Pub. Date: Oct. 4, 2007

(54) Signal Processing System

(75) Inventor: Satoshi Kitani, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/573,925

(22) PCT Filed: Sep. 16, 2004
(86) PCT No.: PCT/JP04/13980

§ 371 Date: Jun. 8, 2007

(30) Foreign Application Priority Data
Sep. 30, 2003 (JP) 2003-340076

(51) Int. Cl. G11B 20/10

(52) U.S. Cl. 369/47.1

(57) ABSTRACT

A writable disc 13a on which a secured disc key 10a is pre-recorded is used. A drive 161 contains a random number generator 81 that generates a title key, an encryptor 82 that encrypts the generated title key with a disc key, a master key 83, and a decryptor 84 that decrypts the secured disc key with the master key. In addition, the drive has an authentication section 62 that generates a session key Ks, a bus encryptor 63 that encrypts the secured disc key with the session key Ks, and a bus decryptor 66 that decrypts scrambled MPEG data. Since an encrypted key is stored in the drive, an unlicensed user cannot freely create CSS written software.

### TECHNICAL FIELD

The present invention relates to a signal process system, a record and reproduction apparatus, a record method, a program therefor, and a record medium of which a drive connected to for example a personal computer records a content to a disc medium for example a disc based on the DVD (Digital Versatile Disc) standard and reproduces a content therefrom.

### BACKGROUND ART

A large amount of data for one movie can be recorded as digital information to one record medium such as a DVD that has been developed in recent years. As a large amount of video information can be recorded as digital information, it is becoming important to protect contents of copyright owners from being illegally copied.

For example, DVD-Video uses a copyright protection technology called CSS (Content Scramble System). A method of protecting copyrights of DVDs is described in the following document 1 and document 2.

(Document 1)

“Part 2, Protection for Intellectual Property, firm footing of illegal copy protection technology, which holds the key to the solution of software decryption (translated title),” Nikkei Electronics, 1997.8.18, p. 110-119

(Document 2)

Yamada, “Spreading out space of copyright protection starting from DVD (translated title),” Nikkei Electronics, 2001.8.13, p. 143-153.

FIG. 1 shows an outline of the CSS scheme described in these documents. In this scheme, three pieces of encrypted key data are used. The three pieces of encrypted key data are a master key issued by the CSS key issuance center and a disc key and a title key designated by a copyright owner or the like. The master key is a secret key that is unique to each maker. The disc key is unique to each disc. A set of disc keys is created so that any master key can decrypt them. The set of disc keys is saved on a disc. When a disc key is saved on a disc, the disc key is encrypted. The disc key is called a secured disc key.

For MPEG (Moving Picture coding Experts Group) data 1 of which content data such as video data and audio data have been compressed, a title key 2 that is an encrypted key assigned to the content is prepared. In addition, a disc key 3 that is an encrypted key assigned to each disc is prepared. In a key issuance center 4 that manages encryption, an encryption circuit (hereinafter, sometimes referred to as an encryptor) 6 encrypts the disc key 3 with a master key 5 that the key issuance center 4 manages. In addition, an encryptor 7 encrypts the title key 2 with the disc key 3. Moreover, a scrambler 8 encrypts the MPEG data 1 with the title key 2.

Encrypted content data (hereinafter sometimes referred to as scrambled MPEG data or scrambled content) 9, an encrypted disc key (hereinafter, sometimes referred to as a secured disc key) 10, and an encrypted title key (hereinafter, sometimes referred to as an encrypted title key) 11 are recorded to a DVD-Video disc 12 when it is produced. The secured disc key is recorded at a predetermined location of the lead-in area of the disc 12 and an encrypted title key is recorded in each sector of sectored content data. The secured disc key and the encrypted title key are key information for the copyright protection system. The secured disc key and the encrypted title key are generically referred to as a CSS key.

As shown in FIG. 2, a DVD player reproduces the scrambled MPEG data 9, the secured disc key 10, and the encrypted title key 11 from the DVD-Video disc 12 and reads them. In the DVD player 21, a decryption circuit (hereinafter referred to as a decryptor) 23 decrypts the encrypted disc key. A decryptor 24 decrypts the encrypted title key with the decrypted disc key. A descrambler 25 descrambles the scrambled MPEG data with the decrypted title key. An MPEG decoder 26 decodes the descrambled MPEG data and obtains audio/visual data.

FIG. 3 shows a data structure of a lead-in area, which is an area of a disc from which the player initially reads information when the player reproduces data from the disc. The lead-in area ranges from physical sector numbers 0h (where h denotes hexadecimal notation) to 30000h. The lead-in area is composed of an all-zero area, a reference code area, an all-zero area, and a control data area. After sector number 30000h, a main data area starts in which content data are recorded.

The control data area is composed of one sector of physical format information (sector 0), one sector of disc production information (sector 1), and 14 sectors of content provider information (sectors 2 to 15). Information of 16 sectors, sectors 0 to 15, is repeatedly placed in the control data area. A secured disc key unique to the disc is placed in an area for the content provider information (information about the content provider).

Next, with reference to FIG. 4, a structure of which the title key is recorded will be described. Each sector in which main data such as content data are recorded is composed of 2064 bytes. The first four bytes of the 2064 bytes are ID data that denotes a sector number or the like. The next two bytes are ID data error detection data IED. The next six bytes are copy management data RSV. The copy management data RSV contains an encrypted title key. The copy management data are followed by a main data record area of 2048 bytes (2 K) in which content data and so forth are recorded. The last four bytes are error detection data EDC for the whole sectors.

A disc to which data that have been encrypted with the disc key and the title key are saved is basically a reproduction-only disc. However, the DVD standard defines recordable discs. For example, DVD-RW/-R standard discs and DVD+RW/+R standard discs are recordable discs. By recording digital data reproduced from another medium to another medium as they are using a process so-called “bit by bit” copy, data read from a DVD-Video can be illegally recorded to one of these types of discs. However, with the foregoing disc key and title key, content data can be prevented from being decrypted from such an illegally copied disc.

Next, with reference to FIG. 5, a reason why encrypted data cannot be decrypted from an illegally copied disc will be described. First, a DVD-Video disc Da to which the secured disc key and the encrypted title key have been recorded at the foregoing locations is provided. The user operates the payer to reproduce data from the disc Da. The player obtains the secured disc key from the lead-in area of an innermost periphery portion of the disc and the encrypted title key from a sector for content data. The player decrypts the secured disc key with the master key and the encrypted title key with the disc key. The player descrambles the scrambled MPEG data with the title key and obtains audio/visual data.

Now, it is assumed that the user opiates the player to record content data recorded on the DVD-Video disc Da to a DVD-RW/-R disc Db by the “bit by bit” copy operation. On the disc Db, a part of the lead-in area is a pit pre-written area that was formed when the disc Db was produced. A disc key assigned to the disc Db or an invalid key is pre-written in the pre-written area.

Thus, when the user creates a DVD-R/W standard disc Db′ to which content data that were read from the DVD-Video disc Da were recorded in the data recordable area of the disc Db, the disc key of the disc Db′ is different from the disc key of the original disc Da. Thus, even if the user operates the player to reproduce data from the disc Db′, the player cannot correctly decrypt the data. As a result, content data can be prevented from being illegally copied.

In the foregoing example, the CSS scheme applied to the DVD-Video disc was mainly described. The basic theory of CPPM (Content Protection for Pre-Recorded) scheme that is a scrambling system applied to a DVD-audio disc and so forth is basically the same as that of the CSS scheme.

FIG. 6 shows a method of which a PC and a drive that reproduce data from a ROM disc for example a DVD-Video disc on which data have been recorded according to the CSS scheme obtains the disc key and the title key therefrom and a method of descrambling scrambled data. In FIG. 6, reference numeral 31 denotes a DVD drive as a reproduction apparatus that reproduces data according to the CSS scheme from the DVD-Video disc. Reference numeral 41 denotes the PC as the data process apparatus. Application software of the DVD player is installed to the PC 41.

The DVD drive 31 and the PC 41 are connected by a normal interface. This interface is for example ATAPI (AT Attachment with Packet Interface), SCSI (Small Computer System Interface), USB (Universal Serial Bus), IEEE (Institute of Electrical and Electronics Engineers) 1394, or the like.

The DVD drive 31 has an authentication section 32 and bus encryptors 33 and 34. The PC 41 has an authentication section 42 and bus encryptors 43 and 44. The authentication section 32 and the authentication section 42 mutually authenticate each other. Whenever they have mutually and successfully authenticated each other, they generate a different session key (referred to as a bus key) Ks. In addition, the PC 41 has a master key 45, decryptors 46 and 47, and a descrambler 48. MPEG data obtained from the descrambler 48 is decoded by an MPEG decoder 49 of the PC 41. As a result, the MPEG decoder 49 obtains audio/visual data 50.

When a disc is detected, after the powers of the DVD drive 31 and the PC 41 are turned on or when a disc is replaced with another disc, the authentication operation is performed. When a record button is pressed for a record operation or a reproduction button is pressed for a reproduction operation, the authentication operation may be performed. For example, when the record button or the reproduction button is pressed, the authentication operation is performed.

The DVD drive 31 reads the scrambled MPEG data 9, the secured disc key 10, and the encrypted title key 11 obtained from the DVD-Video disc. The DVD drive 31 reads the encrypted title key from a sector for content data. The DVD drive 31 decrypts the secured disc key with the master key and the encrypted title key with the disc key. The DVD drive 31 descramble the scrambled MPEG data with the title key and obtains the audio/visual data.

FIG. 7 shows a procedure for exchanging signals between the DVD drive 31 and the PC 41 of the conventional system shown in FIG. 6. The PC 41 sends a command to the DVD drive 31. The DVD drive 31 performs an operation corresponding to the command. For example, when the DVD-Video disc is inserted into the DVD drive 31, the sequence starts. First, an authentication sequence AKE (Authentication and Key Exchange) is performed (at step S1). When the DVD drive 31 and the PC 41 have mutually and successfully authenticated each other, they share a session key Ks. When they have not mutually and successfully authenticated each other, the process is terminated.

Next, a content data zone is sought and read from the DVD-Video disc 12 corresponding to a request received from the PC 41 (at step 52). At the next step, step S3, the PC 41 requests the secured disc key of the DVD drive 31. The drive 31 reads the secured disc key from the DVD-Video disc 12 (at steps S4 and S5). The bus encryptor 33 encrypts the secured disc key with the session key Ks. The secured disc key encrypted with Ks is returned from the drive 31 to the PC 41 (at step S6).

Thereafter, the PC 41 requests the encrypted title key and copy generation management information CGMS of the DVD drive 31 (at step S7). The drive 31 reads the encrypted title key and CGMS from the DVD-Video disc 12 (at step S8 and S9). The bus encryptor 34 encrypts the encrypted title key and CGMS with the session key Ks. The encrypted title key and CGMS that have been encrypted with Ks are returned from the drive 31 to the PC 41 (at step S10).

Thereafter, the PC 41 requests the scrambled content (having the same meaning as scrambled MPEG data) of the DVD drive 31 (at step S11). The drive 31 reads the scrambled content from the DVD-Video disc 12 (at steps S12 and S13). The scrambled content is returned from the DVD drive 31 to the PC 41 (at step S14).

The foregoing CSS scheme can be applied to only the DVD-ROM medium. However, the CSS scheme is prohibited from being applied to the recordable DVDs such as DVD-R, DVD-RW, DVD+R, and DVD+RW under the CSS contract. Thus, the CSS contract does not permit the whole content of a DVD-Video that has been CSS-copyright-protected to be copied to a recordable DVD (by the “bit by bit” copy operation).

However, the CSS encryption scheme was broken. Software called “DeCSS” that can decrypt data that have been encrypted according to the CSS scheme and easily copy the decrypted data to a hard disk has been distributed over the Internet. The “DeCSS” appeared in such a manner that reproduction software that has CSS decryption key data that need to have tamper-resistance, but that do not it was reverse-engineered and the key data ware decrypted. As a result, the entire algorithm was decrypted.

As successors of the CSS scheme, CPPM (Content Protection for Pre-Recorded Media), which is a copyright protection technology for DVD-ROMs such as DVD-Audio and so forth and CPRM (Content Protection for Recordable Media) for recordable DVDs and memory cards have been proposed. These schemes allow systems to be updated if a problem of which for example a content cannot be correctly encrypted or stored occurs. Even if whole data are copied, these schemes have a function for restricting the data from being reproduced. In other words, in the CPRM scheme, to prohibit a content from being copied on the “bit by bit” basis, an area for key information in the lead-in area is pre-recorded. The CPRM scheme is described in the following document (Document 3) distributed by the 4C Entity, LLC, United State.

(Document 3)

“Content Protection for Recordable Media Specification DVD Book,” Internet <URL http://www.4Centity.com/>

However, because a large number of DVD players had been distributed in the market, before the CPRM-scheme has been standardized, these DVD player do not have support it. In addition, most DVD players that have distributed after the CPRM scheme had been standardized do not support the CPRM scheme because it increases their costs. Thus, in consideration of compatibility with common DVD-Video players, it is difficult to use the CPRM scheme. On the other hand, as BS digital broadcasts and terrestrial digital broadcasts have been commercially used, the importance of encrypting recording for the broadcasts is becoming strong to protect the copyright of broadcast contents.

Under the situation of which “DeCSS” appeared, as another method of protecting copyright of a content, an electronic watermark may be pre-embedded in audio/visual data. An electronic watermark can be kept after a content is copied. Thus, when an electronic watermark is detected in a content, it can be prevented from being reproduced.

However, the method of embedding an electronic watermark in a content has several drawbacks. Thus, it is difficult to practically use this method. In other words, a watermark has the following drawbacks. An electronic watermark needs to be randomly accessed in a smaller size than one access unit of audio/visual information. Read data and write data flow through one channel named ATAPI. A large circuit is required to detect an electronic watermark, resulting in an increase of the cost of the drive. A long process time is required to detect electronic watermark information, resulting in preventing the write time and read time of the drive from decreasing.

To prevent a DVD-Video disc from being illegally copied without need to use electronic watermark information, a drive that has a read filter and a write filter has been proposed. When data that are read from a disc are any pack of video data, audio data, and sub picture data of DVD-Video data, the pack is masked. When data that are read from a disc are another control information pack, it is not masked, but transferred to a buffer memory. The mask process means a process for replacing objective data with invalid data such as all-zero data. In such a manner, a content can be prevented from being illegally reproduced from a DVD-Video disc.

The write data filter detects a pack header of a pack transferred from the PC and determines a type of the pack. When the type of the pack is any one of video data, audio data, and sub picture data of a DVD-Video disc, the write data filter masks the pack. Otherwise, the write data filter does not mask the pack, but transfers it to the DVD encoder. Thus, a content of a DVD-Video disc can be prevented from being illegally copied by the PC.

When a PC and a writable DVD disc are used, this method can prevent data from being illegally reproduced and copied according to the DVD-Video format. However, in this case, data in the DVD-Video format cannot be recorded and reproduced. From this point of view, a method of which a PC and a drive mutually authenticate each other and when they have not mutually and successfully authenticated each other, the DVD drive masks content data and when they have successfully and mutually authenticated each other, the DVD drive encrypts/decrypts content data has been proposed. This method allows data to be reproduced from a DVD-Video disc. However, in the proposed method, when data are written, they have not been scrambled.

Since write data have not been scrambled, the CSS scheme of the common DVD-Video players cannot be used. In addition, recorded content data are not copyright-protected. Under the situation of which the “DeCSS” software appeared, which breaks the CSS encryption, it is important to scramble a content recorded on the DVD-Video disc according to the CSS scheme authorized by the authorized licensing organization to identify a copyright protected content.

Therefore, an object of the present invention is to provide a signal process system, a record and reproduction apparatus, a record method, a program therefor, and a record medium that allow write data to be protected and to be identified as protected data by a copyright protection technology for example CSS when the data are written by a drive.

In addition, an object of the present invention is to provide a signal process system, a record and reproduction apparatus, a record method, a program therefor, and a record medium that prevent a common user from creating copyright protection technology writing software when it has been installed as application software on the user's PC.

### DISCLOSURE OF THE INVENTION

To solve the foregoing problem, a first aspect of the present invention is a signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium,

wherein the record and reproduction apparatus comprises:

storage means for storing the first encrypted key,

second encrypted key decryption means for reproducing the second encrypted key encrypted and recorded on the record medium and for decrypting the second encrypted key with the first encrypted key,

third encrypted key generation means for generating the third encrypted key,

encryption means for encrypting the third encrypted key with the decrypted second encrypted key,

authentication means for authenticating the information process apparatus and generating a session key when the authentication means has successfully authenticated the information process apparatus,

first bus-encryption means for bus-encrypting the second encrypted key that has been encrypted and recorded on the record medium with the session key and transferring the bus-encrypted second encrypted key to the information process apparatus,

second bus-encryption means for bus-encrypting the third encrypted key with the session key and transferring the bus-encrypted third encrypted key to the information process apparatus,

bus-decryption means for bus-decrypting encrypted and bus-encrypted content information supplied from the information process apparatus, and

record means for recording the third encrypted key and the encrypted content information to the record medium, and

wherein the information process apparatus comprises:

storage means for storing the first encrypted key,

authentication means for authenticating the record and reproduction apparatus and generating the session key when the authentication means has successfully authenticated the record and reproduction apparatus,

first bus-decryption means for bus-decrypting the bus-encrypted second encrypted key with the session key,

decryption means for decrypting the second encrypted key with the first encrypted key,

second bus-decryption means for bus-decrypting the bus-encrypted third encrypted key with the session key,

decryption means for decrypting the third encrypted key with the second encrypted key,

encryption means for encrypting the content information transferred to the record and reproduction apparatus with the third encryption, and bus-encryption means for bus-encrypting the encrypted content information with the session key and sending the bus-encrypted content information to the record and reproduction apparatus.

A second aspect of the present invention is a signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium, wherein the record and reproduction apparatus comprises:

storage means for storing the first encrypted key,

second encrypted key generation means for generating the second encrypted key,

encryption means for encrypting the generated second encrypted key with the first encrypted key,

third encrypted key generation means for generating the third encrypted key,

encryption means for encrypting the third encrypted key with the generated second encrypted key,

authentication means for authenticating the information process apparatus and generating a session key when the authentication means has successfully authenticated the information process apparatus,

first bus-encryption means for bus-encrypting the second encrypted key with the session key and transferring the bus-encrypted second encrypted key to the information process apparatus,

second bus-encryption means for bus-encrypting the third encrypted key with the session key and transferring the bus-encrypted third encrypted key to the information process apparatus,

bus-decryption means for bus-decrypting the encrypted and bus-encrypted content information supplied from the information process apparatus, and

record means for recording the second encrypted key, the third encrypted key, and the encrypted content information to the record medium, and

wherein the information process apparatus comprises:

storage means for storing the first encrypted key,

authentication means for authenticating the record and reproduction apparatus and generating the session key when the authentication means has successfully authenticated the record and reproduction apparatus,

first bus-decryption means for bus-decrypting the bus-encrypted second encrypted key with the session key,

decryption means for decrypting the second encrypted key with the first encrypted key, second bus-decryption means for bus-decrypting the bus-encrypted third encrypted key with the session key,

decryption means for decrypting the third encrypted key with the second encrypted key,

encryption means for encrypting the content information transferred to the record and reproduction apparatus with the third encryption, and

bus-encryption means for bus-encrypting the encrypted content information with the session key and sending the bus-encrypted content information to the record and reproduction apparatus.

A third aspect of the present invention is a signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium,

wherein the record and reproduction apparatus comprises:

storage means for storing the first encrypted key,

second encrypted key decryption means for reproducing the second encrypted key encrypted and recorded on the record medium and for decrypting the second encrypted key with the first encrypted key,

third encrypted key generation means for generating the third encrypted key,

encryption means for encrypting the third encrypted key with the decrypted second encrypted key,

authentication means for authenticating the information process apparatus and generating a session key when the authentication means has successfully authenticated the information process apparatus,

bus-decryption means for bus-decrypting the bus-encrypted content information supplied from the information process apparatus,

encryption means for encrypting the content information with the third encrypted key, and

record means for recording the third encrypted key and the encrypted content information to the record medium, and

wherein the information process apparatus comprises:

authentication means for authenticating the record and reproduction apparatus and generating the session key when the information process apparatus has successfully authenticated the record and reproduction apparatus, and

bus-encryption means for bus-encrypting content information transferred to the record and reproduction apparatus with the session key and sending the bus-encrypted content information to the record and reproduction apparatus.

A fourth aspect of the present invention is a signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium,

wherein the record and reproduction apparatus comprises:

storage means for storing the first encrypted key,

second encrypted key generation means for generating the second encrypted key,

encryption means for encrypting the generated second encrypted key with the first encrypted key,

third encrypted key generation means for generating the third encrypted key,

encryption means for encrypting the third encrypted key with the generated second encrypted key,

authentication means for authenticating the information process apparatus and generating a session key when the authentication means has successfully authenticated the information process apparatus,

bus-decryption means for bus-decrypting the bus-encrypted content information supplied from the information process apparatus,

encryption means for encrypting the content information with the third encrypted key, and

record means for recording the second encrypted key, the third encrypted key, and the encrypted content information to the record medium, and

wherein the information process apparatus comprises:

authentication means for authenticating the record and reproduction apparatus and generating the session key when the information process apparatus has successfully authenticated the record and reproduction apparatus, and

bus-encryption means for bus-encrypting content information with the session key and sending the bus-encrypted content information to the record and reproduction apparatus.

A fifth aspect of the present invention is a record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:

storage means for storing the first encrypted key,

second encrypted key decryption means for reproducing the second encrypted key encrypted and recorded on the record medium and for decrypting the second encrypted key with the first encrypted key,

third encrypted key generation means for generating the third encrypted key,

encryption means for encrypting the third encrypted key with the decrypted second encrypted key,

authentication means for authenticating the information process apparatus and generating a session key when the authentication means has successfully authenticated the information process apparatus,

first bus-encryption means for bus-encrypting the second encrypted key that has been encrypted and recorded on the record medium with the session key and transferring the bus-encrypted second encrypted key to the information process apparatus,

second bus-encryption means for bus-encrypting the third encrypted key with the session key and transferring the bus-encrypted third encrypted key to the information process apparatus,

bus-decryption means for bus-decrypting encrypted and bus-encrypted content information supplied from the information process apparatus, record means for recording the third encrypted key and the encrypted content information to the record medium,

wherein the encrypted and bus-encrypted content information is encrypted with the third encrypted key and the encrypted content information is bus-encrypted with the session key generated by the information process apparatus.

A sixth aspect of the present invention is a record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:

storage means for storing the first encrypted key,

second encrypted key generation means for generating the second encrypted key,

encryption means for encrypting the generated second encrypted key with the first encrypted key,

third encrypted key generation means for generating the third encrypted key,

encryption means for encrypting the third encrypted key with the generated second encrypted key,

authentication means for authenticating the information process apparatus and generating a session key when the authentication means has successfully authenticated the information process apparatus,

first bus-encryption means for bus-encrypting the second encrypted key with the session key and transferring the bus-encrypted second encrypted key to the information process apparatus,

second bus-encryption means for bus-encrypting the third encrypted key with the session key and transferring the bus-encrypted third encrypted key to the information process apparatus,

bus-decryption means for bus-decrypting the encrypted and bus-encrypted content information supplied from the information process apparatus, and

record means for recording the second encrypted key, the third encrypted key, and the encrypted content information to the record medium,

wherein the encrypted and bus-encrypted content information is encrypted with the third encrypted key and the encrypted content information is bus-encrypted with the session key generated by the information process apparatus.

A seventh aspect of the present invention is a record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:

storage means for storing the first encrypted key,

second encrypted key decryption means for reproducing the second encrypted key encrypted and recorded to the record medium and for decrypting the second encrypted key with the first encrypted key,

third encrypted key generation means for generating the third encrypted key,

encryption means for encrypting the third encrypted key with the decrypted second encrypted key,

authentication means for authenticating the information process apparatus and generating a session key when the authentication means has successfully authenticated the information process apparatus,

bus-decryption means for bus-decrypting the bus-encrypted content information supplied from the information process apparatus,

encryption means for encrypting the content information with the third encrypted key, and

record means for recording the third encrypted key and the encrypted content information to the record medium,

wherein the bus-encrypted content information is the encrypted content information that has been bus-encrypted with the session key generated by the information process apparatus.

An eighth aspect of the present invention is a record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:

storage means for storing the first encrypted key,

second encrypted key generation means for generating the second encrypted key,

encryption means for encrypting the generated second encrypted key with the first encrypted key,

third encrypted key generation means for generating the third encrypted key,

encryption means for encrypting the third encrypted key with the generated second encrypted key,

authentication means for authenticating the information process apparatus and generating a session key when the authentication means has successfully authenticated the information process apparatus,

bus-decryption means for bus-decrypting the bus-encrypted content information supplied from the information process apparatus,

encryption means for encrypting the content information with the third encrypted key, and

record means for recording the second encrypted key, the third encrypted key, and the encrypted content information to the record medium,

wherein the bus-encrypted content information is the encrypted content information that has been bus-encrypted with the session key generated by the information process apparatus.

A ninth aspect of the present invention is a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:

causing the record and reproduction apparatus to store the first encrypted key,

causing the record and reproduction apparatus to reproduce the second encrypted key encrypted and recorded on the record medium and decrypt the second encrypted key with the first encrypted key,

causing the record and reproduction apparatus to generate the third encrypted key,

causing the record and reproduction apparatus to encrypt the third encrypted key with the decrypted second encrypted key,

causing the record and reproduction apparatus to authenticate the information process apparatus and generate a session key when the record and reproduction apparatus has successfully authenticated the information process apparatus

causing the record and reproduction apparatus to bus-encrypt the second encrypted key that has been encrypted and recorded on the record medium with the session key and transfer the bus-encrypted second encrypted key to the information process apparatus,

causing the record and reproduction apparatus to bus-encrypt the third encrypted key with the session key and transfer the bus-encrypted third encrypted key to the information process apparatus,

causing the record and reproduction apparatus to bus-decrypt the encrypted and bus-encrypted content information supplied from the information process apparatus,

causing the record and reproduction apparatus to record the third encrypted key and the encrypted content information to the record medium,

causing the information process apparatus to store the first encrypted key,

causing the information process apparatus to authenticate the record and reproduction apparatus and generate the session key when the information process apparatus has successfully authenticated the record and reproduction apparatus,

causing the information process apparatus to bus-decrypt the bus-encrypted second encrypted key with the session key,

causing the information process apparatus to decrypt the second encrypted key with the first encrypted key,

causing the information process apparatus to bus-decrypt the bus-encrypted third encrypted key with the session key,

causing the information process apparatus to decrypt the third encrypted key with the second encrypted key,

causing the information process apparatus to encrypt the content information transferred to the record and reproduction apparatus with the third encryption, and

causing the information process apparatus to bus-encrypt the encrypted content information with the session key and send the bus-encrypted content information to the record and reproduction apparatus.

In addition, the present invention is a program of the record method and a record medium to which the program has been recorded.

A tenth aspect of the present invention is a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:

causing the record and reproduction apparatus to store the first encrypted key,

causing the record and reproduction apparatus to generate the second encrypted key,

causing the record and reproduction apparatus to encrypt the generated second encrypted key with the first encrypted key,

causing the record and reproduction apparatus to generate the third encrypted key,

causing the record and reproduction apparatus to encrypt the third encrypted key with the generated second encrypted key,

causing the record and reproduction apparatus to authenticate the information process apparatus and generate a session key when the record and reproduction apparatus has successfully authenticated the information process apparatus,

causing the record and reproduction apparatus to bus-encrypt the second encrypted key with the session key and transfers the bus-encrypted second encrypted key to the information process apparatus,

causing the record and reproduction apparatus to bus-encrypt the third encrypted key with the session key and transfer the bus-encrypted third encrypted key to the information process apparatus,

causing the record and reproduction apparatus to bus-decrypt the encrypted and bus-encrypted content information supplied from the information process apparatus, and

causing the record and reproduction apparatus to record the second encrypted key, the third encrypted key, and the encrypted content information to the record medium, and

causing the information process apparatus to store the first encrypted key,

causing the information process apparatus to authenticate the record and reproduction apparatus and generate the session key when the information process apparatus has successfully authenticated the record and reproduction apparatus,

causing the information process apparatus to bus-decrypt the bus-encrypted second encrypted key with the session key,

causing the information process apparatus to decrypt the second encrypted key with the first encrypted key,

causing the information process apparatus to bus-decrypt the bus-encrypted third encrypted key with the session key,

causing the information process apparatus to decrypt the third encrypted key with the second encrypted key,

causing the information process apparatus to encrypt the content information transferred to the record and reproduction apparatus with the third encryption, and

causing the information process apparatus to bus-encrypt the encrypted content information with the session key and send the bus-encrypted content information to the record and reproduction apparatus.

In addition, the present invention is a program of the record method and a record medium to which the program has been recorded.

An eleventh aspect of the present invention is a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:

causing the record and reproduction apparatus to store the first encrypted key,

causing the record and reproduction apparatus to reproduce the second encrypted key encrypted and recorded on the record medium and decrypt the second encrypted key with the first encrypted key,

causing the record and reproduction apparatus to generate the third encrypted key,

causing the record and reproduction apparatus to encrypt the third encrypted key with the decrypted second encrypted key,

causing the record and reproduction apparatus to authenticate the information process apparatus and generate a session key when the record and reproduction apparatus has successfully authenticated the information process apparatus,

causing the record and reproduction apparatus to bus-decrypt the bus-encrypted content information supplied from the information process apparatus,

causing the record and reproduction apparatus to encrypt the content information with the third encrypted key,

causing the record and reproduction apparatus to record the third encrypted key and the encrypted content information to the record medium, and

causing the information process apparatus to authenticate the record and reproduction apparatus and generate the session key when the information process apparatus has successfully authenticated the record and reproduction apparatus, and

causing the information process apparatus to bus-encrypt content information transferred to the record and reproduction apparatus with the session key and send the bus-encrypted content information to the record and reproduction apparatus. In addition, the present invention is a program of the record method and a record medium to which the program has been recorded.

A twelfth aspect of the present invention is a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:

causing the record and reproduction apparatus to store the first encrypted key,

causing the record and reproduction apparatus to generate the second encrypted key,

causing the record and reproduction apparatus to encrypt the generated second encrypted key with the first encrypted key,

causing the record and reproduction apparatus to generate the third encrypted key,

causing the record and reproduction apparatus to encrypt the third encrypted key with the generated second encrypted key,

causing the record and reproduction apparatus to authenticate the information process apparatus and generate a session key when the record and reproduction apparatus has successfully authenticated the information process apparatus,

causing the record and reproduction apparatus to bus-decrypt the bus-encrypted content information supplied from the information process apparatus,

causing the record and reproduction apparatus to encrypt the content information with the third encrypted key,

causing the record and reproduction apparatus to record the second encrypted key, the third encrypted key, and the encrypted content information to the record medium,

causing the information process apparatus to authenticate the record and reproduction apparatus and generate the session key when the information process apparatus has successfully authenticated the record and reproduction apparatus, and

causing the information process apparatus to bus-encrypt content information with the session key and send the bus-encrypted content information to the record and reproduction apparatus. In addition, the present invention is a program of the record method and a record medium to which the program has been recorded.

According to the present invention, content information is recorded according to an encryption system for example CSS scheme. Thus, recorded content information is identified as copyright protected information. In other words, when recorded content information is copied or reproduced by an illegal method that has not been properly licensed, it can be claimed that copyright of the content information is infringed. According to the present invention, the record and reproduction apparatus generates an encrypted key and writes it to a medium for example a DVD disc. When content information is recorded to the DVD disc according to the CSS system, an unlicensed user is prohibited from creating CSS written software. Thus, only a properly licensed person can create a CSS written application.

According to the present invention, the recording and reproduction apparatus generates an encrypted key and writes it to a medium. Thus, unlike CPRM, it is not necessary to pre-record key information to a record disc. As a result, the production cost of the disc can be decreased.

According to the present invention, random number data exchanged between a PC and a record and reproduction apparatus that mutually authenticate each other contains a type of a medium. Thus, the type of the medium can be securely sent from the record and reproduction apparatus to the PC. As a result, the type of the medium can be prevented from being falsified on a standardized interface between the PC and the record and reproduction apparatus and a falsified record and reproduction apparatus from pretending a proper apparatus.

According to the present invention, random number data exchanged between a PC and a record and reproduction apparatus that mutually authenticate each other contains copy generation management information (CGMS). Thus, CGMS can be securely sent from the record and reproduction apparatus to the PC. As a result, CGMS can be prevented from being falsified on a standardized interface between the PC and the record and reproduction apparatus and a falsified PC application from pretending a proper application.

According to the present invention, unless the PC and the record and reproduction apparatus have mutually and successfully authenticated each other, an encoder LSI (Large Scale Integrated Circuit) in the record and reproduction apparatus prohibits an encrypted key from being written to a disc. The encryption key writing prohibition function is disabled when the PC and the record and reproduction apparatus have mutually and successfully authenticated each other. Thus, an unlicensed user can be prohibited from creating CSS written software. As a result only a licensed person can create a CSS written application.

### BRIEF DESCRIPTION OF DRAWINGS

FIG. 1 is a block diagram showing a relationship of key information recorded to a ROM disc according to the CSS scheme.

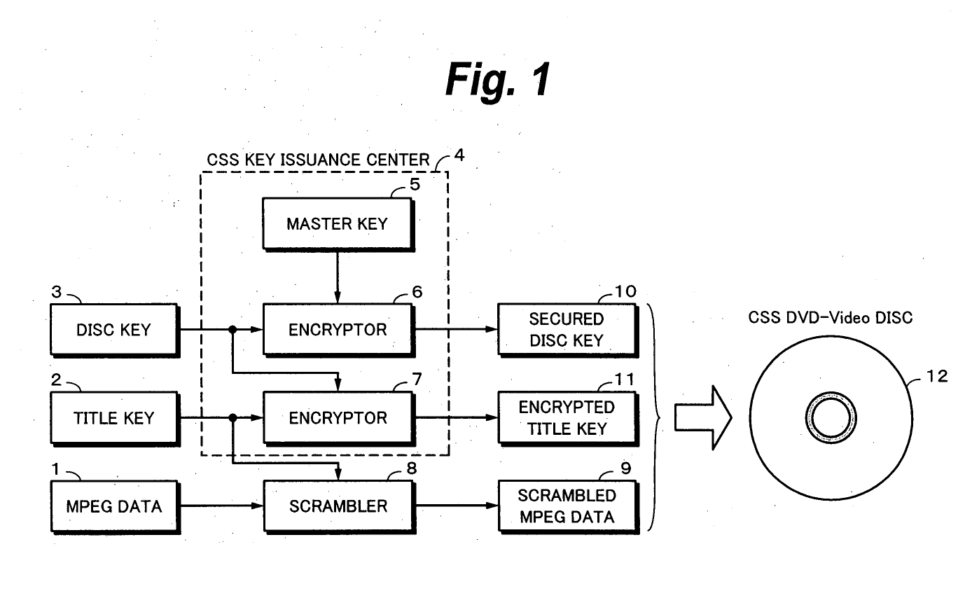

FIG. 2 is a block diagram showing a method of reproducing key information and scrambled data by a DVD player that reproduces data from a ROM disc according to the CSS scheme.

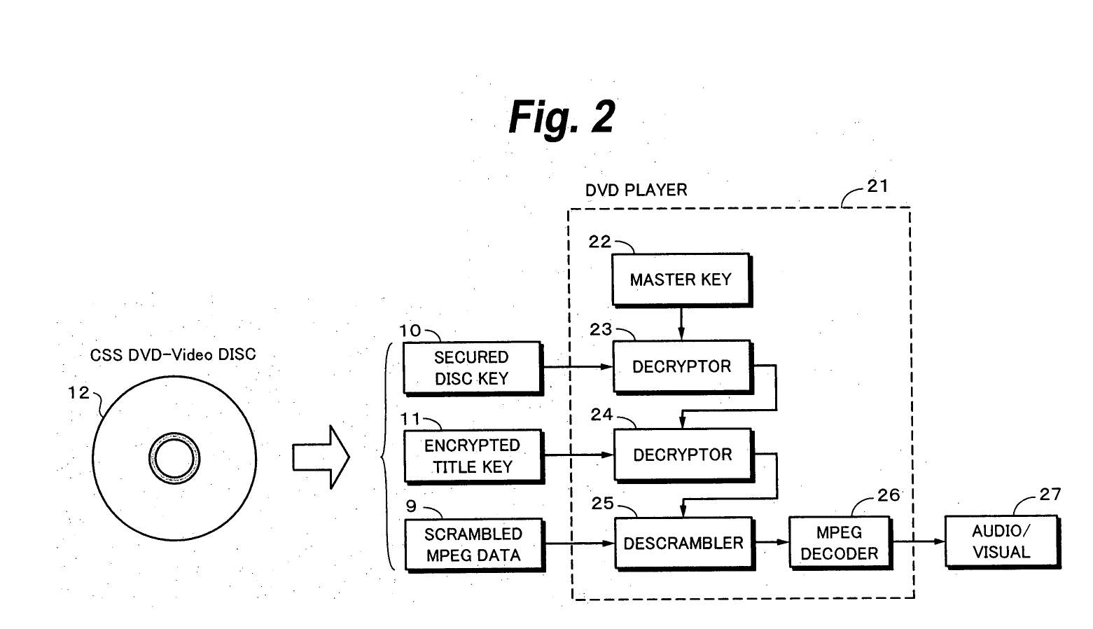

FIG. 3 is a schematic diagram showing a data structure of a lead-in area of the ROM disc.

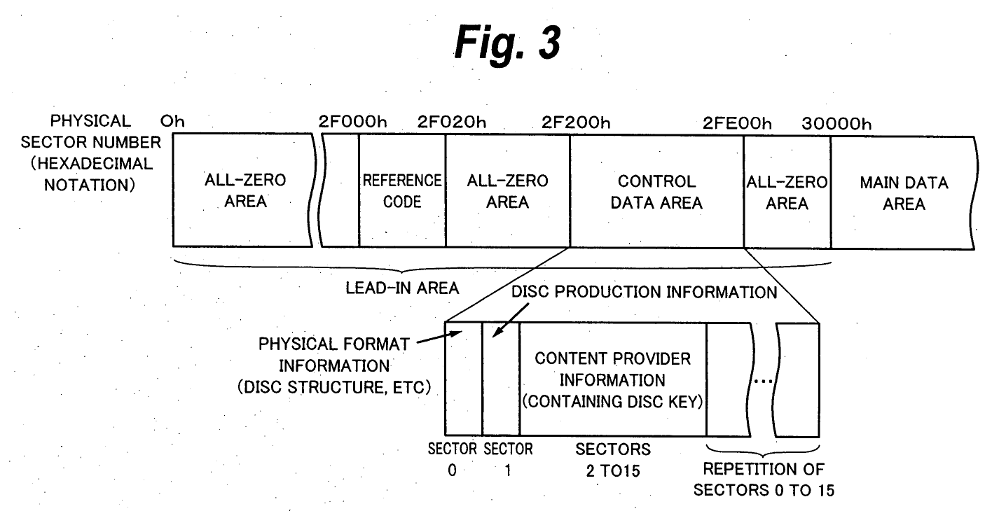

FIG. 4 is a schematic diagram showing a structure of sectors.

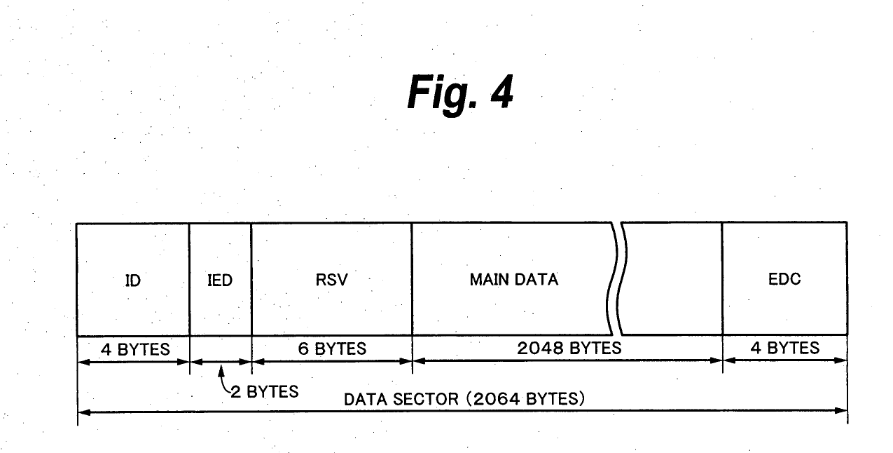

FIG. 5 is a schematic diagram describing a copy protection function according to the CSS scheme.

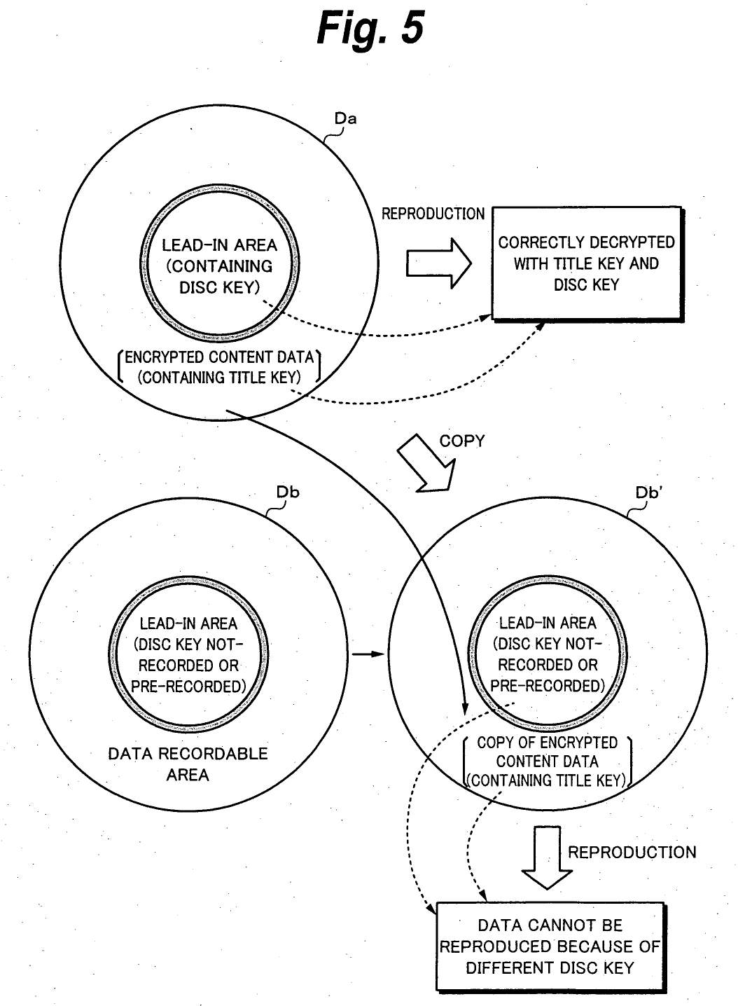

FIG. 6 is a block diagram showing a method of reproducing key information and scrambled data by a PC and a drive that reproduce data from a ROM disc according to the CSS scheme.

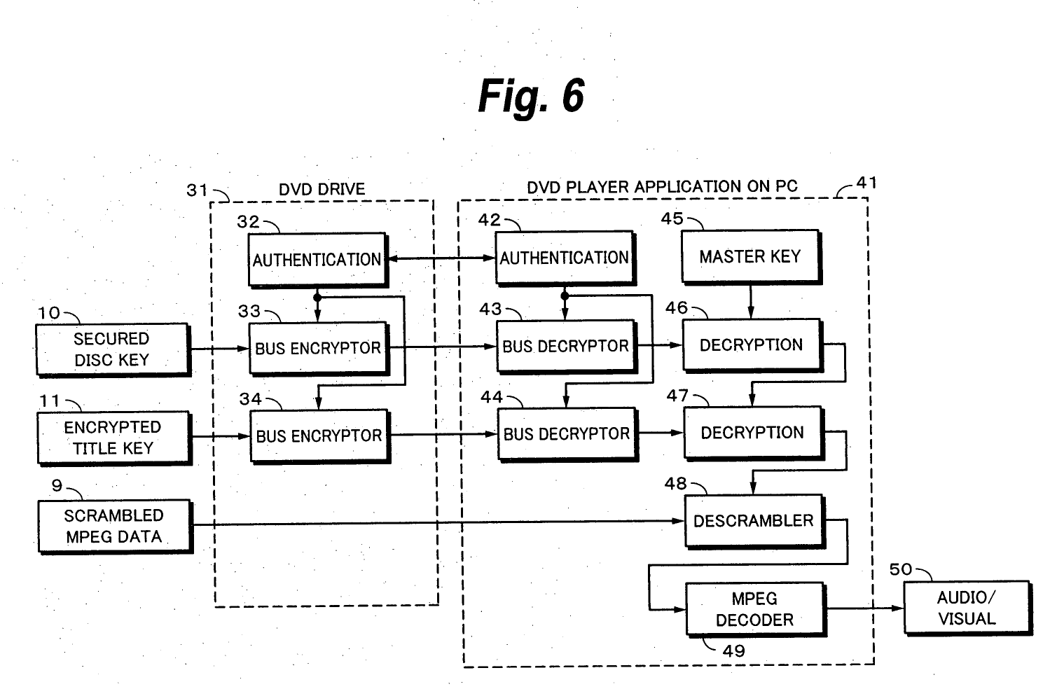

FIG. 7 is a schematic diagram showing a flow of data between the drive and the disc in the system shown in FIG. 6.

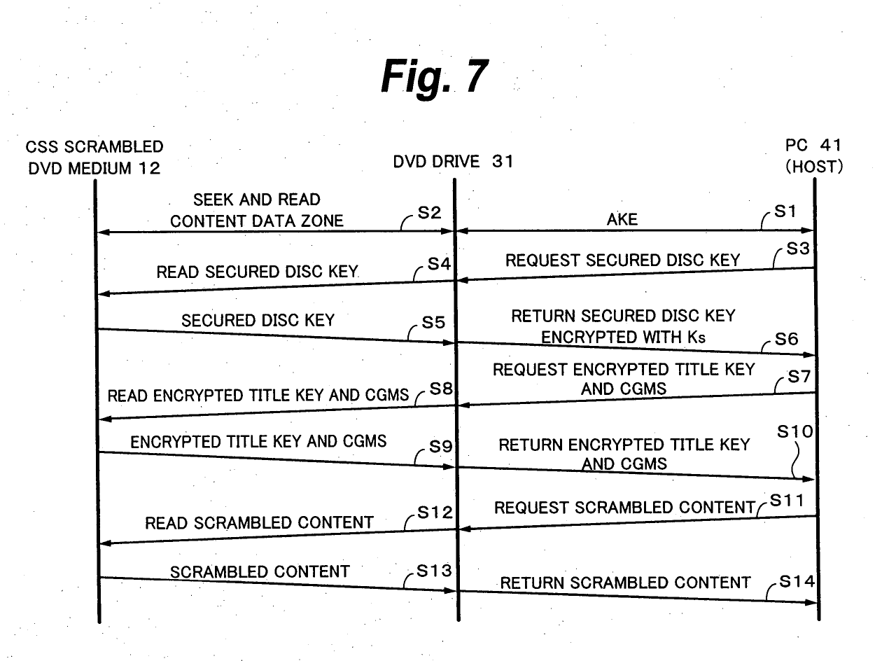

FIG. 8 is a block diagram showing an example of a record method of writing data to a recordable DVD medium having a pre-written disc key according to the CSS scheme.

FIG. 9 is a block diagram showing an example of a record method of writing data to a recordable DVD medium having no pre-written disc key according to the CSS scheme.

FIG. 10 is a block diagram showing an example of a record method of writing data to a recordable DVD medium having a pre-written disc key according to the CSS scheme, the record method being accomplished by a combination of a PC and a drive.

FIG. 11 is a schematic diagram showing a flow of data between the drive and the disk in the structure shown in FIG. 10.

FIG. 12 is a block diagram showing an example of a record method of writing data to a recordable DVD medium having no pre-written disc key according to the CSS scheme, the record method being accomplished by a combination of a PC and a drive.

FIG. 13 is a schematic diagram showing a flow of data between the drive and the disc in the structure shown in FIG. 12.

FIG. 14 is a block diagram showing a structure of bus-encrypted scrambled data and transferring the bus-encrypted scrambled data to the structure shown in FIG. 10.

FIG. 15 is a schematic diagram showing a flow of data between the drive and the disk in the structure shown in FIG. 14.

FIG. 16 is a block diagram showing a structure of bus-encrypted scrambled data and transferring the bus-encrypted scrambled data to the structure shown in FIG. 12.

FIG. 17 is a schematic diagram showing a flow of data between the drive and the disc in the structure shown in FIG. 16.

FIG. 18 is a block diagram showing a structure of a first embodiment of the present invention.

FIG. 19 is a schematic diagram showing a flow of data between the drive and the disc in the structure shown in FIG. 18.

FIG. 20 is a block diagram showing a structure of a second embodiment of the present invention.

FIG. 21 is a schematic diagram showing a flow of data between the drive and the disc in the structure shown in FIG. 20.

FIG. 22 is a block diagram showing a structure of a third embodiment according to the present invention.

FIG. 23 is a block diagram showing a structure of a fourth embodiment according to the present invention.

FIG. 24 is a block diagram showing a structure of a fifth embodiment according to the present invention of which a mask control mechanism for a title key is added to the structure shown in FIG. 18.

FIG. 25 is a block diagram showing a structure of a sixth embodiment according to the present invention of which a mask control mechanism for a disc key and a title key is added to the structure shown in FIG. 20.

FIG. 26 is a block diagram showing a structure of a seventh embodiment according to the present invention of which a mask control mechanism for a title key is added to the structure shown in FIG. 22.

FIG. 27 is a block diagram showing a structure of an eighth embodiment according to the present invention of which a mask control mechanism for a disc key and a title key is added to the structure shown in FIG. 23.

FIG. 28 is a schematic diagram showing a scheme of performing mutual authentication and generating a session key and a scheme of allowing the drive to securely inform the PC of a disc type.

FIG. 29 is a flow chart describing a process for information of a disc type on the drive side.

FIG. 30 is a flow chart describing a process for information of a disc type on the PC side.

FIG. 31 is a schematic diagram showing a scheme for performing mutual authentication and generating a session key and describing means for securely transmitting copy generation management information from the drive to the PC.

FIG. 32 is a block diagram showing an example in the case that AES is used to perform MAC calculation and generate a session key.

FIG. 33 is a flow chart showing processes from a process that mutually authenticate to a process that generate a session key.

FIG. 34 is a flow chart showing processes from a mutual authentication process to a session key generation process performed on the PC side.

FIG. 35 is a block diagram showing an example of bus encryption/decryption processes.

FIG. 36 is a flow chart showing a flow of the processes shown in FIG. 35.

FIG. 37 is a schematic diagram describing a structure of an AV pack and a range of bus encryption.

FIG. 38 is a schematic diagram showing a data structure of one sector.

FIG. 39 is a schematic diagram showing a flow of a data record process.

FIG. 40 is a schematic diagram describing data with which a mask control deals.

FIG. 41 is a block diagram showing an example of a structure of the mask control.

FIG. 42 is a block diagram showing an example of a structure of a filter in the mask control (CSS key write disable state).

FIG. 43 is a block diagram showing an example of a structure of a filter in the mask control (CSS key write enable state).

FIG. 44 is a block diagram showing an example of an application of a structure of a filter in the mask control.

FIG. 45 is a flow chart showing session key generation/erasure processes and a CSS key mask control process.

FIG. 46 is a block diagram showing another example of a master key generation method.

### BEST MODES FOR CARRYING OUT THE INVENTION

Next, the present invention will be described. For easy understanding of the present invention, several examples and problems of which a DVD recorder records data according to the CSS scheme will be described. In the following, only a record process for a DVD medium will be described. Since a reproduction process for the DVD medium is the same as the reproduction process according to the CSS scheme, the description will be omitted. Next, the relationships of terms used in claims and those used in embodiments will be described.

a record medium: a medium, for example a DVD writable disc; a record and reproduction apparatus: a drive; an information process apparatus: a personal computer, transfer means: an interface; a signal process system: a system that connects a drive that records and reproduces data to and from a medium and a personal computer through an interface.

content information: information to be recorded to a medium, for example audio/visual data are content information; a first encrypted key: a master key; a second encrypted key: a disc key recorded as a secured disc key; a third encrypted key: a title key recorded as an encrypted title key on a disc.

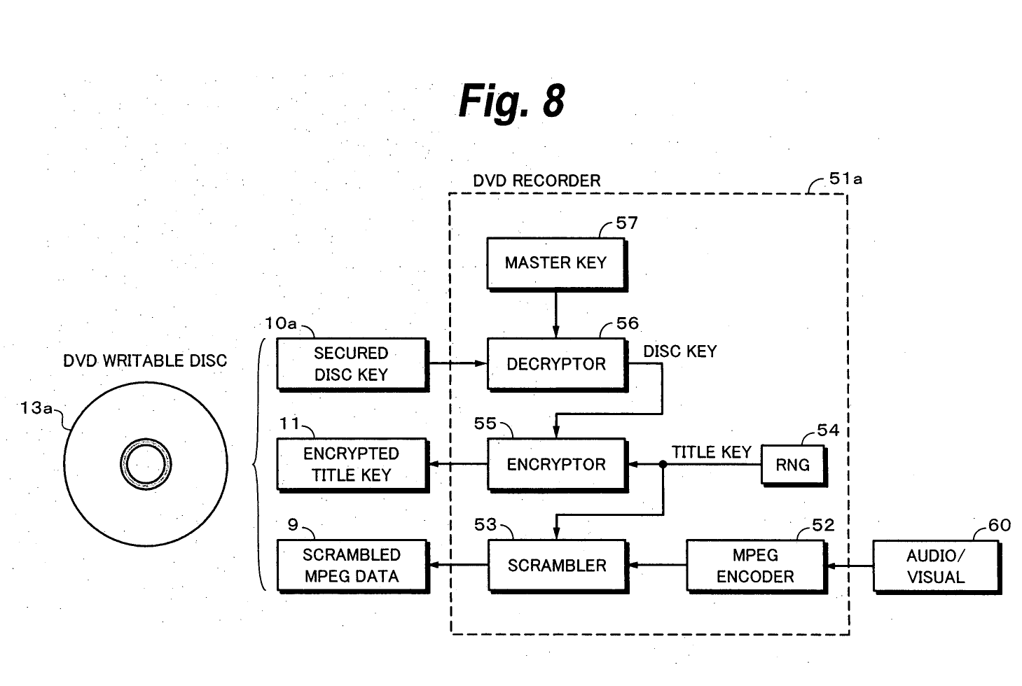

FIG. 8 shows an example of a record method of which a DVD recorder 51a writes a content to a recordable DVD medium (hereinafter sometimes referred to as a writable or recordable disc) 13a according to the CSS scheme. In this example, like the DVD-Video disc, a secured disc key 10a is pre-written at a predetermined location of a lead-in area of the writable disc 13a. An MPEG encoder 52 of the DVD recorder 51a compression-encodes audio/visual data 60. A scrambler 53 scrambles the compression-encoded data. Scrambled MPEG data 9, are recorded to the writable disc 13a.

An internal random number generator (RNG) 54 of the DVD recorder 51a generates a title key. Whenever the DVD recorder 51a records data, the random number generator 54 generate a title key. In addition, when the status of CGMS has changed, the random number generator 54 generates a title key. The scrambler 53 scrambles MPEG data with a title key. An encryptor 55 encrypts the title key. An encrypted title key 11 is recorded to the writable disc 13a. A decryptor 56 decrypts the recorded secured disc key 10a with a master key 57 and obtains a disc key.

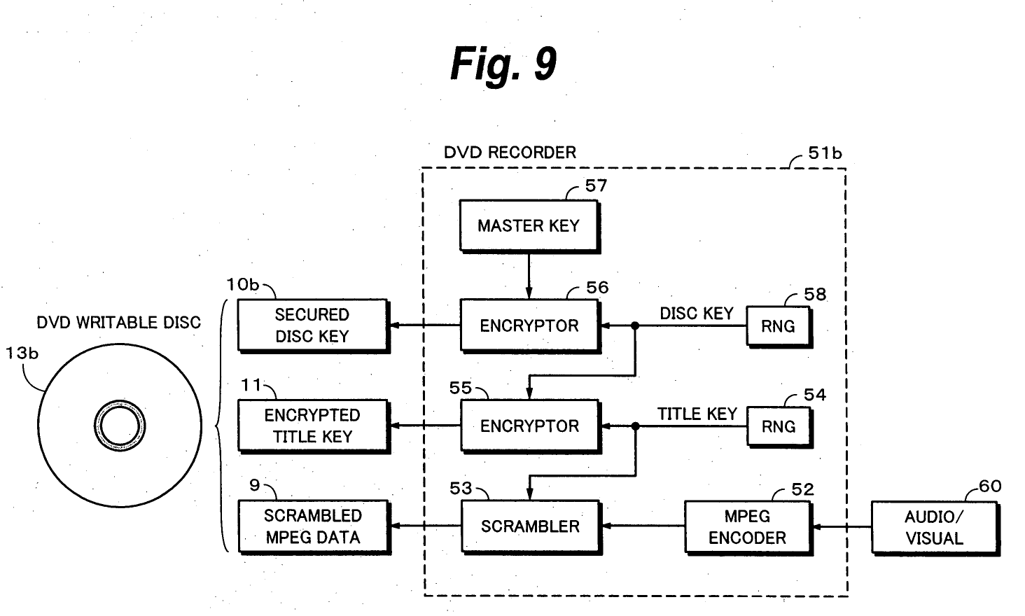

FIG. 9 shows an example of which a secured disc key as encrypted key information is not pre-written to a writable disc. A DVD recorder 51b has random number generators 54 and 58. The random number generators 54 and 58 generate a disc key and a title key. The DVD recorder 51b writes the disc key to a writable disc 13b. When the DVD recorder 51b formats a blank disc, the DVD recorder 51b writes the disc key to the writable disc 13b. This method allows the production cost of a recordable DVD medium to decrease in comparison with the method shown in FIG. 8 of which a disc key is post-written to the medium.

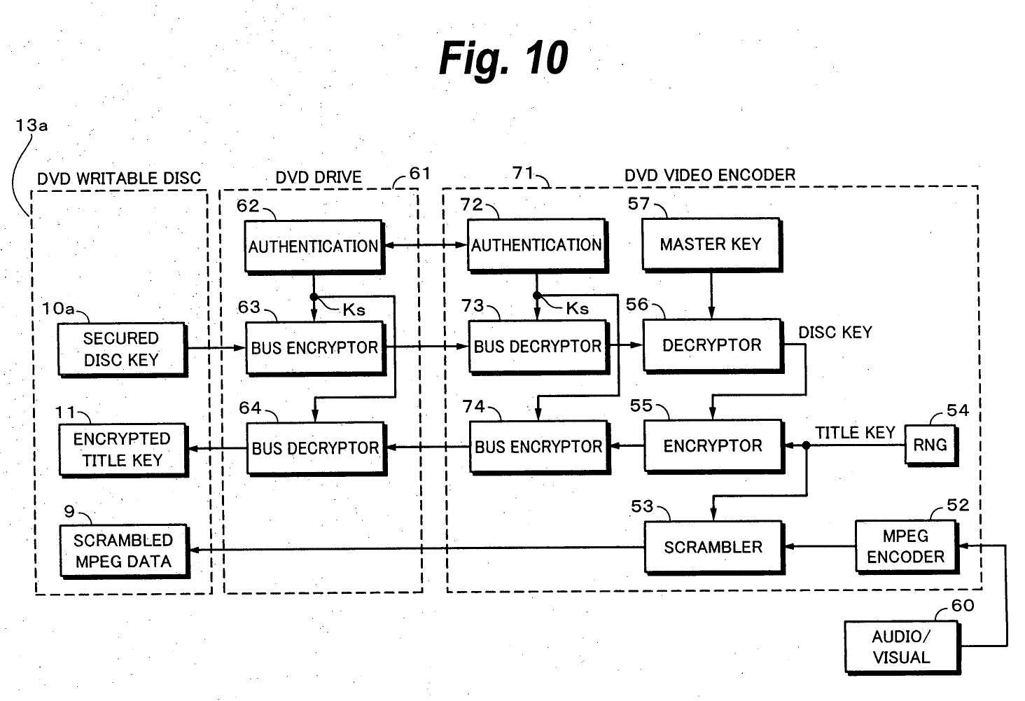

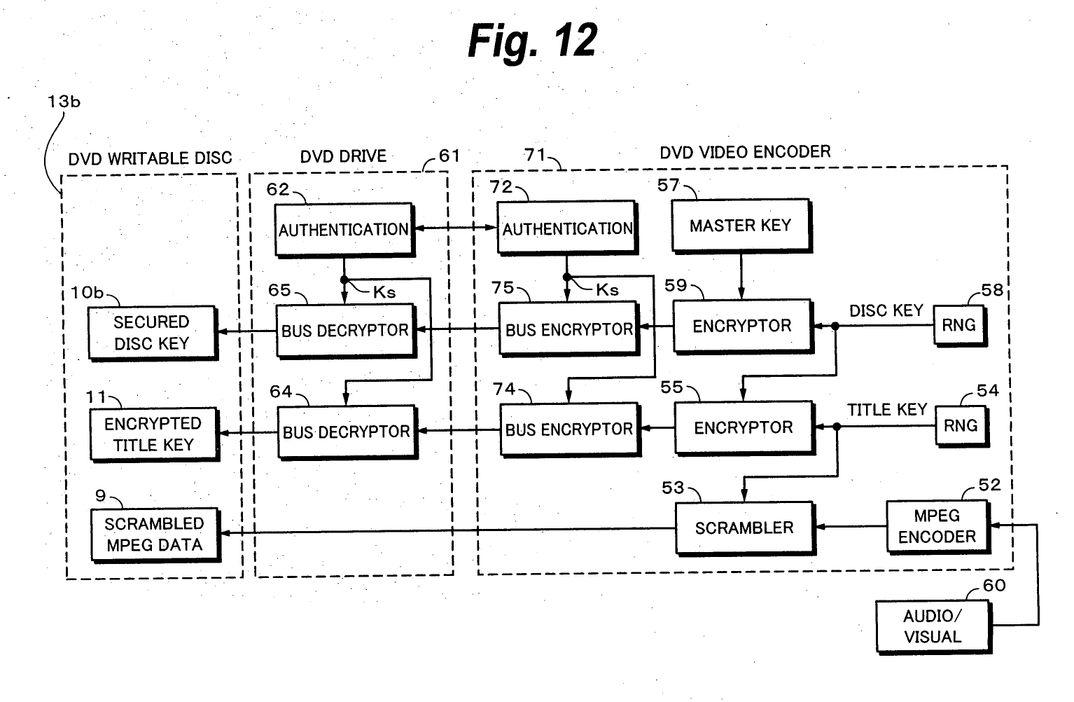

Structures shown in FIG. 10 and FIG. 12 are examples of which a function for writing a video content that has been scrambled according to the CSS scheme to a recordable DVD medium is accomplished by a combination of a PC and a drive.

In these drawings, reference numeral 61 denotes a DVD drive as a record and reproduction apparatus that records data to the writable disc 13a or 13b and reproduces data therefrom. Reference numeral 71 denotes a PC as a data process apparatus (host). Application software has been installed to the PC 71. Thus, the PC 71 functions as a DVD video encoder. However, the DVD video encoder is not limited to such a software process. Instead, the DVD video decoder may be accomplished by a hardware structure (circuit board structure).

The DVD drive 61 and the PC 71 are connected through an interface. The interface is for example ATAPI (AT Attachment with Packet Interface), SCSI (Small Computer System Interface), USB (Universal Serial Bus), or IEEE (Institute of Electrical and Electronics Engineers) 1394.

The DVD drive 61 has an authentication section 62, a bus encryptor 63, and a bus decryptor 64. The PC 71 has an authentication section 72, a bus decryptor 73, and a bus encryptor 74. In addition, the PC 71 has an MPEG encoder 52, a scrambler 53, a random number generator 54, an encryptor 55, a decryptor 56, and a master key 57. The MPEG encoder 52 compression-encodes the audio/visual data 60 and thereby converts them into DVD format stream data. The scrambler 53 scrambles the stream data with the title key. The scrambled data are supplied to the DVD drive 61 through an interface. The DVD drive 61 records the scrambled MPEG data 9 to the writable disc 13a.

The internal random number generator 54 of the PC 71 generates a title key. The scrambler 53 scrambles the MPEG data with the title key. The encryptor 55 encrypts the title key. The bus encryptor 74 encrypts the encrypted title key with a session key that the PC 71 generates when it has successfully authenticated the drive. Output data of the bus encryptor 74 is supplied to the bus decryptor 64 of the DVD drive 61. The bus decryptor 64 decrypts the encrypted title key with the session key. The encrypted title key 11 is recorded to the writable disc 13a.

The bus encryptor 63 of the DVD drive 61 encrypts the recorded secured disc key 10a with the session key that the PC 71 has generated when it has successively authenticated the drive. The secured disc key 10a is transferred from the DVD drive 61 to the PC 71 through an interface. The bus decryptor 73 decrypts the secured disc key 10a with the session key. In addition, the decryptor 56 decrypts the secured disc key 10a with the master key 57 and obtains the disc key.

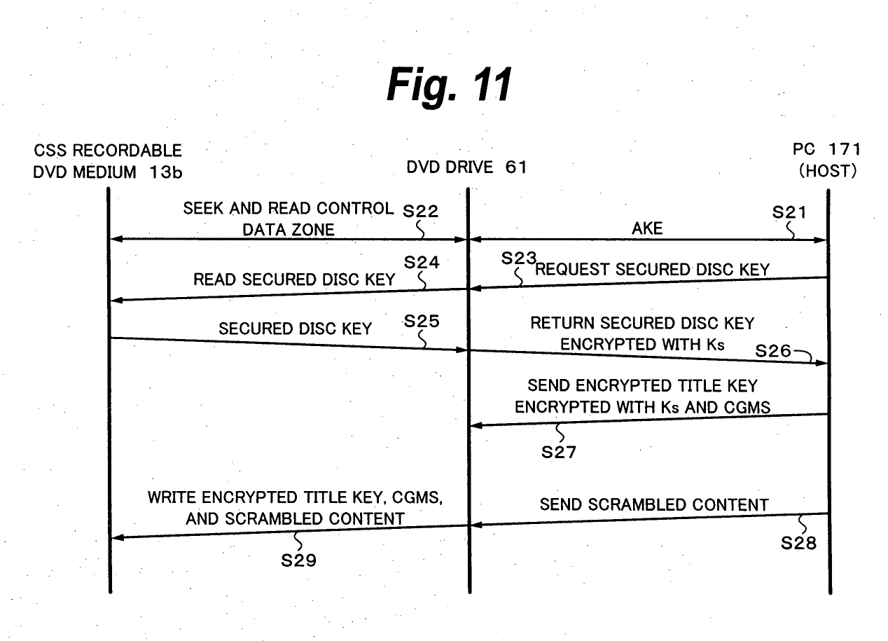

FIG. 11 shows a procedure for exchanging signals between the DVD drive 61 and the PC 71 in the system shown in FIG. 10. The PC 71 sends a command to the DVD drive 61. The DVD drive 61 performs an operation corresponding to the command. For example, when a writable disc is inserted into the DVD drive 61, a sequence is started. First, an authentication sequence AKE is performed (at step S21). When the DVD drive 61 and the PC 71 have mutually and successfully authenticated each other, they share a session key Ks. When they have not successfully and mutually authenticated each other, the process is terminated.

Thereafter, the DVD drive 61 seeks the control data zone on the writable disc 13a corresponding to a request from the PC 71 and reads control data therefrom (at step S22). At the next step, step S23, the PC 71 requests a secured disc key of the DVD drive 61. The DVD drive 61 reads the secured disc key (at steps S24 and S2.5). The bus encryptor 63 of the DVD drive 61 encrypts the secured disc key with the session key Ks. The DVD drive 61 sends the secured disc key to the PC 71 (at step S26). The bus decryptor 73 of the PC 71 decrypts the secured disc key. The decryptor 56 decrypts the secured disc key and obtains the disc key.

Thereafter, at step S27, the bus encryptor 74 of the DVD drive 61 encrypts the encrypted title key and the CGMS with the session key Ks. The encrypted title key is sent to the DVD drive 61. At step S28, the scrambler 53 sends scrambled MPEG data to the DVD drive 61. The DVD drive 61 records the encrypted title key, which the bus decryptor 6 has decrypted with the session key Ks, and the scrambled MPEG data to the writable disc 13a (at step S29).

The example of the structure shown in FIG. 12 is different from that shown in FIG. 10 in that a secured disc key is recorded to the writable disc 13b. Thus, the PC 71 has the random number generator 58, which generates a disc key. An encryptor 59 encrypts the disc key with a master key 57. A bus encryptor 75 encrypts the secured disc key with the session key Ks. An output of the bus encryptor 75 is transferred to the DVD drive 61 through an interface. A bus decryptor 65 decrypts the secured disc key with the session key Ks. The secured disc key is recorded to the writeable disc 13b. The other structure of the system shown in FIG. 12 is the same as that shown in FIG. 10.

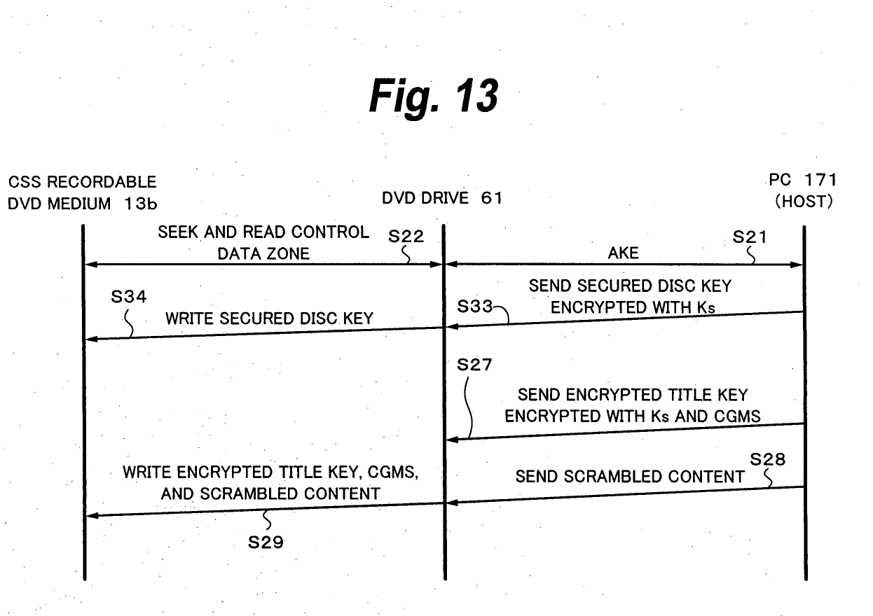

FIG. 13 shows a procedure for exchanging signals between the DVD drive 61 and the PC 71 in the system shown in FIG. 12. The procedure shown in FIG. 13 in the system shown in FIG. 12 is the same as the procedure shown in FIG. 11 in the system at shown in FIG. 10 except that the bus encryptor 75 sends a secured disc key encrypted with the session key. Ks to the DVD drive 61 (at step S33) and that the bus decryptor 65 of the DVD drive 61 writes the secured disc key decrypted with the session key Ks to the writable disc (at step S34).

When the structures or methods shown in FIG. 10 and FIG. 12 are used, a CSS encrypted data image generated by user created CSS write software can be adversely written by a normal write command. This is because the algorithm of the CSS scheme is not secret, but known. In the example shown in FIG. 10, when the DVD drive 61 and the PC 71 have mutually and successfully authenticated each other, the user can replace the application software with his or her own software. In addition, a person who has not made a CSS contract can create a CSS scrambler that scrambles a content with his or her created title key.

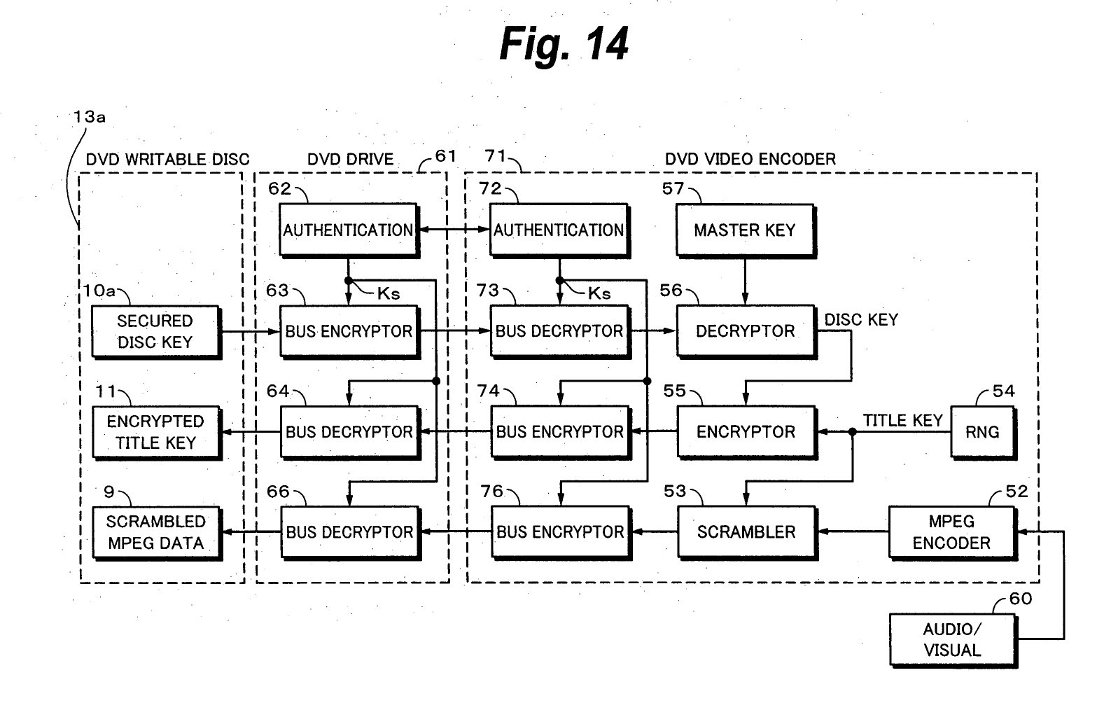

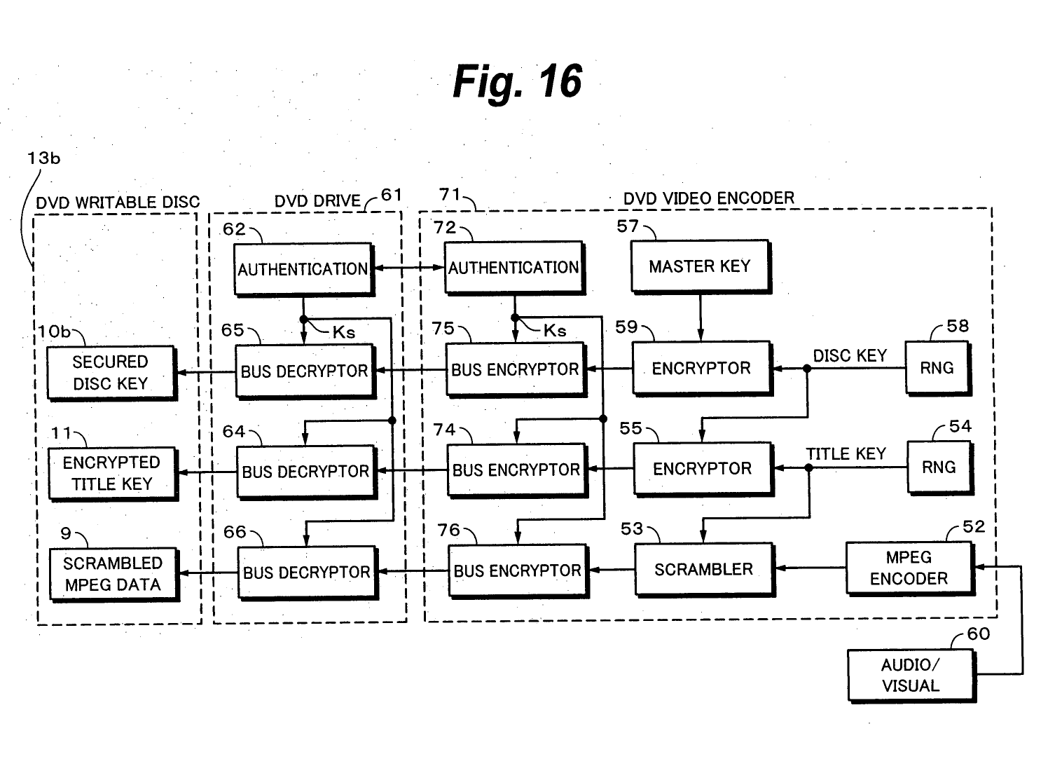

Next, another example of such a structure will be described. In the structures or methods shown in FIG. 10 and FIG. 12, since scrambled MPEG data pass through a standard interface such as ATAPI between the DVD drive 61 and the PC 71. Thus, there is a risk of which scrambled MPEG data that are being written to a writable disc may be stolen and the scrambled MPEG data may be descrambled by “DeCSS.” FIG. 14 and FIG. 16 show examples of structures that bus-encrypt and bus-decrypt scrambled MPEG data, respectively.

The example of the structure shown in FIG. 14 is the same as that of the system shown in FIG. 10 in that the secured disc key 10a is pre-recorded to the writable disc 13a. However, they are different in that a bus encryptor 76 encrypts scrambled MPEG data that are output from the scrambler 53 and the encrypted scrambled MPEG data are transferred to the DVD drive 61 through an interface. A bus decryptor 66 of the DVD drive 61 decrypts the encrypted data. As a result, the risk of which scrambled MPEG data that pass through the interface are stolen can be decreased.

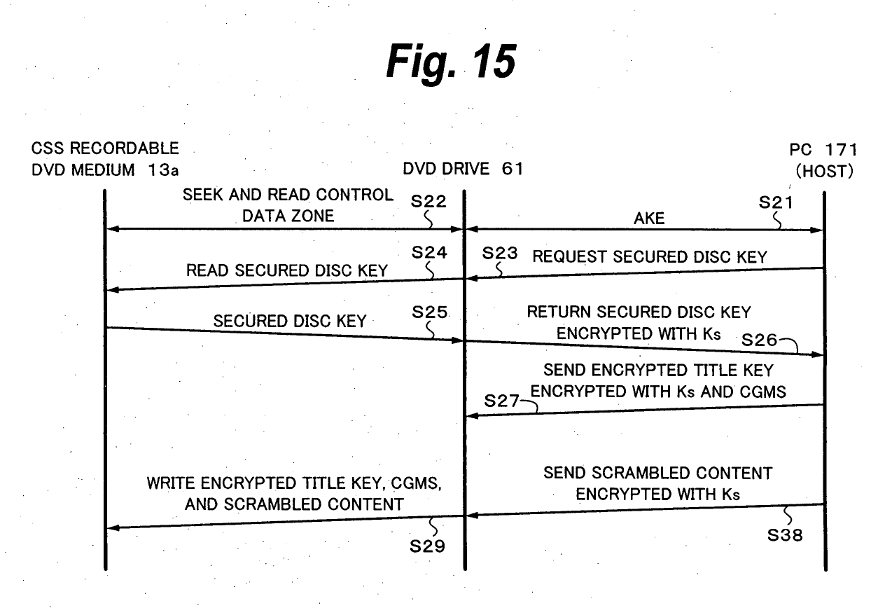

FIG. 15 shows a procedure for exchanging signals between the DVD drive 61 and the PC 71 in the system shown in FIG. 14. This procedure is the same as the procedure shown in FIG. 11 in the system shown in FIG. 10 except for step S38 at which scrambled MPEG data encrypted with the session key. Ks are sent instead of step S28 at which scrambled MPEG data are sent.

The example of the structure shown in FIG. 16 is the same as the structure shown in FIG. 12 in that a secured disc key 10b is recorded to the writable disc 13b except that the bus encryptor 76 encrypts scrambled MPEG data that are output from the scrambler 53, the encrypted scrambled MPEG data are transferred to the DVD drive 61, and the bus decryptor 66 of the DVD drive 61 decrypts the encrypted scrambled MPEG data. Thus, when the encrypted scrambled MPEG data pass through the interface, the risk of which the encrypted scrambled MPEG data are stolen can be decreased. For example, scrambled MPEG data may be stolen from a broadcast content, recorded to a hard disk, and then decrypted by the “DeCSS.”

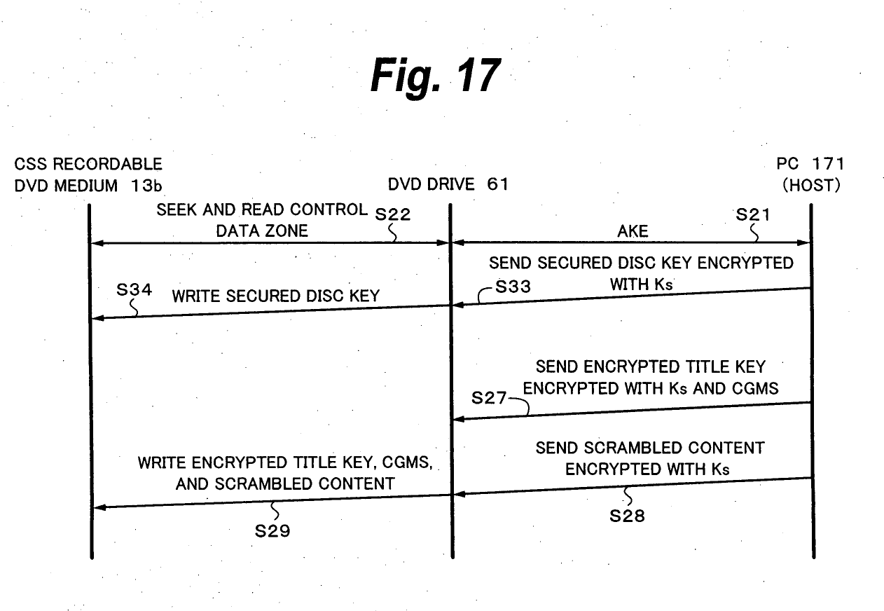

FIG. 17 shows a procedure for exchanging signals between the DVD drive 61 and the PC 71 in the system shown in FIG. 16. This procedure is the same as the procedure shown in FIG. 13 in the system shown in FIG. 12 except for step S38 at which scrambled MPEG data encrypted with the session key Ks are sent instead for step S28 at which scrambled MPEG data are sent.

When the structures or methods shown in FIG. 14 and FIG. 16 are used, a CSS encrypted data image generated by user created CSS write software can be adversely written by a normal write command.

The present invention can solve a problem that takes place in the case that the CSS is applied to data written to a writable disc. Next, with reference to the accompanying drawings, several embodiments of the present invention will be described.

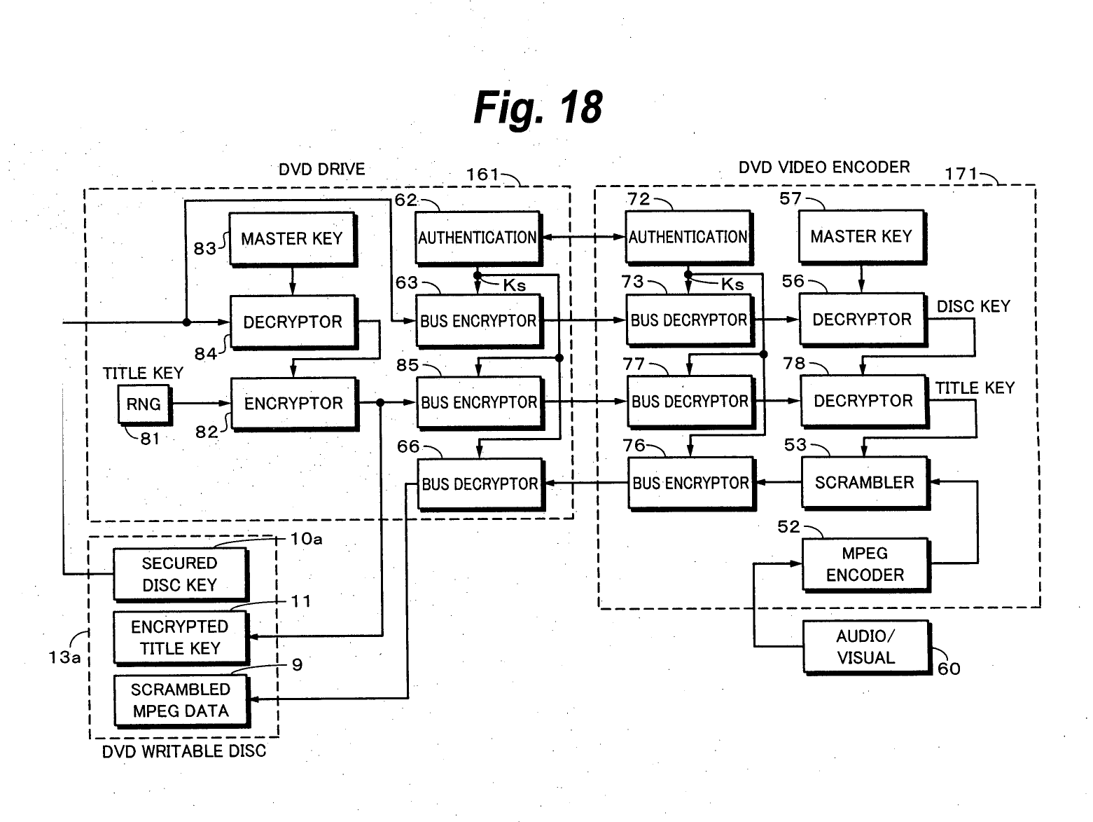

FIG. 18 shows an example of a structure of a system according to a first embodiment of the present invention. Reference numeral 161 denotes a DVD drive. Reference numeral 171 denotes an information process apparatus for example a PC that is connected to the DVD drive 161 through a standard interface and that functions as a host. When application software is installed to the PC 171 or hardware (circuit board) is mounted on the PC 171, it functions as a DVD video encoder. For example, a video encoder circuit board as hardware is mounted on a television tuner circuit board. According to the first embodiment, a writable disc 13a is used. A secured disc key 10a is pre-recorded in the lead-in area of the writable disc 13a. The writable disc is for example DVD+R/RW or DVD-R/RW.

The DVD drive 161 has a random number generator 81 that generates a title key, an encryptor 82 that encrypts the generated title key with a disc key, a master key 83, and a decryptor 84 that decrypts-a secured disc key with the master key. In addition, the DVD drive 161 has an authentication section 62, a bus encryptor 63 that encrypts the secured disc key with a session key Ks, and a bus decryptor 66 that decrypts scrambled MPEG data. The DVD drive 161 has these structural elements that have been-authorized by a CSS key issuance center. Since the DVD drive 161 is +composed of hardware (LSI), the DVD drive 161 has a tamper resistance of which the contents of the signal process are not exposed to the outside.

The decryptor 84 decrypts the secured disc key 10a read from the writable disc 13a with the master key 83. The disc key is supplied to the encryptor 82. The encryptor 82 encrypts the title key supplied from the random number generator 81 and thereby generates an encrypted title key. The encrypted title key is recorded to the writable disc 13a as defined in the CSS scheme.

The application software or hardware (circuit board) allows the PC 171 to function as a DVD video encoder. When the authentication section 62 of the DVD drive 161 and the authentication section 72 of the PC 171 have mutually and successfully authenticated each other, the session key Ks is generated. The bus encryptor 63 of the DVD drive 161 encrypts the secured disc key with the session key Ks. A bus encryptor 85 encrypts the encrypted title key with the session key Ks. The encrypted data are transferred to the PC 171 through the standard interface.

The bus decryptor 73 of the PC 171 decrypts the secured disc key with the session key Ks. A bus decryptor 77 decrypts an encrypted title key with the session key Ks. The decryptor 56 decrypts the disk key with the master key 57. A decryptor 78 decrypts the encrypted title key supplied from the bus decryptor 77 with the disc key and obtains the title key.

An MPEG encoder 52 compression-encodes audio/visual data 60 according to the MPEG2 system and converts the audio/visual data 60 into DVD format data. The MPEG encoder 52 converts a transport stream received as a digital broadcast into a program stream and DVD format data. The scrambler 53 scrambles output data of the MPEG encoder 52 with the title key. A bus encryptor 76 encrypts the scrambled MPEG data supplied from the scrambler 53 with the session key Ks. Output data of the bus encryptor 76 are transferred to the DVD drive 161 through the interface. The bus decryptor 66 of the DVD drive 161 decrypts the scrambled MPEG data and records them to the writable disc 13a. The structural elements except for the MPEG encoder 52 of the PC 171 are disposed with permission of the CSS key issuance center.

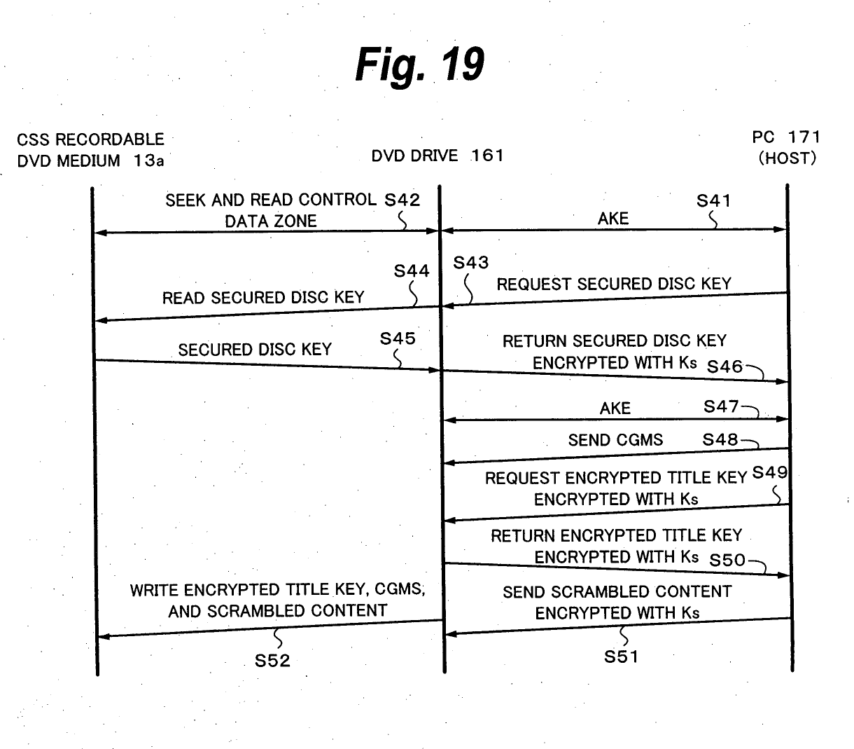

FIG. 19 shows a procedure for exchanging signals between the DVD drive 161 and the PC 171 in the system shown in FIG. 18. The PC 171 sends a command to the DVD drive 161. The DVD drive 161 performs an operation corresponding to the command. For example, when a writable disc is inserted into the DVD drive 161, a sequence is started. First, an authentication sequence AKE is performed (at step S41). After the DVD drive 161 and the PC 171 have mutually and successfully authenticated each other, they share the session key Ks. When they have not mutually and successfully authenticated each other, the process is terminated.

Thereafter, the DVD drive 161 seeks the control data zone of the writable disc 13a corresponding to a request from the PC 171 and reads control data (at step S42). At the next step, step S43, the PC 171 requests a secured disc key of the DVD drive 161. The DVD drive 161 reads the secured disc key (at step S44 and step S45). The bus encryptor 63 of the DVD drive 161 encrypts the secured disc key with the session key Ks. The DVD drive 161 sends the encrypted secured disc key to the PC 171 (at step S46). The bus decryptor 73 of the PC 171 decrypts the encrypted secured disc key with the session key Ks. The decryptor 56 decrypts the disc key.

Thereafter, the flow advances to step S47. At step S47, the authentication sequence AKE is performed. When the DVD drive 161 and the PC 171 have mutually and successfully authenticated each other, a session key Ks is newly generated. The DVD drive 161 and the PC 171 share the session key Ks. When they have not mutually and successfully authenticated each other, the process is terminated. When they have mutually and successfully authenticated each other, the flow advances to step S48. At step S48, the PC 171 sends the CGMS to the DVD drive 161. At step S49, the PC 171 requests a title key encrypted with the session key Ks of the DVD drive 161.

The DVD drive 161 supplies the encrypted title key supplied from the encryptor 82 to the encryptor 85. The encryptor 85 encrypts the encrypted title key with the session key Ks. The encryptor 85 sends the encrypted title key encrypted with Ks back to the PC 171 (at step S50).

The bus decryptors 77 and 78 of the PC 171 decrypt the encrypted title key and generate the title key. The scrambler 53 scrambles the MPEG data and generates the scrambled MPEG data. The bus encryptor 76 encrypts the scrambled MPEG data with the session key Ks and sends the scrambled MPEG data encrypted with Ks to the DVD drive 161 (at step S51). The bus decryptor 66 of the DVD drive 161 decrypts the received data with the session key Ks and obtains the scrambled MPEG data. The DVD drive 161 writes the scrambled MPEG data and the encrypted title key to the writable disc 13a (at step S52).

According to the first embodiment, the title key generated in the DVD drive 161 is securely transferred to the PC 171. The PC 171 scrambles data with the title key according to the CSS scheme. The DVD drive 161 writes the CSS scrambled MPEG data and the tile key generated by the DVD drive 161 to the writable disc 13a. Thus, according to the first embodiment, the PC side is prevented from falsifying the title key. In addition, with the falsified title key, data is prevented from being CSS scrambled. Thus, an unlicensed user is prevented from freely creating CSS scrambling writing software.

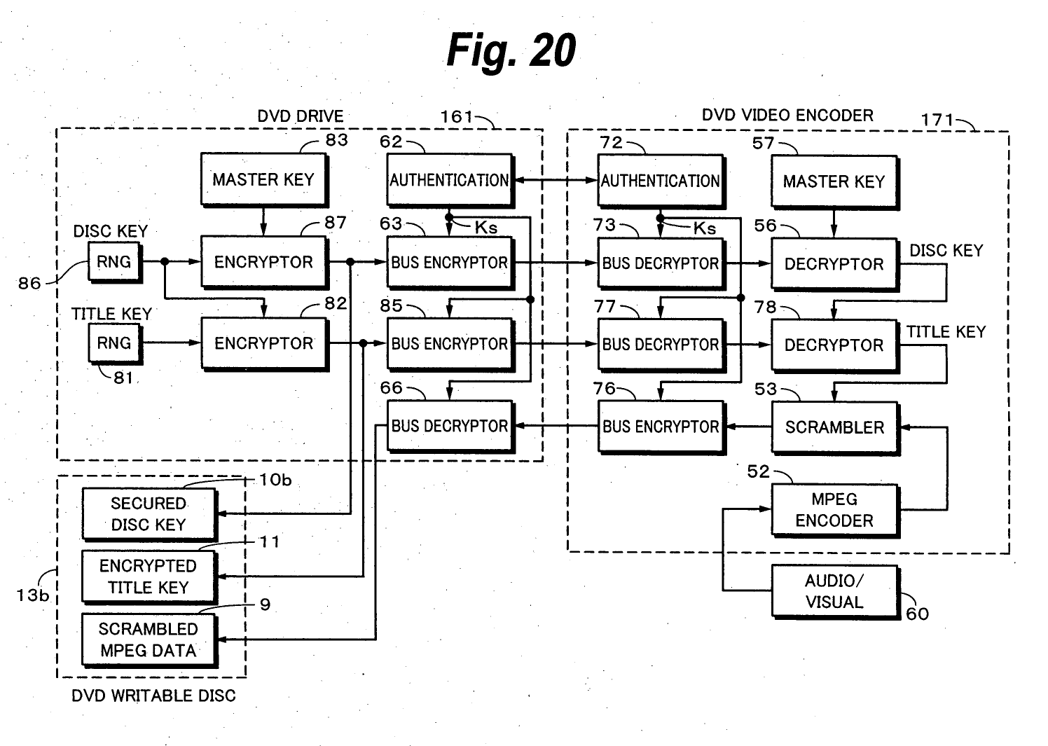

FIG. 20 shows a structure of a system according to a second embodiment of the present invention. According to the second embodiment, a secured disc key is recorded to a writable disc 13b. In addition to a random number generator 81 that generates a title key, a DVD drive 161 has a random number generator 86 that generates a disc key. An encryptor 82 encrypts the title key with the disc key. An encryptor 87 encrypts the disc key with a master key and generates a secured disc key 10b. The secured disc key 10b is recorded in a lead-in area of the writable disc 13b.

The structure and process of the second embodiment are the same as those of the first embodiment shown in FIG. 18 except that the disc key is generated, the generated disc key is encrypted, the secured disc key is generated, and the secured disc key 10b is recorded in the lead-in area.

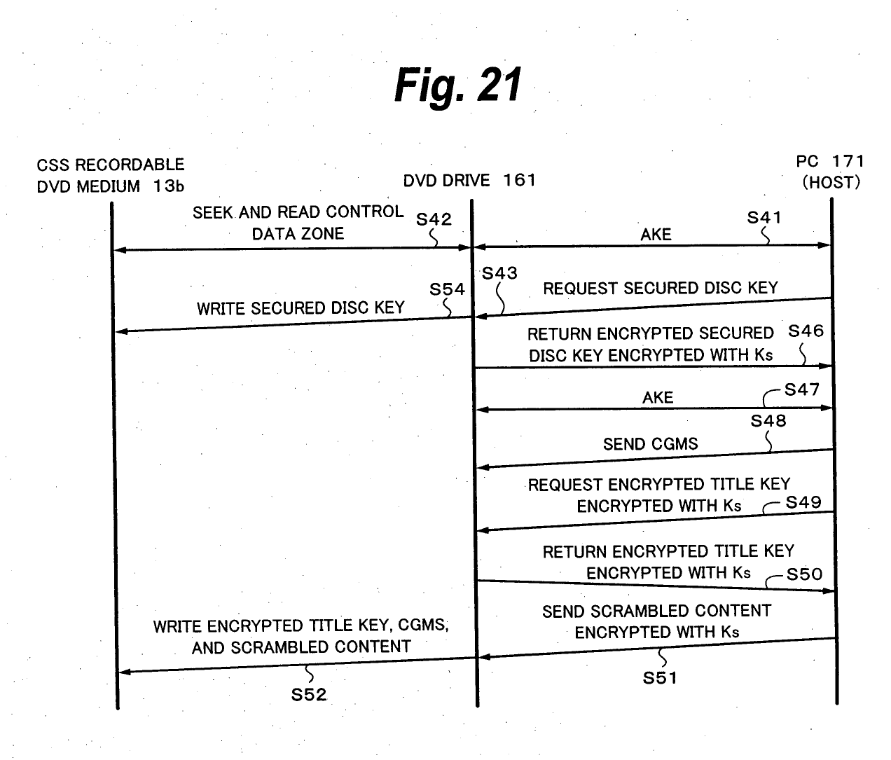

FIG. 21 shows a procedure for exchanging signals between the DVD drive 161 and the PC 171 in the system shown in FIG. 20. The procedure shown in FIG. 21 is the same as that shown in FIG. 19 except that when the PC 171 requests the secured disc key of the DVD drive 161, it records the secured disc key to the writable disc 13b at step S54, encrypts the secured disc key with the session key Ks, and returns the secured disc key back to the PC 171.

The second embodiment is a method of which the disk key and the title key generated in the DVD drive 161 are securely transferred to the PC 171, the video encoder of the PC side scrambles data with the disc key and the title key according to the CSS scheme, and the scrambled MPEG data received from the drive 161 and the secured disc key and the encrypted title key generated in the encrypted title key 11 are written to a writable disc. According to the second embodiment, the PC side is prevented from falsifying the title key and with the falsified title, data is prevented from being CSS scrambled. As a result, an unlicensed person is prevented from freely creating CSS scrambling writing software. In addition, since it is not necessary to pre-write a disc key to a DVD medium, the production cost of the DVD medium can be decreased.

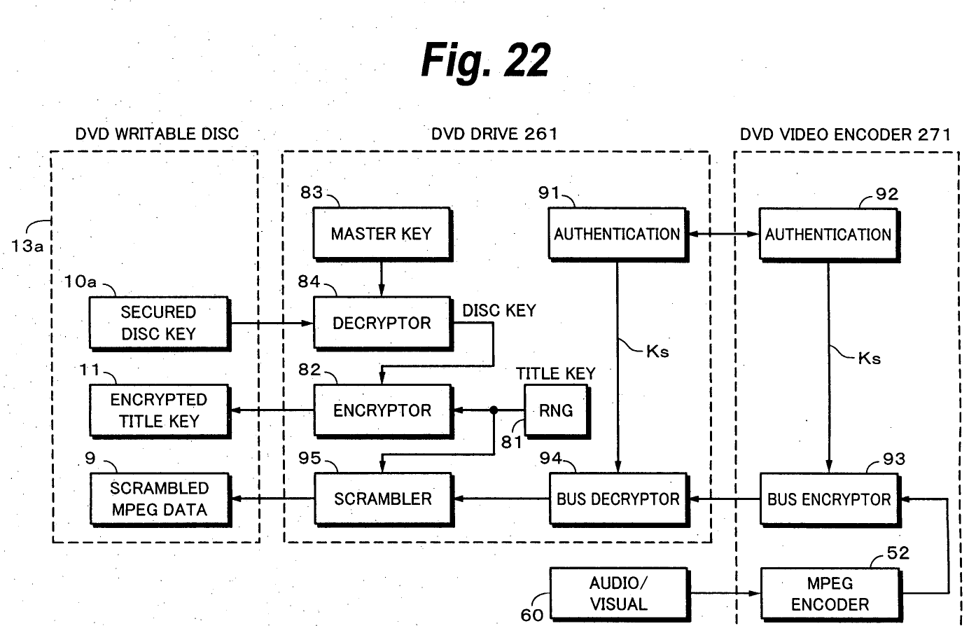

Next, with reference to FIG. 22, a third embodiment will be described. According to the third embodiment, a secured disc key is pre-recorded in a lead-in area of a writable disc 13a. A decryptor 84 decrypts a secured disc key 10a with a master key 83 and obtains a disc key. A random number generator 81 of a DVD drive 261 generates a title key. An encryptor 82 encrypts the title key with the disc key. The encrypted title key 11 supplied from the encryptor 82 is recorded to the writable disc 13a.

The DVD drive 261 has an authentication section 91. The authentication section 91 and an authentication section 92 of a PC 271 mutually authenticate each other. When they have mutually and successfully authenticated each other, they share a session key Ks. The mutual authentication method is not limited to a method according to the CSS scheme. Instead, a new mutual authentication method may be used as will be described later. When the new mutual authentication method is used, an unlicensed person is more securely prevented from creating CSS written software than the foregoing method.

Besides the authentication section 92, the PC 271 only has an MPEG encoder 52 that encodes audio/visual data 60 and a bus encryptor 93. The DVD drive 261 performs the other processes. The PC 271 does not have any keys and processes for scrambling data according to the CSS scheme, but only the mutual authentication function. As a result, the load of the PC 271 is remarkably decreased.

In the DVD drive 261, a bus decryptor 94 decrypts encrypted MPEG data encrypted with the session key Ks supplied from the PC 271. A scrambler 95 scrambles the MPEG data. Scrambled MPEG data 9 are recorded to the writable disc 13a. The scrambler 95 scrambles MPEG data with the title key generated by the random number generator 81 and generates the scrambled MPEG data.

Likewise, according to the third embodiment, the PC side is prevented from falsifying a title key. In addition, with the falsified title key, data are prevented from being CSS scrambled. Thus, an unlicensed person is prevented from freely creating CSS scrambling writing software. When the new mutual authentication method is used, an unlicensed person is securely prevented from creating writing software. In addition, the load of the PC side can be lightened.

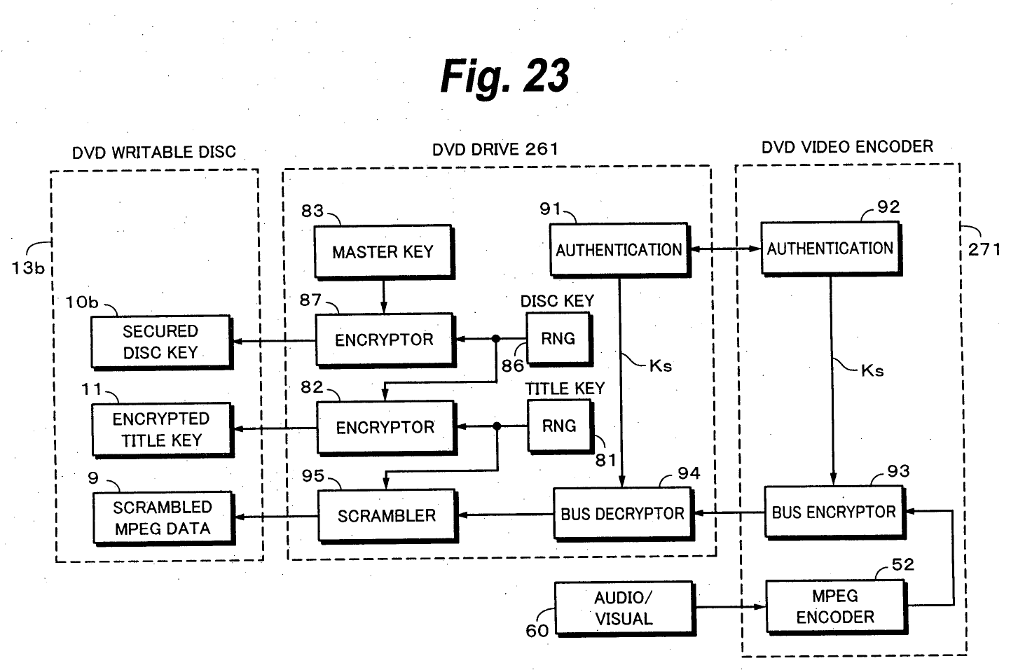

FIG. 23 shows a fourth embodiment. The difference between the fourth embodiment and the third embodiment is in that a random number generator 86 of a DVD drive 261 generates a disc key, an encryptor 87 encrypts the disc key with a master key 83, and the DVD drive 261 records a secured disc key 10b to a writable disc 13b. Like the third embodiment, the PC 271 has an authentication section 92, a bus encryptor 93, and an MPEG encoder 52.

The fourth embodiment has the same operation and effect as does the third embodiment. In addition, it is not necessary to pre-record a disc key to a DVD medium. Thus, the production cost of the medium can be decreased.

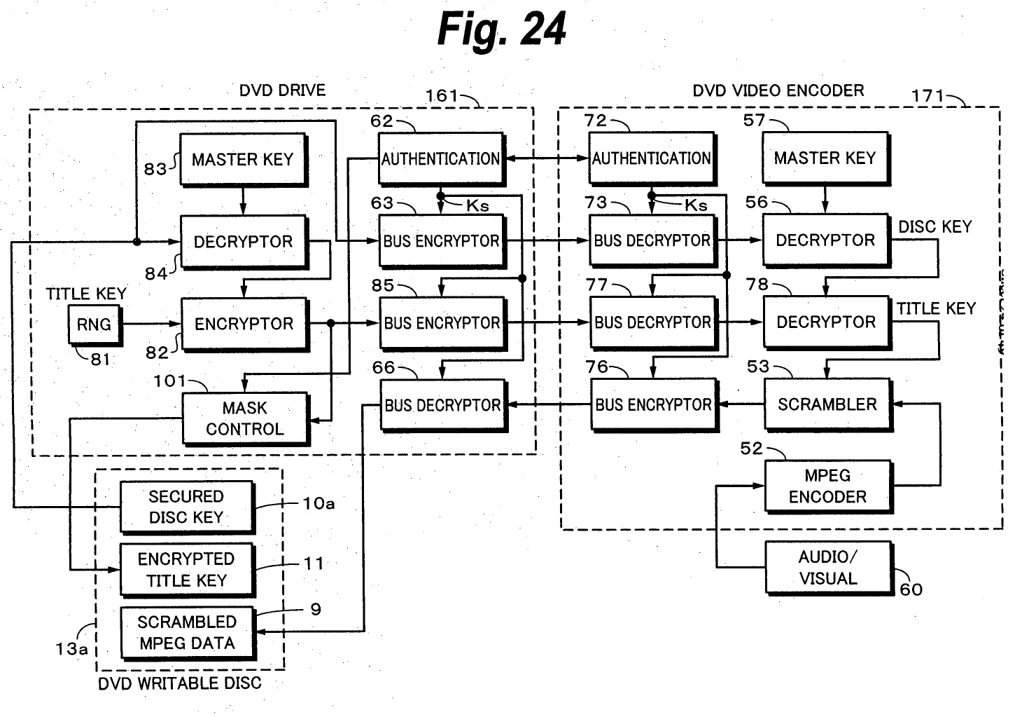

FIG. 24 shows a fifth embodiment of which a mask control 101 as a mask control mechanism for an encrypted title key is added to the structure of the first embodiment shown in FIG. 18. An encrypted title key is input from an encryptor 82 to the mask control 101. An encrypted title key 11 that is output from the mask control 101 is recorded to a writable disc 13a.

The mask control 101 controls a mask function corresponding to an authenticated result of a authentication section 62 of a DVD drive 161. When a PC 171 and the DVD drive 161 have mutually and successfully authenticated each other and a session key has been generated, the mask function is disabled. As a result, an encrypted title key 11 is recorded to the writable disc 13a. In contrast, when they have not mutually and successfully authenticated each other, the mask function is enabled. As a result, the encrypted title key 11 is replaced with invalid data or dummy data such as zero data. Thus, the encrypted title key is substantially prohibited from being written to the writable disc 13a.

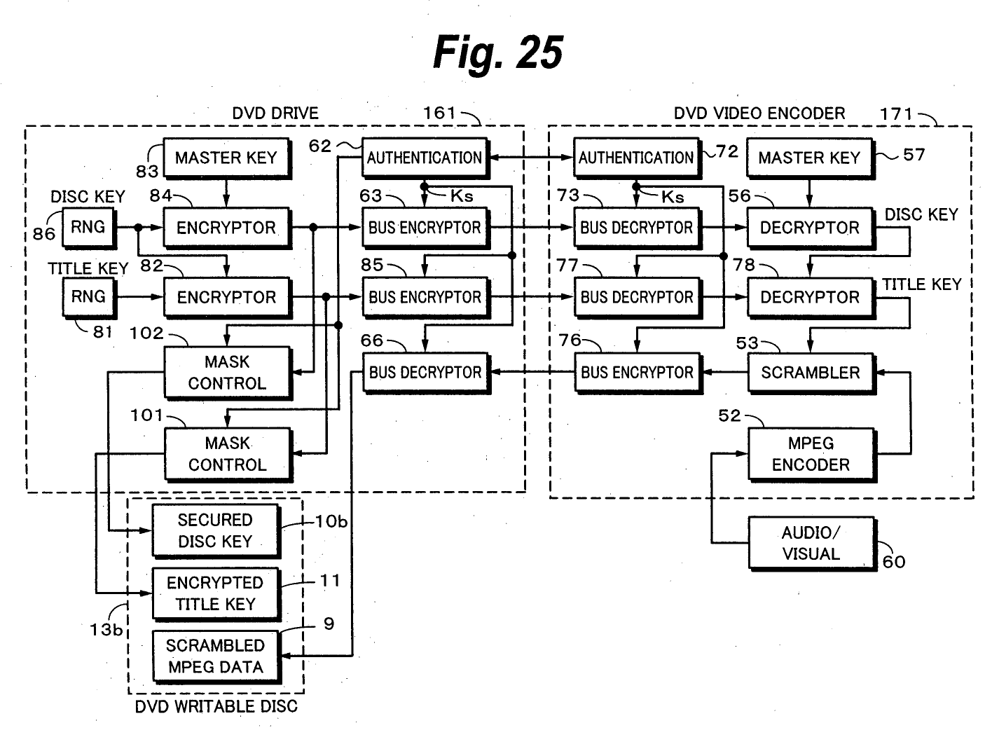

FIG. 25 shows a sixth embodiment of which a mask control 101 as a mask control mechanism for an encrypted title key and a mask control 102 as a mask control mechanism for a secured disc key are added to the structure of the second embodiment shown in FIG. 20. Like the mask control 101, the mask control 102 performs a mask function for the secured disc key. In other words, when a PC 171 and a DVD drive 161 have mutually and successfully authenticated each other and a session key Ks has been generated, the mask function is disabled. As a result, a secured disc key 10b is recorded to a writable disc 13b. In contrast, when they have not mutually and successfully authenticated each other, the mask function is enabled. As a result, the secured disc key 10b is not recorded to the writable disc 13b.

According to the fifth and sixth embodiments, depending on the mutual authentication result, the CSS key written to a disc is controlled. As a result, an unlicensed user is securely prohibited from creating CSS written software. Thus, only a licensed person can create CSS written application software.

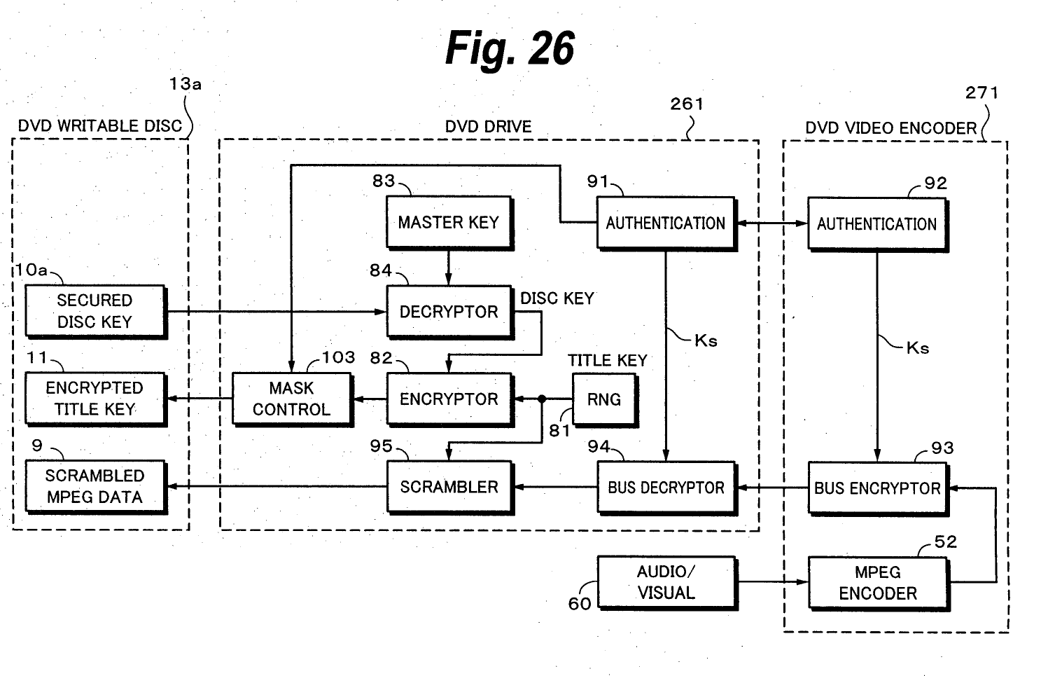

FIG. 26 shows a seventh embodiment of which a mask control 103 as a mask control mechanism for an encrypted title key is added to the structure of the third embodiment shown in FIG. 22. An encrypted title key is input from an encryptor 82 to the mask control 103. An encrypted title key 11 that is output from the mask control 103 is recorded to a writable disc 13a.

The mask control 103 controls the mask function corresponding to an authenticated result of an authentication section 62 of a DVD drive 161. In other words, when a PC 171 and the DVD drive 161 have mutually and successfully authenticated each other and a session key Ks has been generated, the mask function is disabled and the encrypted title key 11 is recorded to the writable disc 13a. In contrast, when they have not mutually and successfully authenticated each other, the mask function is enabled and the encrypted title key 11 is not recorded to the writable disc 13a.

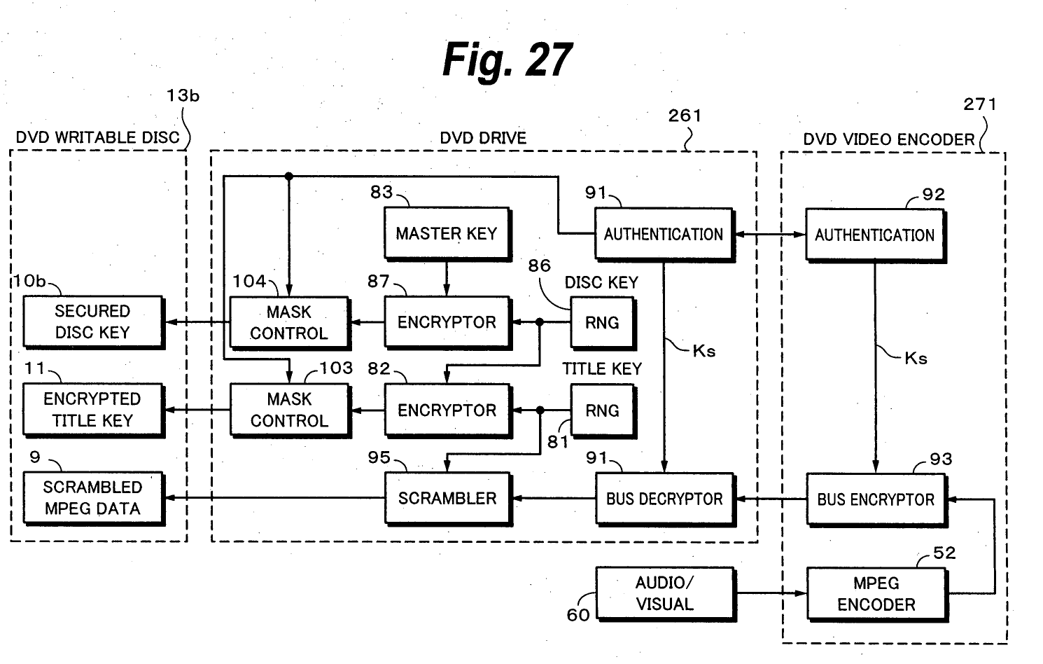

FIG. 27 shows an eighth embodiment of which a mask control 103 as a mask control mechanism for an encrypted title key and a mask control 104 as a mask control mechanism for a secured disc key are added to the structure of the fourth embodiment shown in FIG. 23. Like the mask control 103, the mask control 104 has a mask function for a secured disc key. In other words, when a PC 171 and a DVD drive 161 have mutually and successfully authenticated each other and a session key Ks has been generated, the mask function is disabled and a secured disc key 10b is recorded to a writable disc 13b. In contrast, when they have not mutually and successfully authenticated each other, the mask function is enabled and the secured disc key 10b is not recorded to the writable disc 13b.

According to the seventh and eighth embodiments., depending on the mutual authentication result, the CSS key written to a disc is controlled. As a result, an unlicensed user is securely prohibited from creating CSS written software. Thus, only a licensed person can create CSS written application software.

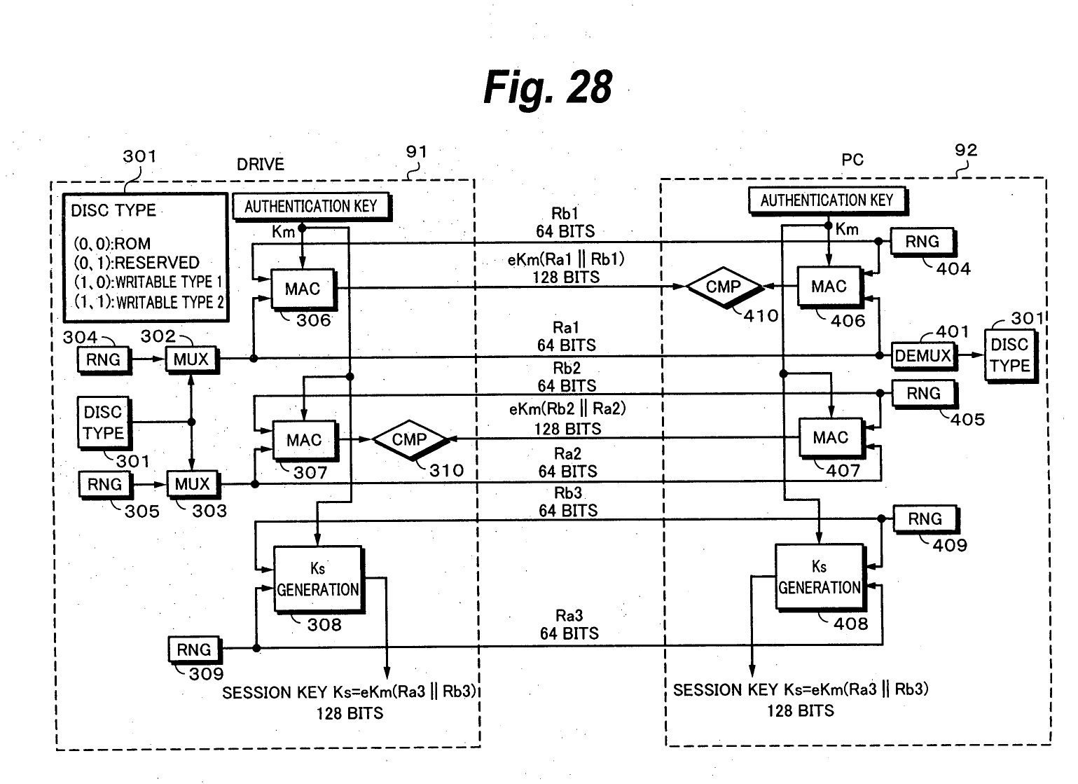

FIG. 28 describes an example of the authentication mechanism or method of the authentication sections 91 and 92 according to the third embodiment (FIG. 22), the fourth embodiment (FIG. 23), the seventh embodiment (FIG. 26), and the eighth embodiment (FIG. 27). In the example shown in FIG. 28, after a PC and a DVD drive have mutually and successfully authenticated each other, a session key is generated. In addition, information of a disc type is securely sent from the drive to the PC. The disc type data are two-bit information defined as follows.

(0, 0): ROM (0, 1): undefined (1, 0): writable type 4 (1, 1): writable type 2

In one example, type 1 denotes a rewritable disc and type 2 denotes one-time recordable disc. In another example, type 1 denotes a disc to which data can be written according to the CSS scheme and type 2 denotes a disc to which data cannot be written, according to the CSS scheme. The disc type is recorded at a predetermined location of the lead-in area of the disc. The disc type may be recorded as information of a wobbling groove. The disc type may be determined as an optical characteristic of the disc. In FIG. 28, reference numeral 301 denotes disc type data.

The disc type data 301 are supplied to a multiplexers 302 and 303. The multiplexers 302 and 303 mix the disc type data 301 with random numbers generated by random number generators 304 and 305, respectively. As a result, 64-bit random number data Ra1 and Ra2, containing the disc type data, are generated. The disc type data are located in predetermined two-bit positions for example low-order two bits of a 64-bit random number. The random numbers Ra1 and Ra2 are sent to the PC side. A demultiplexer 401 of the PC obtains the disc type data 301 from the random number Ra1. The PC executes application software corresponding to the obtained disc type data.

An authentication section 91 of the DVD drive 161 has an authentication key Km. The authentication key Km is normally located in an LSI and securely stored so that the authentication key Km cannot be read to the outside. To allow the DVD drive 161 to record data according to the CSS scheme, the DVD drive 161 requires secret information about copyright protection technology such as the authentication key Km. Thus, a clone drive that has not been properly licensed and that pretends a licensed product can be prevented from being produced.

Reference numerals 306, 307, and 308 denote MAC (Message Authentication Code) calculation blocks that calculate MAC values with the authentication key Km as a parameter. Reference numerals 304, 305, and 309 are random number generators that generate 64-bit random numbers. As described above, the multiplexer 302 multiplexes the disc type and a random number and outputs the random number Ra1. The random number Ra1 is supplied to the MAC calculation block 306. The random number Ra2 that is output from the multiplexer 303 is supplied to the MAC calculation block 307. In addition, the random number generator 309 generates a random number Ra3. The random number generators 304, 305, and 309 are for example LSI random number generators. They can generate more real random numbers than do software random number generators. These random number generators may be composed of common hardware. However, the random numbers Ra1, Ra2, and Ra3 need to be independent random numbers.

An authentication section 92 on the PC side has an authentication key Km. The authentication section 92 has MAC calculation blocks 406, 407, and 408 that calculate MAC values with the authentication key Km as a parameter. The authentication section 92 also has random number generators 404, 405, and 409 that generate 64-bit random numbers Rb1, Rb21 and Rb3, respectively. The random numbers 28Rb1, Rb2, and Rb3 are supplied to the MAC calculation blocks 406, 407, and 408 of the authentication section 92 on the PC side. In addition, the random numbers Rb1, Rb2, and Rb3 are transferred to the DVD drive side and supplied to the MAC calculation blocks 306, 307, and 308, respectively. Although the random number generators 404, 405, and 409 are normally software random number generators, they may be hardware random number generators.

The random numbers generated in the authentication section 91 of the DVD drive are exchanged with the random numbers generated in the authentication section 92 of the PC. In other words, the random number Ra1 and the random number Rb1 are input to the MAC calculation blocks 306 and 406. The random number Ra2 and the random number Rb2 are input to the MAC calculation blocks 307 and 407. The random number Ra3 and the random number Rb3 are input to the MAC calculation blocks 308 and 408.

A comparison 410 of the authentication section 92 compares a MAC value calculated by the MAC calculation block 306 and a MAC value calculated by the MAC calculation block 406. The authentication section 92 determines whether the two values are the same. A MAC value is denoted by eKm (Ra1∥Rb1) where eKm ( ) denotes that data in parentheses are encrypted with the authentication key Km. Ra1∥Rb1 denotes that two random numbers are connected so that random numbers Ra1 and Rb1 are placed on the left and right, respectively. When the compared result denotes that the two values are the same, the PC has successfully authenticated the DVD drive. Otherwise, the PC has failed to authenticate the DVD drive.

A comparison 310 of the authentication section 91 of the drive compares a MAC value calculated by the MAC calculation block 307 with a MAC value calculated by the MAC calculation block 407. The comparison 310 determines whether these values are the same. A MAC value is denoted by eKm (Rb2∥Ra2). When the compared result denotes that these values are the same, the DVD drive has successfully authenticated the PC. Otherwise, the DVD drive has failed to authenticate the PC.

When the comparisons 310 and 410 have determined that the MAC values are the same and the DVD drive and the PC have mutually and successfully authenticated each other, the MAC calculation blocks 308 and 408 generate a common session key eKm (Ra3∥Rb3). In such a manner, the MAC calculated values are exchanged and it is determined whether they match, a key can be prevented from being falsified and disguised. According to the present invention, one of the PC and the DVD drive may authenticate the other instead of mutual authentication.

In another example, disc type data may be defined as follows.

(0, 0): ROM (0, 1): undefined (normal writable) (1, 0): undefined (normal writable) (1, 1): video writable disc (video data can be recorded according to CSS/CPRM, private record compensation money being contained in disc price).

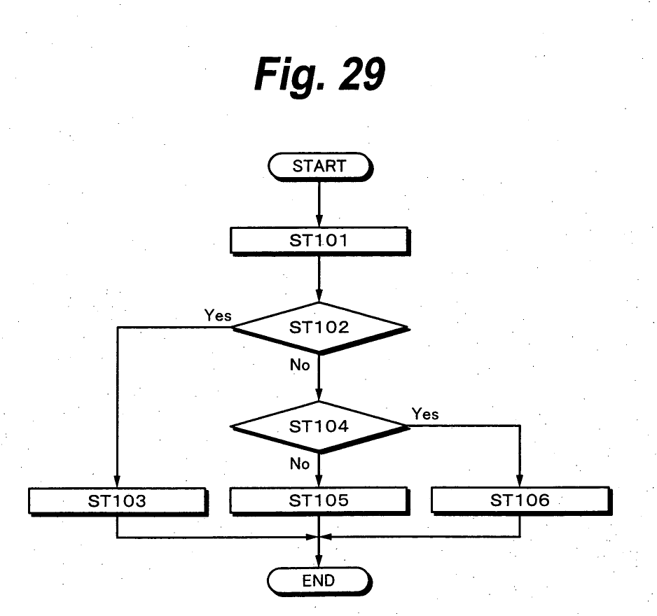

When the disc type data defined as described above are mixed with a random number to be transferred to the PC side, the following processes are performed on the drive side and the PC side. FIG. 29 is a flow chart showing a process performed on the drive side.

As described in the foregoing non-patent document 3, wobbled grooves are pre-formed on the disc. The wobbled grooves are modulated with information named ADIP (Address in Pre-groove). One piece of information contained in ADIP is a medium type (3 bytes). At the first step, step ST101, it is determined what the medium type of the disc is. At step ST102, it is determined whether the determined result is ROM. When the medium type is ROM, the flow advances to step ST103. At step ST103, it is determined that the disc type be ROM (0, 0). When the disc type is not ROM, the flow advances to step ST104. At step ST104, it is determined whether the disc application code is video writable.

Another piece of information contained in ADIP is a disc application code (1 byte). The disc application code is used to identify whether the disc is limited to a special application. For example, the disc application code identifies a disc to which a video signal can be written (a video writable disc).

When the disc application code at step ST104 is video writable, it is determined that the disc type be video writable (at step ST106). When the determined result at step ST104 denotes that the disc application code is not video writable, it is determined that the disc type be reserved (namely, undefined) (at step ST105).

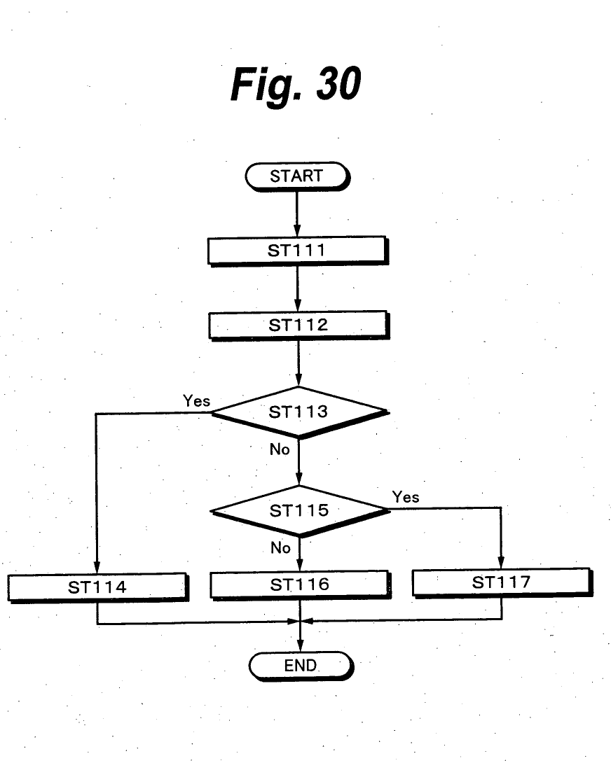

As described above, the disc type that the drive has determined is mixed with a random number exchanged upon mutual authentication and then transferred to the PC side. FIG. 30 is a flow chart showing a process performed on the PC side. At step ST111, the drive and the PC mutually authenticate each other. At step ST112, the PC obtains disc type data from the drive.

At step ST113, it is determined whether the disc type is ROM. When the determined result denotes that the disc type is ROM, the flow advances to step ST114. At step ST114, data are prohibited from being written to the disc. When the determined result denotes that the disc type is not ROM, the flow advances to step ST115. At step ST115 it is determined whether the disc type is video writable. When the determined result denotes that the disc type is not video writable, the flow advances to step ST116. At step ST116, it is determined that data be writable to the disc. When the determined result denotes that the disc type is video writable, the flow advances to step ST117. At step ST117, it is determined that data be writable to the disc according to CSS/CPRM.

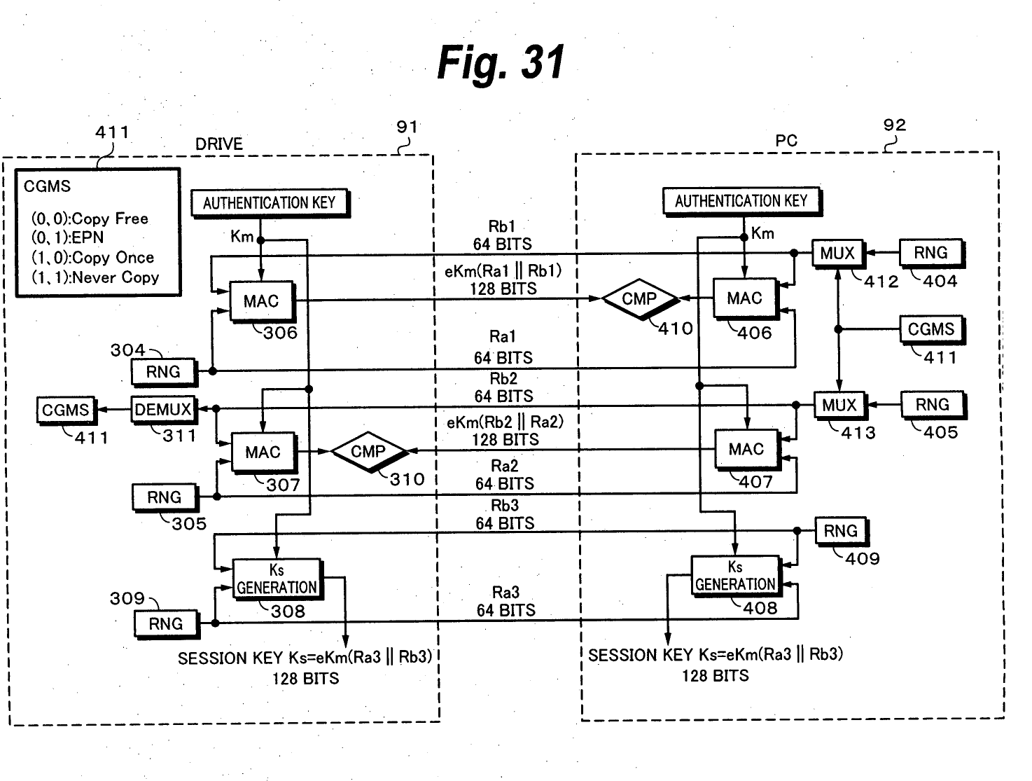

FIG. 31 shows another example of the authentication sections 91 and 92. In the foregoing example, the DVD drive and the PC mutually authenticate each other and information of the disc type is transferred from the DVD drive to the PC. In contrast, in this example, information of CGMS is transferred from the PC to the DVD.

The authentication section 92 of the PC 9 contains CGMS data 411 to be recorded. The CGMS data 411 are two-bit data corresponding to copyright management information contained in video data to be recorded. The CGMS data 411 are defined as follows.

(0, 0): copy free (0, 1): EPN (Encryption Plus Non-assertion) (content management information for digital broadcasts) (1, 0): one-time copy permitted (1, 1): copy prohibited

The CGMS data 411 are separated from a video input to be recorded. When CGMS data that have been separated from the video input are (1, 0), which denotes one-time copy permitted, after the video data are copied one time, the CGMS data recorded to the writable disc are changed to (1, 1), which denotes copy prohibited.

The CGMS data 411 are supplied to multiplexers 412 and 413 of the authentication section 92 on the PC side and mixed with random numbers supplied from random number generators 404 and 405, respectively. As a result, 64-bit random number data Rb1 and RB2 that contain CGMS data are generated. The CGMS data are located in predetermined two bits for example low-order two bits of for example 64-bit random numbers. The random numbers Rb1 and Rb2 are transferred to the DVD drive side. A demultiplexer 311 of the DVD drive can obtain the CGMS data 411 from the random number Rb2. The CGMS data 411 are recorded at a predetermined location on the writable disc.

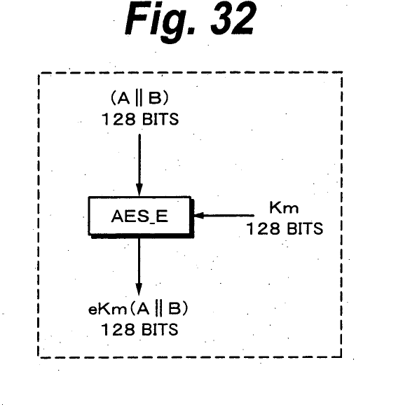

FIG. 32 shows an example of a structure of the MAC calculation blocks 306, 307, 308, 406, 407, and 408 that are AES (Advanced Encryption Standard) encryptors. A 128-bit random number A∥B, where two random numbers A and B are combined, and an authentication key Km are supplied to an AES encoder. An output eKm (A∥B) of which the random number A∥B has been encrypted with the authentication key Km is generated.

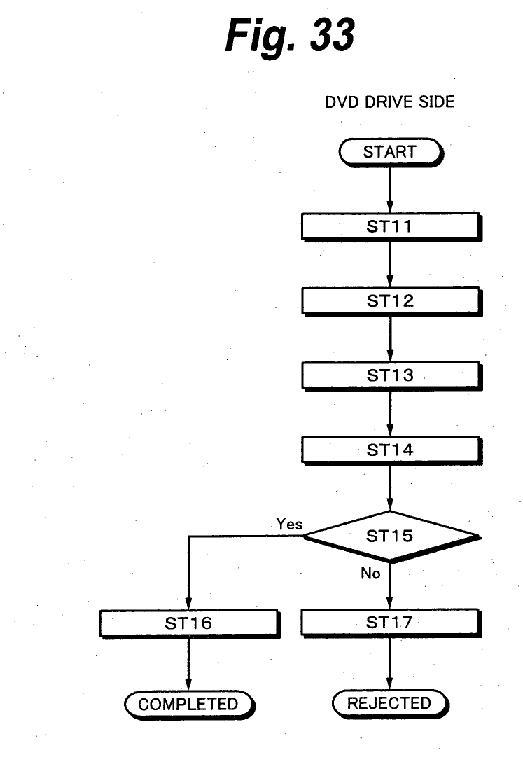

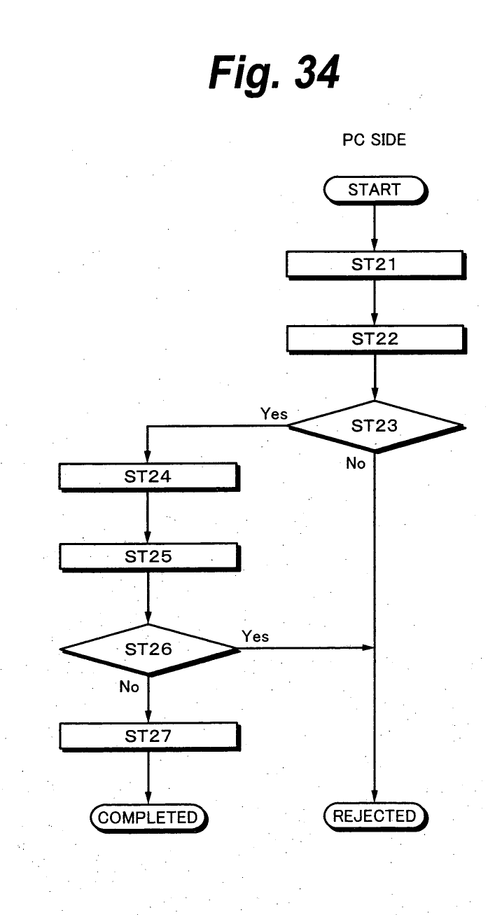

Next, with reference to flow charts shown in FIG. 33 and FIG. 34, a flow of a mutual authentication process in the structure shown in FIG. 28 will be described. FIG. 33 shows a flow of the process of the authentication section 91 on the DVD drive side. FIG. 34 shows a flow of the process of the authentication section 92 on the PC side. At the first step, step ST21 shown in FIG. 34, a command SEND KEY causes the random number Rb1 and the random number Rb2 generated in the random number generators 404 and 405 to be transferred to the authentication section 91. At step ST11 shown in FIG. 33, the authentication section 91 receives these random number transferred from the authentication section 92.

Thereafter, the authentication section 92 sends a command REPORT KEY to the authentication section 91 to cause it to transfer a MAC response value encrypted with the authentication key Km and the random number Ra1 (containing the disc type data) to the authentication section 92 (at step ST22). The response value is denoted by eKm (Ra1∥Rb1) where eKm ( ) denotes that data in parentheses are encrypted with the authentication key Km as an encrypted key. Ra1∥Rb1 denotes that two random numbers are connected so that random numbers Ra1 and Rb1 are placed on the left and right, respectively.

When the authentication section 91 has received the command REPORT KEY from the authentication section 92, the flow advances to step ST12. At step ST12, the authentication section 91 transfers the MAC value eKm (Ra1∥Rb1) generated by the MAC calculation block 306 and the random number Ra1 to the authentication section 92. At step ST23, the MAC calculation block 406 of the authentication section 92 calculates a MAC value. Thereafter, the comparison 410 determines whether the calculated MAC value matches the value received from the authentication section 91. When the received MAC value matches the calculated MAC value, the authentication section 92 (PC) has successfully authenticated the authentication section 91 (DVD drive). In contrast, when they do not match, the authentication section 92 (PC) has failed to authenticate the authentication section 91 (DVD drive). As a result, a reject process is performed.

When the authentication section 92 has successfully authenticated the authentication section 91, the flow advances to step ST24. At step ST24, the authentication section 92 sends a command REPORT KEY to the authentication section 91 to causes it to transfer the random number Ra2 (containing disc type data) and the random number Ra3 to the authentication section 92. At step ST113, the authentication section 91 transfers these random numbers to the authentication section 92 corresponding to this command.

At step ST25, the MAC calculation block 407 of the authentication section 92 calculates a MAC response value eKm (Rb2∥Ra2) encrypted with the authentication key Km with the random numbers received from the authentication section 91 and sends a command SEND key to the authentication section 91 to transfer the response value eKm (Rb2∥Ra2) and the random number Rb3 thereto.

At step ST14, the authentication section 91 receives the response value eKm (Rb2∥Ra2) and the random number Rb3 from the authentication section 92 and calculates the MAC value. At step ST15, the comparison 310 determines whether the calculated MAC value matches the MAC value received from the authentication section 92. When they match, the authentication section 91 (DVD drive) has successfully authenticated the authentication section 92 (PC). In this case, at step ST16, the MAC calculation block 308 generates a session key eKm (Ra3∥Rb3). In addition, the authentication section 91 transmits information denoting that it has successfully authenticated the authentication section 92 thereto. Thereafter, the authentication process is completed. The session key varies whenever the authentication operation is performed.

When the compared result at step ST15 denotes that the MAC values do not match, the authentication section 91 has failed to authenticate the authentication section 92. At step ST17, the authentication section 91 transmits error information denoting that the authentication section 91 has failed to authenticate the authentication section 92 thereto.

The authentication section 92 receives information denoting that the authentication section 91 has successfully authenticated the authentication section 92 or has failed to authenticate it as a response to the command SEND KEY. At step ST26, the authentication section 92 determines whether the authentication section 91 has completed the authentication operation corresponding to the received information. When the authentication section 92 has received information denoting that it has successfully authenticated the authentication section 91, the authentication section 92 determines that the authentication operation have been completed. When the authentication section 92 has received information denoting that it has failed to authenticate the authentication section 91, the authentication section 92 determines that the authentication have not been completed. When the authentication has been completed, the flow advances to step ST27. At step ST27, the MAC calculation block 408 generates a session key eKm (Ra3∥Rb) (for example, 64 bits) that is in common with the drive side. When the authentication operation has not been completed, the reject process is performed.

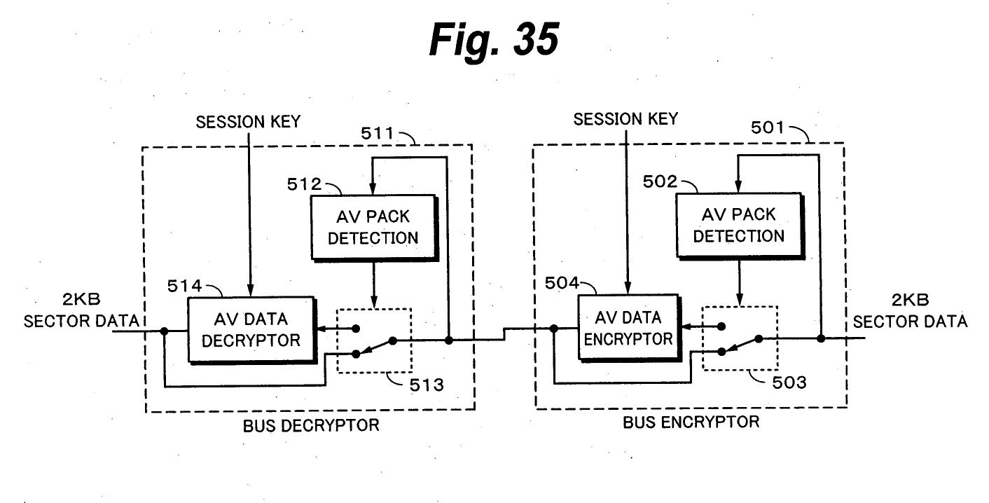

In all the foregoing embodiments of the present invention, the bus encryptor encrypts record data that are transferred from the PC to the DVD drive. On the DVD drive side, the bus decryptor decrypts encrypted data. In FIG. 35, reference numeral 501 denotes the bus encryptor, whereas reference numeral 511 denotes the bus encryptor.

Data are transferred as packs each of which is composed of sector data of 2 KB (kilobytes) from the to the DVD drive. Each pack has a pack header that identifies a pack type. An AV pack detection section 502 detects an audio pack, a video pack, and a sub picture pack and outputs a control signal corresponding to the detected result.

With the control signal supplied from the AV pack detection section 502, a selector 503 is controlled. When input data are an audio pack, a video pack, and a sub picture pack, the input data are supplied to an AV data encryptor 504. The AV data encryptor 504 encrypts the input data except for a pack header with a session key. When the input data are not these packs, they are not encrypted, but transferred to the DVD drive through an interface.

An AV pack detection section 512 of a bus decryptor 511 detects the type of the received pack with the pack header. A selector 513 is controlled with a control signal supplied from an AV pack detection section 512. When the pack is an audio pack, a video pack, and a sub picture pack, the received data are supplied to an AV data-decryptor 514. The AV data decryptor 514 decrypts the received data with the session key.

Since only audio/visual data are protected according to the CSS scheme, it is not necessary to encrypt other normal data such as file data of a computer. Thus, only AV packs are encrypted.

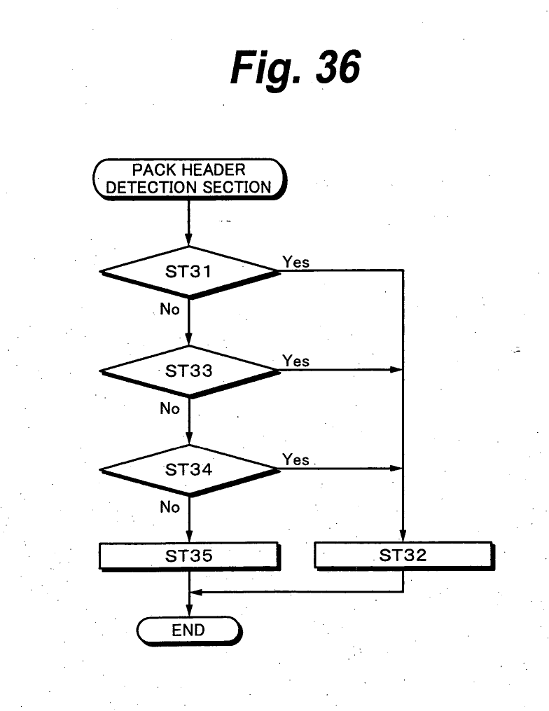

FIG. 36 shows a flow of the bus encryption/decryption processes. At step ST31, it is determined whether the detected result of the pack header detection section denotes a video pack. When the detected result denotes a video pack, the flow advances to step ST32. At step ST32, the data are encrypted/decrypted. When the detected result does not denote a video pack, the flow advances to step ST33. At step ST33, it is determined whether the detected result denotes an audio pack.

When the detected result at step ST33 denotes an audio pack, the flow advances to step ST32. At step ST32, the data are encrypted/decrypted. When the detected result does not denote an audio pack, the flow advances to step ST34. At step ST34, it is determined whether the data are a sub picture pack. When the detected result at step ST34 denotes that the data is a sub picture pack, the flow advances to step ST32. At step ST32, the data are encrypted/decrypted. Otherwise, data are not encrypted/decrypted (at step ST35). Thereafter, the bus encryption/decryption processes are completed.

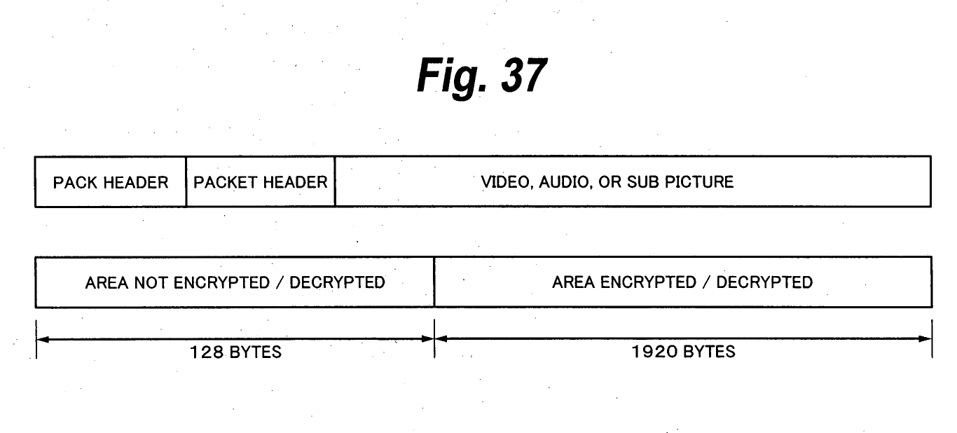

FIG. 37 shows a structure of an audio pack, a video pack, or a sub picture pack of DVD video data. Located at the beginning of a pack is a pack header that contains control information of the pack. The pack header is followed by a packet header. The packet header is followed by audio data (AC3 data), video data (MPEG program stream), or sub picture data (text data such as subtitle). Since the pack header and packet header are variable length, for example 128 bytes of a pack, that are larger than the maximum length of the pack header and packet header, are not bus-encrypted/bus-decrypted. The remaining 1920 bytes of the pack are bus-encrypted/bus-decrypted. A total of 2 K (2048) bytes are main data of one sector.

According to the fifth embodiment (FIG. 24), the sixth embodiment (FIG. 25), the seventh embodiment (FIG. 26), and the eighth embodiment (FIG. 27), the mask controls 101, 102, 103, and 104 are disposed, which are controlled depending on whether the DVD drive and the PC have mutually and successfully authenticated each other. Next, data that these mask controls mask will be described. First, a structure of data recorded on a writable disc will be described.

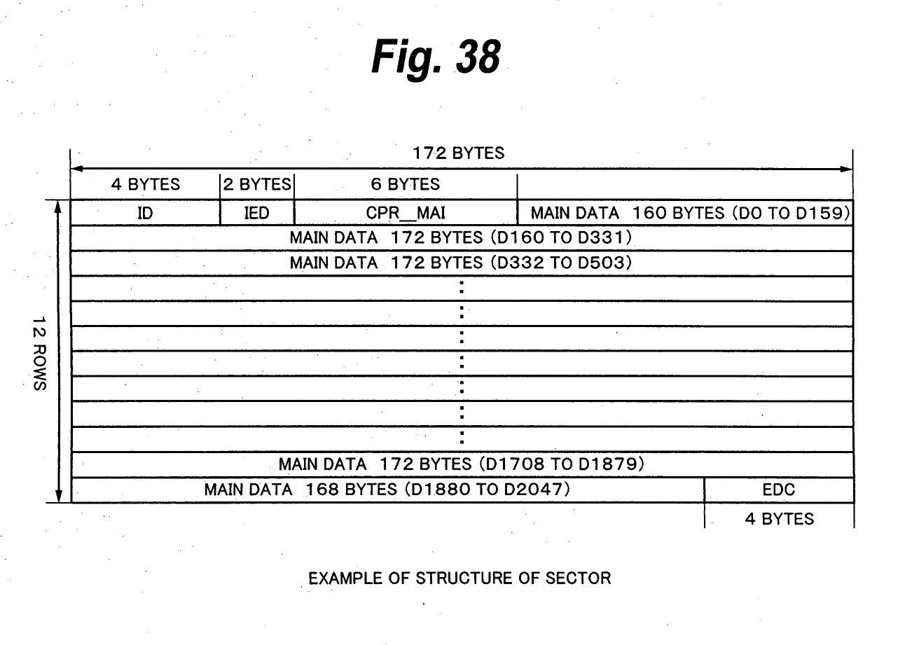

The DVD drive converts data received from the PC into data in a sector format and records the converted data to the writable disc. FIG. 38 shows a data structure of one sector. A sector header of 12 bytes is added to main data of 2 Kbytes. The last four bytes of the sector header is an error detection code EDC for the whole sector.

The first four bytes of the sector header are an ID such as a sector number. The next two bytes are an error detection code IED corresponding to the ID. The next six bytes are copy management data CPR_MAI (Copyright Management Information). CPR_MAI is data necessary when data to be copy-managed (copyright-managed) are recorded as main data. An encrypted title key necessary to decrypt main data is contained in CPR_MAI.

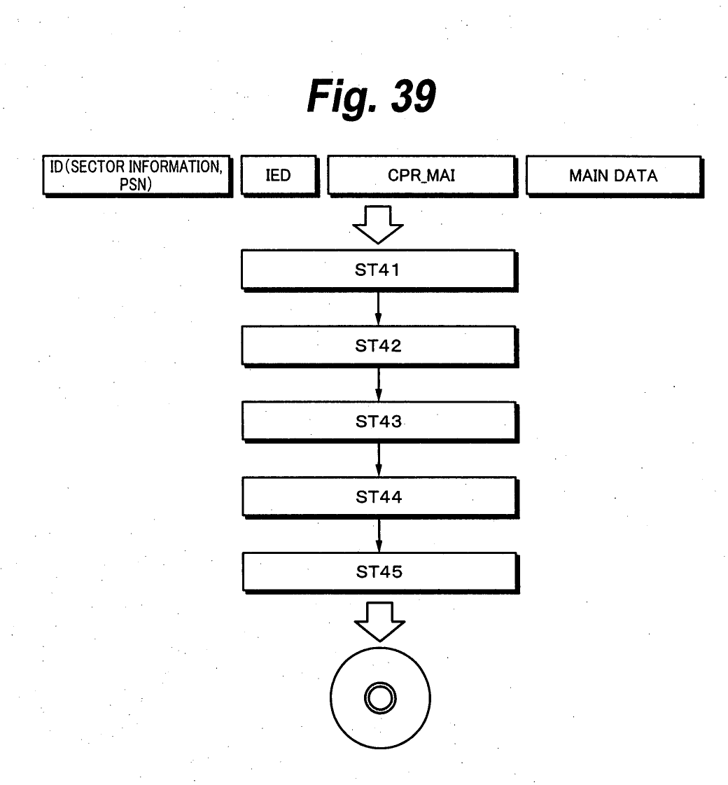

Next, with reference to FIG. 39, a process that is performed upon recording of sector structured data shown in FIG. 38 will be described. As shown in FIG. 39, an ID of the sector header is provided. The ID is generated by a CPU of the DVD drive. In other words, when data are recorded, a write command is transferred from the PC to the DVD drive. LBA (Logical Block Address) data that denotes a record location on the disc and data that denotes the write data length are added to the write command. When the CPU of the DVD drive has determined that the write command be executable, data are transferred on pack-by-pack (of 2 Kbytes) basis from the PC to the buffer memory of the drive for the length of the write data.

Before the write operation is started, PSN (Physical Sector Number) that is a physical address on the disc is calculated with the LBA data. The PSN is used as an ID. An error detection code IED is added to the ID. As a result, ID+IED (6 bytes) are formed.

In addition, CPR_MAI and main data are added to (ID+IED) data. With these data, an error detection code EDC for each sector is generated (at step ST41). As a result, one unit of data that is scrambled (for one frame) is formed. Main data of one unit are scrambled with a title key. As a result, a frame containing scrambled main data is formed (at step ST42).

Data of 16 scrambled frames are encoded with an error correction code (at step ST43). Main data of 16 frames that have been encoded with the error correction code are interleaved (at step ST44). 26 sync frames are modulated for each sector (at step ST45). Data that have been modulated are recorded to the writable disc.

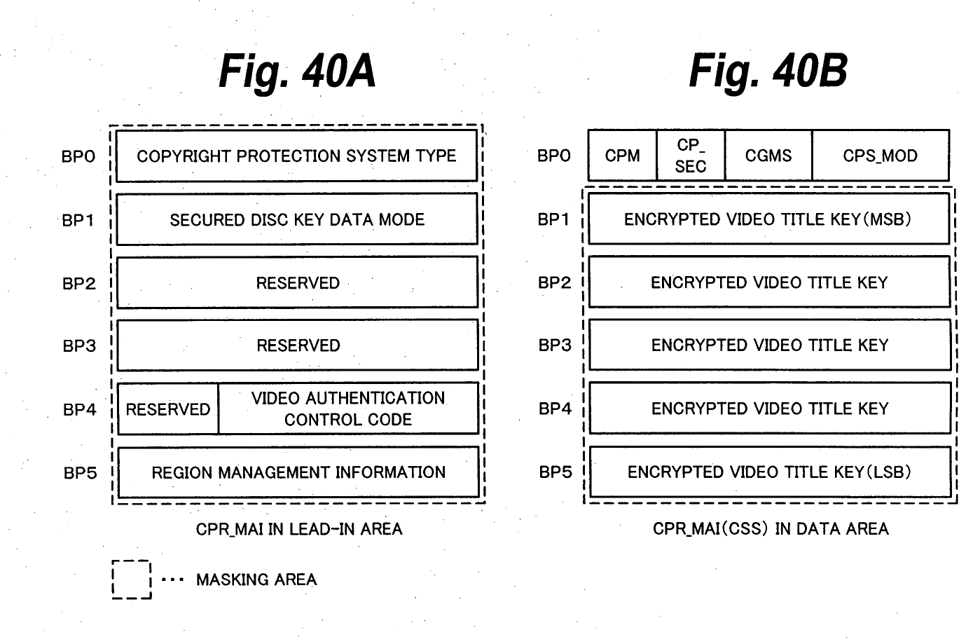

FIG. 40 shows a more detailed data structure of six-byte CPR_MAI. FIG. 40A shows a data structure of CPR_MAI in the lead-in area (PSN<030000h). FIG. 40B shows a data structure of CPR_MAI in the data area (PSN≧030000h). CPR_MAI in the lead-in area shown in FIG. 40A is a kind of attribute information and contains information that denotes that the written data are a secured disc key. The first one byte BP0 denotes a copyright protection system type, for example CSS, CPRM, or not.

The next byte BP1 denotes, a secured disc key mode. The next bytes BP2 and BP3 are undefined. High order two bits of the next byte BP4 are undefined. Low order six bits of the byte BP4 are a video authentication control code. The next byte BP5 denotes region management information.

As denoted with dotted lines shown in FIG. 40A, the whole data of CPR_MAI in the lead-in area are masked. In other words, when the whole data of CPR_MAI are masked unless the DVD drive has been successfully authenticated, the whole data of CPR_MAI of the lead-in area are replaced with for example 00h data. The video authentication control code may not be masked. In a mask control CPR_MAI filter that will be described later, since information that denotes a predetermined encryption system (for example, CSS scheme) is the first byte BP0, when it is replaced with other than the information that denotes the encryption system, for example 00h, the whole data of CPR_MAI are substantially masked.

Next, CPR_MAI in the data area showing in FIG. 40B will be described. The first byte BP0 is composed of CPM (1 bit), CP_SEC (1 bit), CGMS (2 bits), and CPS_MOD (4 bits). The remaining five bytes BP1 to BP5 are an encrypted video title key arranged in the order of BP1 to BP5.

As denoted with dotted lines shown in FIG. 40B, bytes BP1 to BP5 (encrypted video title key) other than the first byte BP0 of CPR_MAI in the data area are masked. In other words, when the data of CPR_MAI in the data area are masked unless the DVD drive has been successfully authenticated, bytes BP1 to BP5 of CPR_MAI of the lead-in area are replaced with for example 00h data.

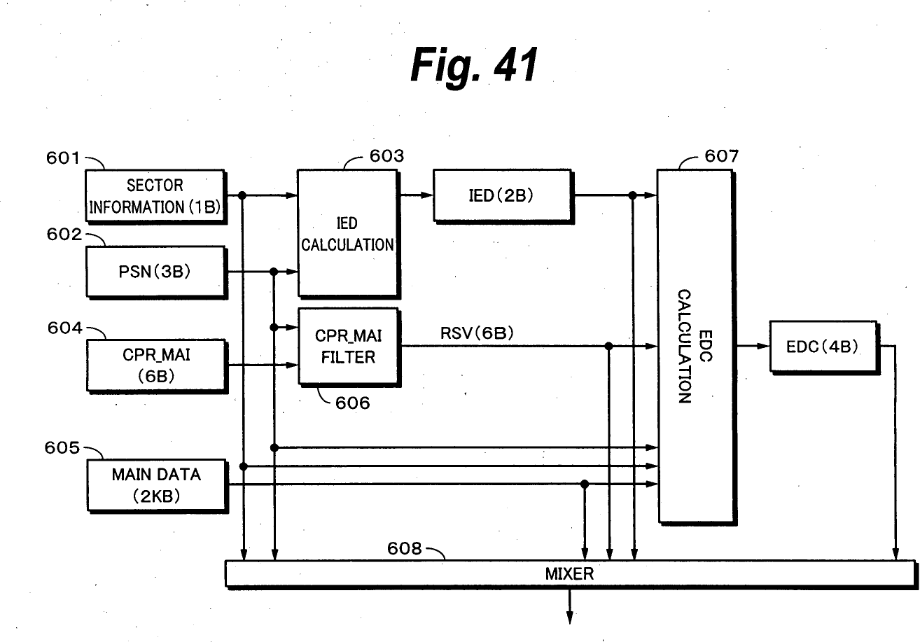

FIG. 41 shows an example of a structure of a mask control for CPR_MAI in the lead-in area and data area. In this example, in the record process shown in FIG. 39, before EDC is added at step ST41, the mask control is performed. In FIG. 41, reference numeral 601 denotes a register that stores sector information (1 byte). Reference numeral 602 denotes a register that stores PSN (3 bytes). These four bytes as an ID are input to a calculation section 603. The calculation section 603 calculates the ID and obtains an error-detection code IED of two bytes.

Reference numeral 604 denotes a register that stores CPR_MAI (6 bytes). Reference numeral 605 denotes a buffer memory that stores main data of one sector (2 Kbytes). CPR_MAI is input to a CPR_MAI filter 606. The CPR_MAI filter 606 performs a mask control for CPR_MAI. The filter 606 outputs CPR_MAI that has been mask-controlled, namely RSV (6 bytes).

The error detection code IED (2 bytes), RSV (6 bytes), sector information (1 byte), PSN (3 bytes), and main data (2048 bytes) are input to a calculation section 607. The calculation section 607 generates an error detection code EDC for the whole sector. The sector information, PSN, error detection code IED, RSV, main data, and DEC are inputted to a mixer denoted by reference numeral 608. As a result, data of one sector shown in FIG. 38 are formed.

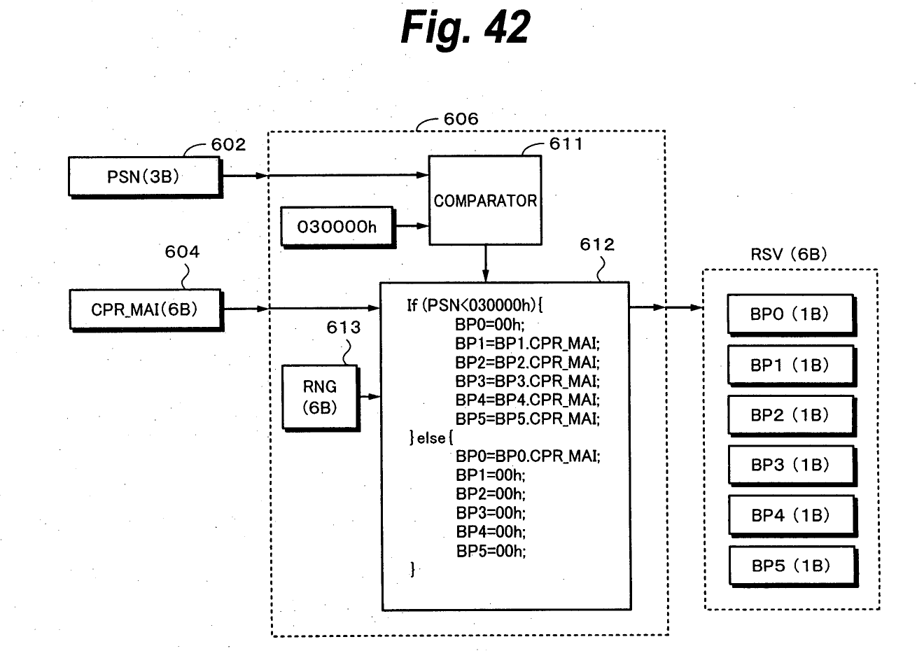

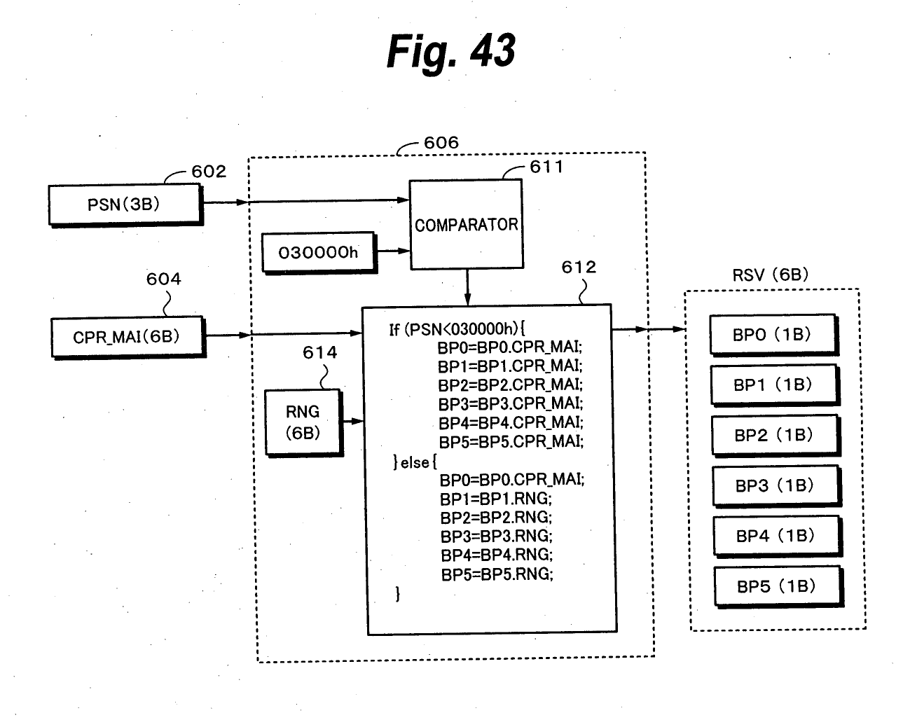

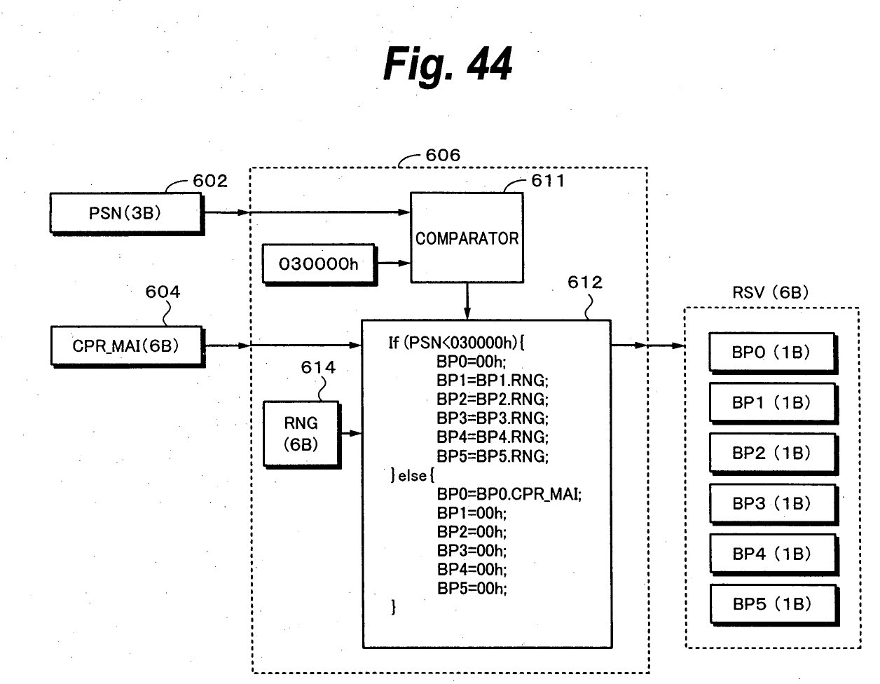

FIG. 42 describes the CPR_MAI filter 606 for the lead-in area and data area in detail. FIG. 42 shows a structure that masks data to prohibits a CSS key from being written before the PC and the DVD drive have mutually and successfully authenticated each other. In FIG. 42, FIG. 43, and FIG. 44 (FIG. 43 and FIG. 44 will be described later), the CPR_MAI filter 606 denoted with dotted lines is composed of logic gates. PSN (3 bytes) that is an address of a disc is inputted to a comparator 611. The comparator 611 compares PSN with a predetermined address, for example 030000h. CPR_MAI and a random number that is generated by a random number generator 613 are supplied to a data converter 612. The data converter 612 is controlled by the comparator 611.

The data converter 612 performs a process for each area corresponding to an output of the comparator 611, the output denoting the lead-in area and the data area. When the output of the comparator 611 denotes (PSN<030000h), CPR_MAI (see FIG. 40A) recorded in the lead-in area is masked. To mask CPR_MAI, the data converter 612 replaces data of BP0 with 00h. When the output of the comparator 611 denotes other than (PSN<030000h), CPR_MAI (see FIG. 40B) recorded in the data area is masked. In other words, five bytes other than BP0 are replaced with 00h.

FIG. 43 shows a process of the CPR_MAI filter 606 when data can be written according to the CSS scheme after the PC and the DVD drive have mutually and successfully authenticated each other, namely CSS key writing prohibition is disabled.

For the lead-in area where the output of the comparator 6.11 is (PSN<030000h), CPR_MAI (see FIG. 40A) is output. When the output of the comparator 611 is not (PSN<030000h), CPR_MAI (see FIG. 40B); is output. To generate a title key, a random number generator 613 having a length of six bytes is used.

Five bytes of six bytes generated by the random number generator 613 are used as five bytes (BP1, BP2, BP3, BP4, and BP5) of CPR_MAI.

FIG. 44 shows an example of an application of the mask control. In this example, when the PC and the DVD drive has mutually and successfully authenticated, BP1 to BP5 of the lead-in area are permitted to be filled with random numbers. This example can be applied to the mask control for the disc key.

When the output of the comparator 611 denotes the lead-in area, BP0 is 00h and BP1 to BP5 are random number data generated as an output of a random number generator 614. Since the six bytes of BP0 to BP5 are recorded in the lead-in area of the disc, a unique ID is recorded to the disc. For the data area, unlike the case that the title key is recorded, five bytes of BP1 to BP5 other than BP0 are all 00h.

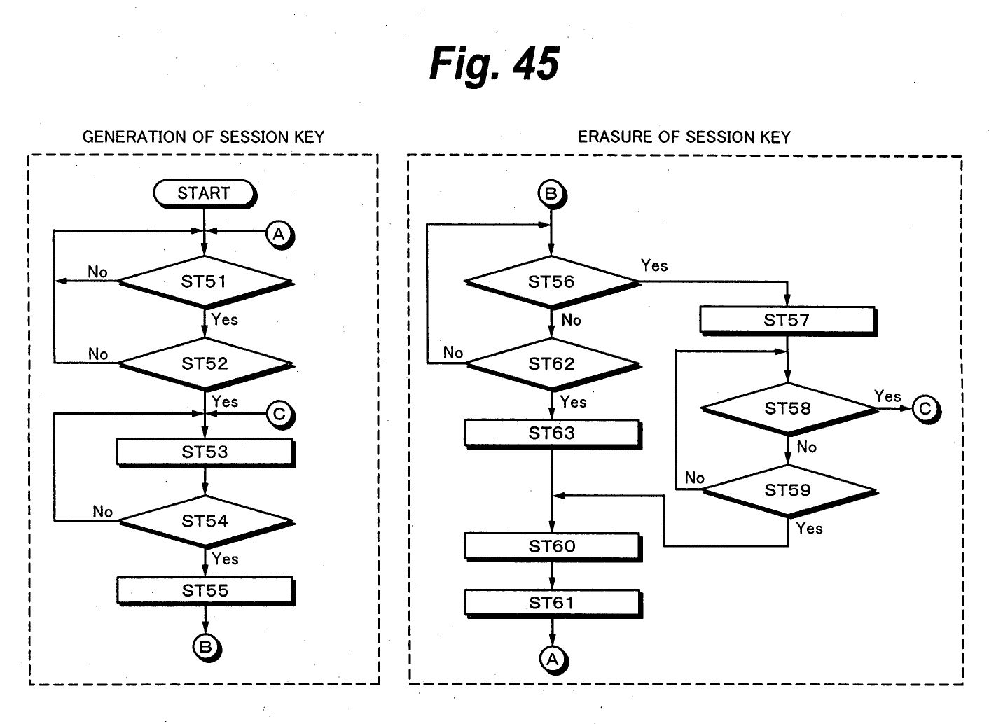

FIG. 45 is a flow chart showing session key generation/erasure processes and a CSS key (encrypted title key, secured disc key, or encrypted title key) mask control process. At the first step, step ST51, it is determined whether a CSS scramble writable disc according to the present invention for example DVD+RW/+R has been inserted into the DVD drive. When the determined result denotes that the disc has been inserted into the drive, the flow advances to step ST52. At step ST52, it is determined whether the PC application has been started, namely the power of the PC has been turned on or re-started, the OS has been started, and the PC can execute the application program. The default state of the CSS key write mask function is write prohibition state. The order of steps ST51 and ST52 may be reversed.

When the determined result at step S52 denotes that the PC application has been started, the flow advances to step ST53. At step ST53, the PC and the DVD drive mutually authenticate each other and a session key is generated. At step ST54, it is determined whether the session key has been generated. When the determined result denotes that the session key has been generated, the CSS key write mask function is disabled (at step ST55).

At step ST56, it is determined whether the PC application has been completed. When the determined result denotes that the PC application has been completed, the flow advances to step ST57. At step ST57, the session key generated in the PC is erased (at step ST57). Thereafter, it is determined whether the PC application has been started again (at step ST58). When the determined result denotes that the PC application has been started again, the flow returns to step ST53.

When the determined result at step ST58 denotes that the application has not been started, the flow advances to step ST59. At step ST59, it is determined whether the DVD+RW/+R disc has been ejected. When the determined result denotes that the disc has not been ejected, the flow returns to step ST58. When the determined result at step ST59 denotes that the disc has been ejected, the flow advances to step ST60. At step ST60, the session key generated in the drive is erased. Thereafter, the mask control prohibits the CSS key from being written (at step ST61).

When the determined result at step ST56 denotes that the application has not been started, the flow advances to step ST62. At step ST62, it is determined whether the DVD+RW/+R disc has been ejected. When the determined result denotes that the disc has not been ejected, the flow returns to step ST56. When the determined result at step ST62 denotes that the disc has been ejected, the flow advances to step ST63. At step ST63, the session key generated in the drive is erased. Thereafter, the mask control prohibits the CSS key from being written (at step ST61).

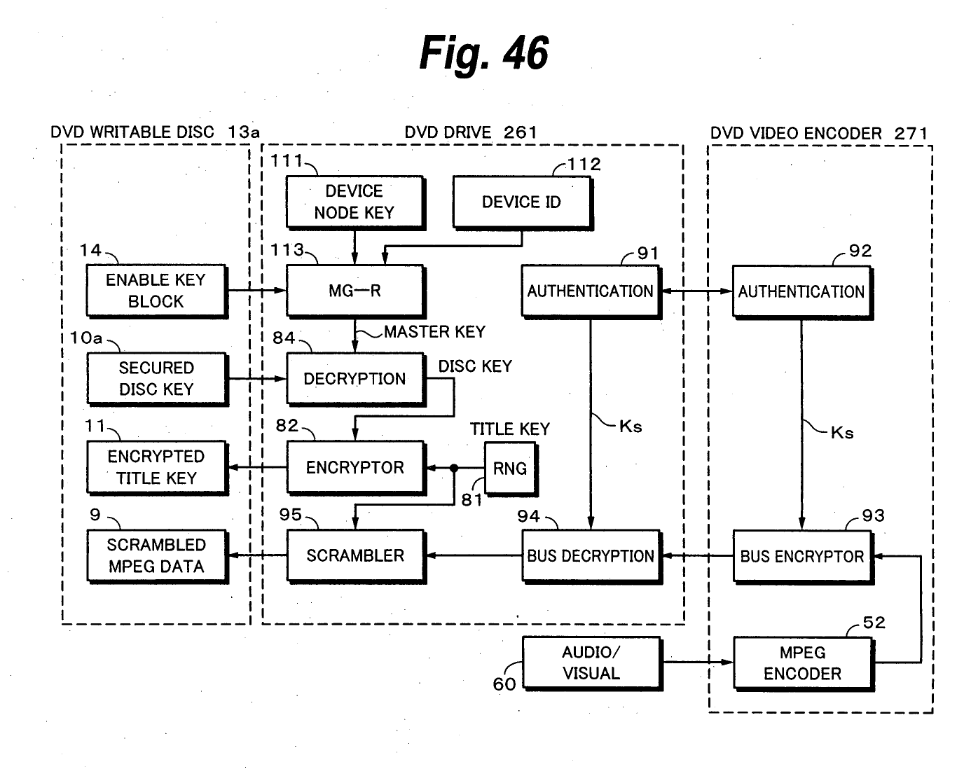

The mask key may be formed in a tree structure as described in Japanese Patent Unexamined Publication No. 2002-236622. FIG. 46 shows a structure in the case that such a method is applied to an embodiment shown in FIG. 26. A drive 261 has a device node key 111 that is in common with a plurality of drives and a device ID 112 that is unique to the drive. A writable disc 13a has a table composed of block data called an EKB (Enable Key Block) 14. The KEB contains a plurality of encrypted keys.

EKB is read from the writable disc to a decryption section 113. The decryption section 113 decrypt the master key with the device node key 111 and the device ID 112. This method can be used to distribute a new master key or update the existing master key.

The present invention is not limited to the foregoing embodiments. Various modifications and applications may be made without departing from the spirit of the present invention. As long as three encrypted keys that are a master key, a disc key, and a title key are used, another encryption method other than the CSS scheme may be used. In addition, the present invention may be applied to the case that information is recorded to a medium such as an optical card or a memory card other than a disc.

1. A signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium,
wherein the record and reproduction apparatus comprises:
storage means for storing the first encrypted key,
second encrypted key decryption means for reproducing the second encrypted key encrypted and recorded on the record medium and for decrypting the second encrypted key with the first encrypted key,
third encrypted key generation means for generating the third encrypted key,
encryption means for encrypting the third encrypted key with the decrypted second encrypted key,
authentication means for authenticating the information process apparatus and generating a session key when the authentication means has successfully authenticated the information process apparatus,
first bus-encryption means for bus-encrypting the second encrypted key that has been encrypted and recorded on the record medium with the session key and transferring the bus-encrypted second encrypted key to the information process apparatus,
second bus-encryption means for bus-encrypting the third encrypted key with the session key and transferring the bus-encrypted third encrypted key to the information process apparatus,
bus-decryption means for bus-decrypting encrypted and bus-encrypted content information supplied from the information process apparatus, and
record means for recording the third encrypted key and the encrypted content information to the record medium, and
wherein the information process apparatus comprises:
storage means for storing the first encrypted key,
authentication means for authenticating the record and reproduction apparatus and generating the session key when the authentication means has successfully authenticated the record and reproduction apparatus,
first bus-decryption means for bus-decrypting the bus-encrypted second encrypted key with the session key,
decryption means for decrypting the second encrypted key with the first encrypted key,
second bus-decryption means for bus-decrypting the bus-encrypted third encrypted key with the session key,
decryption means for decrypting the third encrypted key with the second encrypted key,
encryption means for encrypting the content information transferred to the record and reproduction apparatus with the third encryption, and
bus-encryption means for bus-encrypting the encrypted content information with the session key and sending the bus-encrypted content information to the record and reproduction apparatus.

2. The signal process system as set forth in claim 1,
wherein the authentication means of the record and reproduction apparatus and the authentication means of the information process apparatus mix a random number transferred from the record and reproduction apparatus to the information process apparatus with information about a type of the record medium when the authentication means of the record and reproduction apparatus and the authentication means of the information process apparatus exchange the generated random number data therebetween.

3. The signal process system as set forth in claim 1,
wherein the authentication means of the record and reproduction apparatus and the authentication means of the information process apparatus mix a random number transferred from the record and reproduction apparatus to the information process apparatus with information about copyright when the authentication means of the record and reproduction apparatus and the authentication means of the information process apparatus exchange the generated random number data therebetween.

4. The signal process system as set forth in claim 1, further comprising:
mask control means for the third encrypted key,
wherein only when the authentication means of the record and reproduction apparatus and the authentication means of the information process apparatus have mutually and successfully authenticated each other, the third encrypted key can be written to the record medium.

5. A signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium, wherein the record and reproduction apparatus comprises:
storage means for storing the first encrypted key,
second encrypted key generation means for generating the second encrypted key,
encryption means for encrypting the generated second encrypted key with the first encrypted key,
third encrypted key generation means for generating the third encrypted key,
encryption means for encrypting the third encrypted key with the generated second encrypted key,
authentication means for authenticating the information process apparatus and generating a session key when the authentication means has successfully authenticated the information process apparatus,
first bus-encryption means for bus-encrypting the second encrypted key with the session key and transferring the bus-encrypted second encrypted key to the information process apparatus,
second bus-encryption means for bus-encrypting the third encrypted key with the session key and transferring the bus-encrypted third encrypted key to the information process apparatus,
bus-decryption means for bus-decrypting the encrypted and bus-encrypted content information supplied from the information process apparatus, and
record means for recording the second encrypted key, the third encrypted key, and the encrypted content information to the record medium, and
wherein the information process apparatus comprises:
storage means for storing the first encrypted key,
authentication means for authenticating the record and reproduction apparatus and generating the session key when the authentication means has successfully authenticated the record and reproduction apparatus,
first bus-decryption means for bus-decrypting the bus-encrypted second encrypted key with the session key,
decryption means for decrypting the second encrypted key with the first encrypted key,
second bus-decryption means for bus-decrypting the bus-encrypted third encrypted key with the session key,
decryption means for decrypting the third encrypted key with the second encrypted key,
encryption means for encrypting the content information transferred to the record and reproduction apparatus with the third encryption, and
bus-encryption means for bus-encrypting the encrypted content information with the session key and sending the bus-encrypted content information to the record and reproduction apparatus.

6. The signal process system as set forth in claim 5,
wherein the authentication means of the record and reproduction apparatus and the authentication means of the information process apparatus mix a random number transferred from the record and reproduction apparatus to the information process apparatus with information about a type of the record medium when the authentication means of the record and reproduction apparatus and the authentication means of the information process apparatus exchange the generated random number data therebetween.

7. The signal process system as set forth in claim 5,
wherein the authentication means of the record and reproduction apparatus and the authentication means of the information process apparatus mix a random number transferred from the record and reproduction apparatus to the information process apparatus with information about copyright when the authentication means of the record and reproduction apparatus and the authentication means of the information process apparatus exchange the generated random number data therebetween.

8. The signal process system as set forth in claim 5, further comprising:
first mask control means for the third encrypted key, and
second mask control means for the second encrypted key,
wherein only when the authentication means of the record and reproduction apparatus and the authentication means of the information process apparatus have mutually and successfully authenticated each other, the third encrypted key and the second encrypted key can be written to the record medium.

9. A signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium,
wherein the record and reproduction apparatus comprises:
storage means for storing the first encrypted key,
second encrypted key decryption means for reproducing the second encrypted key encrypted and recorded on the record medium and for decrypting the second encrypted key with the first encrypted key,
third encrypted key generation means for generating the third encrypted key,
encryption means for encrypting the third encrypted key with the decrypted second encrypted key,
authentication means for authenticating the information process apparatus and generating a session key when the authentication means has successfully authenticated the information process apparatus,
bus-decryption means for bus-decrypting the bus-encrypted content information supplied from the information process apparatus,
encryption means for encrypting the content information with the third encrypted key, and
record means for recording the third encrypted key and the encrypted content information to the record medium, and
wherein the information process apparatus comprises:
authentication means for authenticating the record and reproduction apparatus and generating the session key when the information process apparatus has successfully authenticated the record and reproduction apparatus, and
bus-encryption means for bus-encrypting content information transferred to the record and reproduction apparatus with the session key and sending the bus-encrypted content information to the record and reproduction apparatus.

10. The signal process system as set forth in claim 9,
wherein the authentication means of the record and reproduction apparatus and the authentication means of the information process apparatus mix a random number transferred from the record and reproduction apparatus to the information process apparatus with information about a type of the record medium when the authentication means of the record and reproduction apparatus and the authentication means of the information process apparatus exchange the generated random number data therebetween.

11. The signal process system as set forth in claim 9,
wherein the authentication means of the record and reproduction apparatus and the authentication means of the information process apparatus mix a random number transferred from the record and reproduction apparatus to the information process apparatus with information about copyright when the authentication means of the record and reproduction apparatus and the authentication means of the information process apparatus exchange the generated random number data therebetween.

12. The signal process system as set forth in claim 9, further comprising:
mask control means for the third encrypted key,
wherein only when the authentication means of the record and reproduction apparatus and the authentication means of the information process apparatus have mutually and successfully authenticated each other, the third encrypted key can be written to the record medium.

13. A signal process system having a record and reproduction apparatus that reads information from a record medium and records information thereto, and an information process apparatus to which the record and reproduction apparatus is connected through transfer means, content information being encrypted according to a content information encryption method using a first encrypted key managed by a management mechanism, a second encrypted key unique to the record medium, and a third encrypted key generated whenever information is recorded, the content information being recorded to the record medium,
wherein the record and reproduction apparatus comprises:
storage means for storing the first encrypted key,
second encrypted key generation means for generating the second encrypted key,
encryption means for encrypting the generated second encrypted key with the first encrypted key,
third encrypted key generation means for generating the third encrypted key,
encryption means for encrypting the third encrypted key with the generated second encrypted key,
authentication means for authenticating the information process apparatus and generating a session key when the authentication means has successfully authenticated the information process apparatus,
bus-decryption means for bus-decrypting the bus-encrypted content information supplied from the information process apparatus,
encryption means for encrypting the content information with the third encrypted key, and
record means for recording the second encrypted key, the third encrypted key, and the encrypted content information to the record medium, and
wherein the information process apparatus comprises:
authentication means for authenticating the record and reproduction apparatus and generating the session key when the information process apparatus has successfully authenticated the record and reproduction apparatus, and
bus-encryption means for bus-encrypting content information with the session key and sending the bus-encrypted content information to the record and reproduction apparatus.

14. The signal process system as set forth in claim 13,
wherein the authentication means of the record and reproduction apparatus and the authentication means of the information process apparatus mix a random number transferred from the record and reproduction apparatus to the information process apparatus with information about a type of the record medium when the authentication means of the record and reproduction apparatus and the authentication means of the information process apparatus exchange the generated random number data therebetween.

15. The signal process system as set forth in claim 13,
wherein the authentication means of the record and reproduction apparatus and the authentication means of the information process apparatus mix a random number transferred from the record and reproduction apparatus to the information process apparatus with information about copyright when the authentication means of the record and reproduction apparatus and the authentication means of the information process apparatus exchange the generated random number data therebetween.

16. The signal process system as set forth in claim 13, further comprising:
first mask control means for the third encrypted key, and
second mask control means for the second encrypted key,
wherein only when the authentication means of the record and reproduction apparatus and the authentication means of the information process apparatus have mutually and successfully authenticated each other, the third encrypted key and the second encrypted key can be written to the record medium.

17. A record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:
storage means for storing the first encrypted key,
second encrypted key decryption means for reproducing the second encrypted key encrypted and recorded on the record medium and for decrypting the second encrypted key with the first encrypted key,
third encrypted key generation means for generating the third encrypted key,
encryption means for encrypting the third encrypted key with the decrypted second encrypted key,
authentication means for authenticating the information process apparatus and generating a session key when the authentication means has successfully authenticated the information process apparatus,
first bus-encryption means for bus-encrypting the second encrypted key that has been encrypted and recorded on the record medium with the session key and transferring the bus-encrypted second encrypted key to the information process apparatus,
second bus-encryption means for bus-encrypting the third encrypted key with the session key and transferring the bus-encrypted third encrypted key to the information process apparatus,
bus-decryption means for bus-decrypting encrypted and bus-encrypted content information supplied from the information process apparatus,
record means for recording the third encrypted key and the encrypted content information to the record medium,
wherein the encrypted and bus-encrypted content information is encrypted with the third encrypted key and the encrypted content information is bus-encrypted with the session key generated by the information process apparatus.

18. The record and reproduction apparatus as set forth in claim 17,
wherein the authentication means mixes a random number transferred to the information process apparatus with information about a type of the record medium when the authentication means exchanges random number data with the information process apparatus.

19. The record and reproduction apparatus as set forth in claim 17, further comprising:
mask control means for the third encrypted key,
wherein only when the authentication means has successfully authenticated the information process apparatus, the third encrypted key can be written to the record medium.

20. A record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:
storage means for storing the first encrypted key,
second encrypted key generation means for generating the second encrypted key,
encryption means for encrypting the generated second encrypted key with the first encrypted key,
third encrypted key generation means for generating the third encrypted key,
encryption means for encrypting the third encrypted key with the generated second encrypted key,
authentication means for authenticating the information process apparatus and generating a session key when the authentication means has successfully authenticated the information process apparatus,
first bus-encryption means for bus-encrypting the second encrypted key with the session key and transferring the bus-encrypted second encrypted key to the information process apparatus,
second bus-encryption means for bus-encrypting the third encrypted key with the session key and transferring the bus-encrypted third encrypted key to the information process apparatus,
bus-decryption means for bus-decrypting the encrypted and bus-encrypted content information supplied from the information process apparatus, and
record means for recording the second encrypted key, the third encrypted key, and the encrypted content information to the record medium,
wherein the encrypted and bus-encrypted content information is encrypted with the third encrypted key and the encrypted content information is bus-encrypted with the session key generated by the information process apparatus.

21. The record and reproduction apparatus as set forth in claim 20,
wherein the authentication means mixes a random number transferred to the information process apparatus with information about a type of the record medium when the authentication means exchanges random number data with the information process apparatus.

22. The record and reproduction apparatus as set forth in claim 20, further comprising:
first mask control means for the third encrypted key, and
second mask control means for the second encrypted key,
wherein only when the authentication means has successfully authenticated the information process apparatus, the third encrypted key and the second encrypted key can be written to the record medium.

23. A record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:
storage means for storing the first encrypted key,
second encrypted key decryption means for reproducing the second encrypted key encrypted and recorded to the record medium and for decrypting the second encrypted key with the first encrypted key,
third encrypted key generation means for generating the third encrypted key,
encryption means for encrypting the third encrypted key with the decrypted second encrypted key,
authentication means for authenticating the information process apparatus and generating a session key when the authentication means has successfully authenticated the information process apparatus,
bus-decryption means for bus-decrypting the bus-encrypted content information supplied from the information process apparatus,
encryption means for encrypting the content information with the third encrypted key, and
record means for recording the third encrypted key and the encrypted content information to the record medium,
wherein the bus-encrypted content information is the encrypted content information that has been bus-encrypted with the session key generated by the information process apparatus.

24. The record and reproduction apparatus as set forth in claim 23,
wherein the authentication means mixes a random number transferred to the information process apparatus with information about a type of the record medium when the authentication means exchanges random number data with the information process apparatus.

25. The record and reproduction apparatus as set forth in claim 23, further comprising:
mask control means for the third encrypted key,
wherein only when the authentication means has successfully authenticated the information process apparatus, the third encrypted key can be written to the record medium.

26. A record and reproduction apparatus that is connected to an information process apparatus through transfer means and that reads information from a record medium and records information thereto, content information being encrypted according to a content information encryption method using a first encrypted key managed by a management mechanism, a second encrypted key unique to the record medium, and a third encrypted key generated whenever information is recorded, the content information being recorded to the record medium, the record and reproduction apparatus comprising:
storage means for storing the first encrypted key,
second encrypted key generation means for generating the second encrypted key,
encryption means for encrypting the generated second encrypted key with the first encrypted key,
third encrypted key generation means for generating the third encrypted key,
encryption means for encrypting the third encrypted key with the generated second encrypted key,
authentication means for authenticating the information process apparatus and generating a session key when the authentication means has successfully authenticated the information process apparatus,
bus-decryption means for bus-decrypting the bus-encrypted content information supplied from the information process apparatus,
encryption means for encrypting the content information with the third encrypted key, and
record means for recording the second encrypted key, the third encrypted key, and the encrypted content information to the record medium,
wherein the bus-encrypted content information is the encrypted content information that has been bus-encrypted with the session key generated by the information process apparatus.

27. The record and reproduction apparatus as set forth in claim 26,
wherein the authentication means mixes a random number transferred to the information process apparatus with information about a type of the record medium when the authentication means exchanges random number data with the information process apparatus.

28. The record and reproduction apparatus as set forth in claim 26, further comprising:
first mask control means for the third encrypted key, and
second mask control means for the second encrypted key,
wherein only when the authentication means has successfully authenticated the information process apparatus, the third encrypted key and the second encrypted key can be written to the record medium.

29. A record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to reproduce the second encrypted key encrypted and recorded on the record medium and decrypt the second encrypted key with the first encrypted key,
causing the record and reproduction apparatus to generate the third encrypted key,
causing the record and reproduction apparatus to encrypt the third encrypted key with the decrypted second encrypted key,
causing the record and reproduction apparatus to authenticate the information process apparatus and generate a session key when the record and reproduction apparatus has successfully authenticated the information process apparatus,
causing the record and reproduction apparatus to bus-encrypt the second encrypted key that has been encrypted and recorded on the record medium with the session key and transfer the bus-encrypted second encrypted key to the information process apparatus,
causing the record and reproduction apparatus to bus-encrypt the third encrypted key with the session key and transfer the bus-encrypted third encrypted key to the information process apparatus,
causing the record and reproduction apparatus to bus-decrypt the encrypted and bus-encrypted content information supplied from the information process apparatus,
causing the record and reproduction apparatus to record the third encrypted key and the encrypted content information to the record medium,
causing the information process apparatus to store the first encrypted key,
causing the information process apparatus to authenticate the record and reproduction apparatus and generate the session key when the information process apparatus has successfully authenticated the record and reproduction apparatus,
causing the information process apparatus to bus-decrypt the bus-encrypted second encrypted key with the session key,
causing the information process apparatus to decrypt the second encrypted key with the first encrypted key,
causing the information process apparatus to bus-decrypt the bus-encrypted third encrypted key with the session key,
causing the information process apparatus to decrypt the third encrypted key with the second encrypted key,
causing the information process apparatus to encrypt the content information transferred to the record and reproduction apparatus with the third encryption, and
causing the information process apparatus to bus-encrypt the encrypted content information with the session key and send the bus-encrypted content information to the record and reproduction apparatus.

30. The record method as set forth in claim 29,
wherein at the authentication step of the record and reproduction apparatus and the authentication step of the information process apparatus, a random number transferred from the record and reproduction apparatus to the information process apparatus is mixed with information about a type of the record medium when the generated random number data are exchanged therebetween.

31. The record method as set forth in claim 29,
wherein at the authentication step of the record and reproduction apparatus and the authentication step of the information process apparatus, a random number transferred from the record and reproduction apparatus to the information process apparatus is mixed with information about copyright when the generated random number data are exchanged therebetween.

32. The record method as set forth in claim 29, further comprising the step of:
mask-controlling the third encrypted key,
wherein only when at the authentication step of the record and reproduction apparatus and the authentication step of the information process apparatus, they have been mutually and successfully authenticated each other, the third encrypted key can be written to the record medium.

33. A record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to generate the second encrypted key,
causing the record and reproduction apparatus to encrypt the generated second encrypted key with the first encrypted key,
causing the record and reproduction apparatus to generate the third encrypted key,
causing the record and reproduction apparatus to encrypt the third encrypted key with the generated second encrypted key,
causing the record and reproduction apparatus to authenticate the information process apparatus and generate a session key when the record and reproduction apparatus has successfully authenticated the information process apparatus,
causing the record and reproduction apparatus to bus-encrypt the second encrypted key with the session key and transfers the bus-encrypted second encrypted key to the information process apparatus,
causing the record and reproduction apparatus to bus-encrypt the third encrypted key with the session key and transfer the bus-encrypted third encrypted key to the information process apparatus,
causing the record and reproduction apparatus to bus-decrypt the encrypted and bus-encrypted content information supplied from the information process apparatus, and
causing the record and reproduction apparatus to record the second encrypted key, the third encrypted key, and the encrypted content information to the record medium, and
causing the information process apparatus to store the first encrypted key,
causing the information process apparatus to authenticate the record and reproduction apparatus and generate the session key when the information process apparatus has successfully authenticated the record and reproduction apparatus,
causing the information process apparatus to bus-decrypt the bus-encrypted second encrypted key with the session key,
causing the information process apparatus to decrypt the second encrypted key with the first encrypted key,
causing the information process apparatus to bus-decrypt the bus-encrypted third encrypted key with the session key,
causing the information process apparatus to decrypt the third encrypted key with the second encrypted key,
causing the information process apparatus to encrypt the content information transferred to the record and reproduction apparatus with the third encryption, and
causing the information process apparatus to bus-encrypt the encrypted content information with the session key and send the bus-encrypted content information to the record and reproduction apparatus.

34. The record method as set forth in claim 33,
wherein at the authentication step of the record and reproduction apparatus and the authentication step of the information process apparatus, a random number transferred from the record and reproduction apparatus to the information process apparatus is mixed with information about a type of the record medium when the generated random number data are exchanged therebetween.

35. The record method as set forth in claim 33,
wherein at the authentication step of the record and reproduction apparatus and the authentication step of the information process apparatus, a random number transferred from the record and reproduction apparatus to the information process apparatus is mixed with information about copyright when the generated random number data are exchanged therebetween.

36. The record method as set forth in claim 33, further comprising the steps of:
mask-controlling the third encrypted key, and
mask-controlling the second encrypted key,
wherein only when at the authentication step of the record and reproduction apparatus and the authentication step of the information process apparatus, they have been mutually and successfully authenticated each other, the third encrypted key and the second encrypted key can be written to the record medium.

37. A record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to reproduce the second encrypted key encrypted and recorded on the record medium and decrypt the second encrypted key with the first encrypted key,
causing the record and reproduction apparatus to generate the third encrypted key,
causing the record and reproduction apparatus to encrypt the third encrypted key with the decrypted second encrypted key,
causing the record and reproduction apparatus to authenticate the information process apparatus and generate a session key when the record and reproduction apparatus has successfully authenticated the information process apparatus,
causing the record and reproduction apparatus to bus-decrypt the bus-encrypted content information supplied from the information process apparatus,
causing the record and reproduction apparatus to encrypt the content information with the third encrypted key,
causing the record and reproduction apparatus to record the third encrypted key and the encrypted content information to the record medium, and
causing the information process apparatus to authenticate the record and reproduction apparatus and generate the session key when the information process apparatus has successfully authenticated the record and reproduction apparatus, and
causing the information process apparatus to bus-encrypt content information transferred to the record and reproduction apparatus with the session key and send the bus-encrypted content information to the record and reproduction apparatus.

38. The record method as set forth in claim 37,
wherein at the authentication step of the record and reproduction apparatus and the authentication step of the information process apparatus, a random number transferred from the record and reproduction apparatus to the information process apparatus is mixed with information about a type of the record medium when the generated random number data are exchanged therebetween.

39. The record method as set forth in claim 37,
wherein at the authentication step of the record and reproduction apparatus and the authentication step of the information process apparatus, a random number transferred from the record and reproduction apparatus to the information process apparatus is mixed with information about copyright when the generated random number data are exchanged therebetween.

40. The record method as set forth in claim 37, further comprising the step of:
mask-controlling the third encrypted key,
wherein only when at the authentication step of the record and reproduction apparatus and the authentication step of the information process apparatus, they have been mutually and successfully authenticated each other, the third encrypted key can be written to the record medium.

41. A record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to generate the second encrypted key,
causing the record and reproduction apparatus to encrypt the generated second encrypted key with the first encrypted key,
causing the record and reproduction apparatus to generate the third encrypted key,
causing the record and reproduction apparatus to encrypt the third encrypted key with the generated second encrypted key,
causing the record and reproduction apparatus to authenticate the information process apparatus and generate a session key when the record and reproduction apparatus has successfully authenticated the information process apparatus,
causing the record and reproduction apparatus to bus-decrypt the bus-encrypted content information supplied from the information process apparatus,
causing the record and reproduction apparatus to encrypt the content information with the third encrypted key,
causing the record and reproduction apparatus to record the second encrypted key, the third encrypted key, and the encrypted content information to the record medium,
causing the information process apparatus to authenticate the record and reproduction apparatus and generate the session key when the information process apparatus has successfully authenticated the record and reproduction apparatus, and
causing the information process apparatus to bus-encrypt content information with the session key and send the bus-encrypted content information to the record and reproduction apparatus.

42. The record method as set forth in claim 41,
wherein at the authentication step of the record and reproduction apparatus and the authentication step of the information process apparatus, a random number transferred from the record and reproduction apparatus to the information process apparatus is mixed with information about a type of the record medium when the generated random number data are exchanged therebetween.

43. The record method as set forth in claim 41,
wherein at the authentication step of the record and reproduction apparatus and the authentication step of the information process apparatus, a random number transferred from the record and reproduction apparatus to the information process apparatus is mixed with information about copyright when the generated random number data are exchanged therebetween.

44. The record method as set forth in claim 41, further comprising the steps of:
mask-controlling the third encrypted key, and
mask-controlling the second encrypted key,
wherein only when at the authentication step of the record and reproduction apparatus and the authentication step of the information process apparatus, they have been mutually and successfully authenticated each other, the third encrypted key and the second encrypted key can be written to the record medium.

45. A program of a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to reproduce the second encrypted key encrypted and recorded on the record medium and decrypt the second encrypted key with the first encrypted key,
causing the record and reproduction apparatus to generate the third encrypted key,
causing the record and reproduction apparatus to encrypt the third encrypted key with the decrypted second encrypted key,
causing the record and reproduction apparatus to authenticate the information process apparatus and generate a session key when the record and reproduction apparatus has successfully authenticated the information process apparatus,
causing the record and reproduction apparatus to bus-encrypt the second encrypted key that has been encrypted and recorded on the record medium with the session key and transfer the bus-encrypted second encrypted key to the information process apparatus,
causing the record and reproduction apparatus to bus-encrypt the third encrypted key with the session key and transfer the bus-encrypted third encrypted key to the information process apparatus,
causing the record and reproduction apparatus to bus-decrypt the encrypted and bus-encrypted content information supplied from the information process apparatus,
causing the record and reproduction apparatus to record the third encrypted key and the encrypted content information to the record medium,
causing the information process apparatus to store the first encrypted key,
causing the information process apparatus to authenticate the record and reproduction apparatus and generate the session key when the information process apparatus has successfully authenticated the record and reproduction apparatus,
causing the information process apparatus to bus-decrypt the bus-encrypted second encrypted key with the session key,
causing the information process apparatus to decrypt the second encrypted key with the first encrypted key,
causing the information process apparatus to bus-decrypt the bus-encrypted third encrypted key with the session key,
causing the information process apparatus to decrypt the third encrypted key with the second encrypted key,
causing the information process apparatus to encrypt the content information transferred to the record and reproduction apparatus with the third encryption, and
causing the information process apparatus to bus-encrypt the encrypted content information with the session key and send the bus-encrypted content information to the record and reproduction apparatus.

46. A program of a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to generate the second encrypted key,
causing the record and reproduction apparatus to encrypt the generated second encrypted key with the first encrypted key,
causing the record and reproduction apparatus to generate the third encrypted key,
causing the record and reproduction apparatus to encrypt the third encrypted key with the generated second encrypted key,
causing the record and reproduction apparatus to authenticate the information process apparatus and generate a session key when the record and reproduction apparatus has successfully authenticated the information process apparatus,
causing the record and reproduction apparatus to bus-encrypt the second encrypted key with the session key and transfers the bus-encrypted second encrypted key to the information process apparatus,
causing the record and reproduction apparatus to bus-encrypt the third encrypted key with the session key and transfer the bus-encrypted third encrypted key to the information process apparatus,
causing the record and reproduction apparatus to bus-decrypt the encrypted and bus-encrypted content information supplied from the information process apparatus, and
causing the record and reproduction apparatus to record the second encrypted key, the third encrypted key, and the encrypted content information to the record medium, and
causing the information process apparatus to store the first encrypted key,
causing the information process apparatus to authenticate the record and reproduction apparatus and generate the session key when the information process apparatus has successfully authenticated the record and reproduction apparatus,
causing the information process apparatus to bus-decrypt the bus-encrypted second encrypted key with the session key,
causing the information process apparatus to decrypt the second encrypted key with the first encrypted key,
causing the information process apparatus to bus-decrypt the bus-encrypted third encrypted key with the session key,
causing the information process apparatus to decrypt the third encrypted key with the second encrypted key,
causing the information process apparatus to encrypt the content information transferred to the record and reproduction apparatus with the third encryption, and
causing the information process apparatus to bus-encrypt the encrypted content information with the session key and send the bus-encrypted content information to the record and reproduction apparatus.

47. A program of a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to reproduce the second encrypted key encrypted and recorded on the record medium and decrypt the second encrypted key with the first encrypted key,
causing the record and reproduction apparatus to generate the third encrypted key,
causing the record and reproduction apparatus to encrypt the third encrypted key with the decrypted second encrypted key,
causing the record and reproduction apparatus to authenticate the information process apparatus and generate a session key when the record and reproduction apparatus has successfully authenticated the information process apparatus,
causing the record and reproduction apparatus to bus-decrypt the bus-encrypted content information supplied from the information process apparatus,
causing the record and reproduction apparatus to encrypt the content information with the third encrypted key,
causing the record and reproduction apparatus to record the third encrypted key and the encrypted content information to the record medium, and
causing the information process apparatus to authenticate the record and reproduction apparatus and generate the session key when the information process apparatus has successfully authenticated the record and reproduction apparatus, and
causing the information process apparatus to bus-encrypt content information transferred to the record and reproduction apparatus with the session key and send the bus-encrypted content information to the record and reproduction apparatus.

48. A program of a record method of a record and reproduction apparatus that reads information from a record medium and records information thereto and an information process apparatus to which the record and reproduction apparatus is connected through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to generate the second encrypted key,
causing the record and reproduction apparatus to encrypt the generated second encrypted key with the first encrypted key,
causing the record and reproduction apparatus to generate the third encrypted key,
causing the record and reproduction apparatus to encrypt the third encrypted key with the generated second encrypted key,
causing the record and reproduction apparatus to authenticate the information process apparatus and generate a session key when the record and reproduction apparatus has successfully authenticated the information process apparatus,
causing the record and reproduction apparatus to bus-decrypt the bus-encrypted content information supplied from the information process apparatus,
causing the record and reproduction apparatus to encrypt the content information with the third encrypted key,
causing the record and reproduction apparatus to record the second encrypted key, the third encrypted key, and the encrypted content information to the record medium,
causing the information process apparatus to authenticate the record and reproduction apparatus and generate the session key when the information process apparatus has successfully authenticated the record and reproduction apparatus, and
causing the information process apparatus to bus-encrypt content information with the session key and send the bus-encrypted content information to the record and reproduction apparatus.

49. A record medium on which a program of a record method of a record and reproduction apparatus and an information process apparatus is recorded, the record and reproduction apparatus reading information from a record medium and records information thereto and the information process apparatus being connected to the record and reproduction apparatus through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to reproduce the second encrypted key encrypted and recorded on the record medium and decrypt the second encrypted key with the first encrypted key,
causing the record and reproduction apparatus to generate the third encrypted key,
causing the record and reproduction apparatus to encrypt the third encrypted key with the decrypted second encrypted key,
causing the record and reproduction apparatus to authenticate the information process apparatus and generate a session key when the record and reproduction apparatus has successfully authenticated the information process apparatus,
causing the record and reproduction apparatus to bus-encrypt the second encrypted key that has been encrypted and recorded on the record medium with the session key and transfer the bus-encrypted second encrypted key to the information process apparatus,
causing the record and reproduction apparatus to bus-encrypt the third encrypted key with the session key and transfer the bus-encrypted third encrypted key to the information process apparatus,
causing the record and reproduction apparatus to bus-decrypt the encrypted and bus-encrypted content information supplied from the information process apparatus,
causing the record and reproduction apparatus to record the third encrypted key and the encrypted content information to the record medium,
causing the information process apparatus to store the first encrypted key,
causing the information process apparatus to authenticate the record and reproduction apparatus and generate the session key when the information process apparatus has successfully authenticated the record and reproduction apparatus,
causing the information process apparatus to bus-decrypt the bus-encrypted second encrypted key with the session key,
causing the information process apparatus to decrypt the second encrypted key with the first encrypted key,
causing the information process apparatus to bus-decrypt the bus-encrypted third encrypted key with the session key,
causing the information process apparatus to decrypt the third encrypted key with the second encrypted key,
causing the information process apparatus to encrypt the content information transferred to the record and reproduction apparatus with the third encryption, and
causing the information process apparatus to bus-encrypt the encrypted content information with the session key and send the bus-encrypted content information to the record and reproduction apparatus.

50. A record medium on which a program of a record method of a record and reproduction apparatus and an information process apparatus is recorded, the record and reproduction apparatus reading information from a record medium and records information thereto and the information process apparatus being connected to the record and reproduction apparatus through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to generate the second encrypted key,
causing the record and reproduction apparatus to encrypt the generated second encrypted key with the first encrypted key,
causing the record and reproduction apparatus to generate the third encrypted key,
causing the record and reproduction apparatus to encrypt the third encrypted key with the generated second encrypted key,
causing the record and reproduction apparatus to authenticate the information process apparatus and generate a session key when the record and reproduction apparatus has successfully authenticated the information process apparatus,
causing the record and reproduction apparatus to bus-encrypt the second encrypted key with the session key and transfers the bus-encrypted second encrypted key to the information process apparatus,
causing the record and reproduction apparatus to bus-encrypt the third encrypted key with the session key and transfer the bus-encrypted third encrypted key to the information process apparatus,
causing the record and reproduction apparatus to bus-decrypt the encrypted and bus-encrypted content information supplied from the information process apparatus, and
causing the record and reproduction apparatus to record the second encrypted key, the third encrypted key, and the encrypted content information to the record medium, and
causing the information process apparatus to store the first encrypted key,
causing the information process apparatus to authenticate the record and reproduction apparatus and generate the session key when the information process apparatus has successfully authenticated the record and reproduction apparatus,
causing the information process apparatus to bus-decrypt the bus-encrypted second encrypted key with the session key,
causing the information process apparatus to decrypt the second encrypted key with the first encrypted key,
causing the information process apparatus to bus-decrypt the bus-encrypted third encrypted key with the session key,
causing the information process apparatus to decrypt the third encrypted key with the second encrypted key,
causing the information process apparatus to encrypt the content information transferred to the record and reproduction apparatus with the third encryption, and
causing the information process apparatus to bus-encrypt the encrypted content information with the session key and send the bus-encrypted content information to the record and reproduction apparatus.

51. A record medium on which a program of a record method of a record and reproduction apparatus and an information process apparatus is recorded, the record and reproduction apparatus reading information from a record medium and records information thereto and the information process apparatus being connected to the record and reproduction apparatus through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to reproduce the second encrypted key encrypted and recorded on the record medium and decrypt the second encrypted key with the first encrypted key,
causing the record and reproduction apparatus to generate the third encrypted key,
causing the record and reproduction apparatus to encrypt the third encrypted key with the decrypted second encrypted key,
causing the record and reproduction apparatus to authenticate the information process apparatus and generate a session key when the record and reproduction apparatus has successfully authenticated the information process apparatus,
causing the record and reproduction apparatus to bus-decrypt the bus-encrypted content information supplied from the information process apparatus,
causing the record and reproduction apparatus to encrypt the content information with the third encrypted key,
causing the record and reproduction apparatus to record the third encrypted key and the encrypted content information to the record medium, and
causing the information process apparatus to authenticate the record and reproduction apparatus and generate the session key when the information process apparatus has successfully authenticated the record and reproduction apparatus, and
causing the information process apparatus to bus-encrypt content information transferred to the record and reproduction apparatus with the session key and send the bus-encrypted content information to the record and reproduction apparatus.

52. A record medium on which a program of a record method of a record and reproduction apparatus and an information process apparatus is recorded, the record and reproduction apparatus reading information from a record medium and records information thereto and the information process apparatus being connected to the record and reproduction apparatus through transfer step, content information being encrypted according to a content information encryption method using a first encrypted key managed by a management mechanism, a second encrypted key unique to the record medium, and a third encrypted key generated whenever information is recorded, the content information being recorded to the record medium, the record method comprising the steps of:
causing the record and reproduction apparatus to store the first encrypted key,
causing the record and reproduction apparatus to generate the second encrypted key,
causing the record and reproduction apparatus to encrypt the generated second encrypted key with the first encrypted key,
causing the record and reproduction apparatus to generate the third encrypted key,
causing the record and reproduction apparatus to encrypt the third encrypted key with the generated second encrypted key,
causing the record and reproduction apparatus to authenticate the information process apparatus and generate a session key when the record and reproduction apparatus has successfully authenticated the information process apparatus,
causing the record and reproduction apparatus to bus-decrypt the bus-encrypted content information supplied from the information process apparatus,
causing the record and reproduction apparatus to encrypt the content information with the third encrypted key,
causing the record and reproduction apparatus to record the second encrypted key, the third encrypted key, and the encrypted content information to the record medium,
causing the information process apparatus to authenticate the record and reproduction apparatus and generate the session key when the information process apparatus has successfully authenticated the record and reproduction apparatus, and
causing the information process apparatus to bus-encrypt content information with the session key and send the bus-encrypted content information to the record and reproduction apparatus.

53. A system for recording encrypted audio visual data on a medium comprising:
a drive for recording an information onto the medium and a host computer, connected to the recorder, to control said drive wherein
said drive includes:
a random number generator for generating a random number;
a first transmitter for transmitting said random number;
a recording unit for recording said random number onto the medium; and
said host computer includes:
a first receiver for receiving said random number;
an encrypting unit for encrypting audio visual data using said receiving random number;
a second transmitter for transmitting said encrypted audio visual data to said drive; and
wherein said drive further includes:
a second receiving unit for receiving encrypted audio visual data transmitted by said second transmitting; and
said recording further recording audio visual data received by said second receiving unit onto the medium.
